(19) United States
(12) Patent Application Publication
(10) Pub. No.: US 2026/0085621 A1
(43) Pub. Date: Mar. 26, 2026

(54) TURBOFAN ENGINE INCLUDING A FAN ACTUATION SYSTEM

(71) Applicant: General Electric Company, Evendale, OH (US)

(72) Inventors: Randy M. Vondrell, Newport, KY (US); Keith A. Miedema, Fairfield, OH (US); Brandon W. Miller, Middletown, OH (US)

(21) Appl. No.: 19/410,101

(22) Filed: Dec. 5, 2025

Related U.S. Application Data
(63) Continuation-in-part of application No. 19/357,928, filed on Oct. 14, 2025.
Application No. 19/357,928 is a continuation-in-part of application No. 19/097,493, filed on Apr. 1, 2025, now Pat. No. 12,480,415.
Application No. 19/097,493 is a continuation-in-part of application No. 18/400,746, filed on Dec. 29, 2023, now Pat. No. 12,345,178.

(51) Int. Cl. F01D 25/16; B64D 27/10; B64D 29/00

(52) U.S. Cl. CPC F01D 25/16; B64D 27/10; B64D 29/00; F05D 2220/36; F05D 2240/54

(57) ABSTRACT

A turbofan engine for an aircraft includes a fan and a fan actuation system. The fan has a plurality of fan blades coupled to a fan shaft having one or more fan bearings. The fan blades are rotatable about a pitch axis. The fan actuation system is disposed within a fan hub and includes one or more actuators for rotating the fan blades about the pitch axis and one or more radial thrust bearings. The fan actuation system is characterized by a fan actuation system length envelope in a range from 8.5 to 24 and given by

$$\frac{{N}_{FB} \times {D}_{FT}}{{L}_{AXIAL} \times ( \frac{{R}_{TB}}{{N}_{FB}} )} .$$

N_{FB} is a number of the fan blades, D_{FT} is a fan tip diameter of the fan blades, R_{TB} is a thrust bearing radius of the radial thrust bearings, and L_{AXIAL} is an axial length from a fan hub tip to the fan bearings.

### CROSS REFERENCE TO RELATED APPLICATIONS

This application is a continuation-in-part of U.S. patent application Ser. No. 19/357,928, filed Oct. 14, 2025, which is a continuation-in-part of U.S. patent application Ser. No. 19/097,493, filed Apr. 1, 2025, which is a continuation-in-part of U.S. patent application Ser. No. 18/400,746, filed on Dec. 29, 2023, and issued as U.S. Pat. No. 12,345,178 on Jul. 1, 2025, the contents of all of which are hereby incorporated by reference herein in their entireties.

### TECHNICAL FIELD

The present disclosure relates generally to fan actuation systems for turbofan engines.

### BACKGROUND

Turbofan engines, for example, for an aircraft, generally include a fan having fan blades, a compressor section, a combustion section, and a turbine section arranged in flow communication with one another. Some turbofan engines include a fan actuation system for actuating the fan blades of the fan.

### BRIEF DESCRIPTION OF THE DRAWINGS

The foregoing and other features and advantages will be apparent from the following, more particular, description of various exemplary aspects, as illustrated in the accompanying drawings, wherein like reference numbers generally indicate identical, functionally similar, or structurally similar elements.

FIG. 1 is a schematic cross-sectional diagram of a turbofan engine, taken along a longitudinal centerline axis of the turbofan engine, according to the present disclosure.

FIG. 2 shows a schematic view of a turbofan engine, according to the present disclosure.

FIG. 3 shows a fan having a fan actuation system, according to the present disclosure.

FIG. 4 is a schematic cross-sectional diagram of a fan actuation system for a turbofan engine, taken along a longitudinal centerline axis of the turbofan engine, according to the present disclosure.

FIG. 5 is a schematic cross-sectional view of a fan actuation system for a turbofan engine, according to another aspect.

FIG. 6 is a schematic cross-sectional view of a fan actuation system for the turbofan engine, taken along the longitudinal centerline axis of the turbofan engine, according to the present disclosure.

FIG. 7 is a schematic cross-sectional view of a fan actuation system for the turbofan engine, taken along the longitudinal centerline axis of the turbofan engine, according to another aspect.

FIG. 8 is a schematic cross-sectional view of a fan actuation system for the turbofan engine, taken along the longitudinal centerline axis of the turbofan engine, according to another aspect.

FIG. 9 is a schematic cross-sectional view of a fan actuation system for the turbofan engine, taken along the longitudinal centerline axis of the turbofan engine, according to another aspect.

FIG. 10 is a schematic cross-sectional view of a fan actuation system for the turbofan engine, taken along the longitudinal centerline axis of the turbofan engine, according to another aspect.

FIG. 11 represents, in graph form, a fan actuation system envelope as a function of a loading envelope, according to the present disclosure.

FIG. 12 represents, in graph form, the fan actuation system envelope as a function of a spacing envelope, according to the present disclosure.

FIG. 13 represents, in graph form, a fan actuation system length envelope as a function of a loading envelope, according to the present disclosure.

FIG. 14 represents, in graph form, the fan actuation system length envelope as a function of a spacing envelope, according to the present disclosure.

FIG. 15 is a schematic view of a forward end of a fan of the turbofan engine of FIG. 2, according to the present disclosure.

FIG. 16 is an enlarged, schematic, cross-sectional diagram of the turbofan engine of FIG. 1 and having one or more fan bearings, taken at detail 16 in FIG. 1, according to the present disclosure.

FIG. 17 is an enlarged, schematic, cross-sectional diagram of the turbofan engine of FIG. 1 and having one or more fan bearings, taken along the longitudinal centerline axis, according to another aspect.

FIG. 18 is a schematic cross-sectional view of a fan bearing for the turbofan engine of FIG. 1, according to another aspect.

FIG. 19 represents, in graph form, a fan bearing envelope as a function of a takeoff thrust of the turbofan engine, according to the present disclosure.

FIG. 20 represents, in graph form, the fan bearing envelope as a function of the takeoff thrust, according to another aspect.

FIG. 21 is an enlarged schematic, cross-sectional view of a segment of a fan of having a fan actuation system, according to another aspect.

FIG. 22 is a schematic perspective view of an aircraft having turbofan engines with a rotating airfoil according to an embodiment of the present disclosure.

FIG. 23 is a schematic, cross-sectional view, taken along line 23-23 in FIG. 22, of one of the turbofan engines of the aircraft shown in FIG. 22.

FIG. 24 is another schematic, cross-sectional view, taken along line 23-23 in FIG. 22, of one of the turbofan engines of the aircraft shown in FIG. 22, showing an engine mounting system used to mount the engine to a wing of the aircraft.

FIG. 25 is a detail cross-sectional view, showing detail 25 in FIG. 24, of a forward mount of the engine mount system shown in FIG. 24.

FIG. 26 is a detail cross-sectional view, showing detail 26 in FIG. 24, of an aft mount of the engine mount system shown in FIG. 24.

FIG. 27 is a view of the aircraft shown in FIG. 22 during level flight.

FIG. 28 is a view of the aircraft shown in FIG. 22 for an operating condition when the aircraft is pitched upward.

FIG. 29 is a front view of a fan (rotating airfoil assembly) of one of the turbofan engines of the aircraft shown in FIG. 22.

FIG. 30 is a view of the aircraft shown in FIG. 22 for an operating condition when the aircraft is pitched upward and the rotating airfoil assembly is rotated according to an embodiment of the present disclosure.

FIG. 31 is a top view of the engine support structure according to an embodiment of the present disclosure.

FIG. 32 is a schematic, cross-sectional view, taken along line 23-23 in FIG. 22, of one of the turbofan engines of the aircraft shown in FIG. 22, showing the engine support structure of FIG. 31 in a stowed position.

FIG. 33 is a schematic, cross-sectional view, taken along line 23-23 in FIG. 22, of one of the turbofan engines of the aircraft shown in FIG. 22, showing the engine support structure of FIG. 31 in a deployed position.

FIG. 34 is a side view of the engine support structure according to an embodiment of the present disclosure.

FIG. 35 is a top view of the engine support structure shown in FIG. 34.

FIG. 36 is a side view of the engine support structure according to an embodiment of the present disclosure.

FIG. 37 is a cross-sectional view of an aft mount of the engine support structure shown in FIG. 36, taken along line 37-37 in FIG. 36.

FIG. 38 is a cross-sectional view of the aft mount of the engine support structure shown in FIG. 36, taken along line 38-38 in FIG. 37.

FIG. 39 is a side view of the engine support structure according to an embodiment of the present disclosure.

FIG. 40 is a side view of the engine support structure according to an embodiment of the present disclosure.

FIG. 41 is a schematic, cross-sectional view of a turbofan engine according to an embodiment of the present disclosure. The cross-sectional view is taken from a perspective similar to line 23-23 in FIG. 22.

FIG. 42 shows a differential gearbox used in the engine shown in FIG. 41.

FIG. 43 is a schematic, cross-sectional view of a turbofan engine according to an embodiment of the present disclosure. The cross-sectional view is taken from a perspective similar to line 23-23 in FIG. 22.

FIG. 44 is a cross-sectional detail view of a spherical bearing supporting a fan shaft.

FIG. 45 is a cross-sectional detail view of a spherical bearing supporting a fan shaft, with the fan shaft pivoted.

FIG. 46 is a schematic, cross-sectional view of a turbofan engine according to an embodiment of the present disclosure during level flight. The cross-sectional view is taken from a perspective similar to line 23-23 in FIG. 22.

FIG. 47 is a schematic, cross-sectional view of the turbofan engine shown in FIG. 46 during the condition shown in FIG. 30.

FIG. 48 is a detail cross-sectional view of a fan hub according to another embodiment.

FIG. 49 is a cross-sectional view of the root of the fan blade taken along line 49-49 in FIG. 48.

FIG. 50 is a cross-sectional view of the root of the fan blade according to another embodiment.

FIG. 51 is the cross-sectional view of the root of the fan blade shown in FIG. 50 in a condition where the fan blade is rotating.

FIG. 52 is a graph illustrating the effects of a spring damper system for the fan blade shown in FIG. 51.

### DETAILED DESCRIPTION

Features, advantages, and aspects of the present disclosure are set forth or apparent from a consideration of the following detailed description, drawings, and claims. Moreover, the following detailed description is exemplary and intended to provide further explanation without limiting the scope of the disclosure as claimed.

Various aspects of the present disclosure are discussed in detail below. While specific aspects are discussed, this is done for illustration purposes only. A person skilled in the relevant art will recognize that other components and configurations may be used without departing from the present disclosure.

As used herein, the terms “first,” “second,” “third,” and “fourth” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbofan engine or vehicle, and refer to the normal operational attitude of the turbofan engine or vehicle. For example, with regard to a turbofan engine, forward refers to a position closer to an engine inlet and aft refers to a position closer to an engine nozzle or exhaust.

As used herein, the terms “low,” “mid” (or “mid-level”), and “high,” or their respective comparative degrees (e.g., “lower” and “higher”, where applicable), when used with compressor, combustor, turbine, shaft, fan, or turbofan engine components, each refers to relative pressures, relative speeds, relative temperatures, or relative power outputs within an engine unless otherwise specified. For example, a “low-power” setting defines the engine or the combustor configured to operate at a power output lower than a “high-power” setting of the engine or the combustor, and a “mid-level power” setting defines the engine or the combustor configured to operate at a power output higher than a “low-power” setting and lower than a “high-power” setting. The terms “low,” “mid” (or “mid-level”) or “high” in such aforementioned terms may additionally, or alternatively, be understood as relative to minimum allowable speeds, pressures, or temperatures, or minimum or maximum allowable speeds, pressures, or temperatures relative to normal, desired, steady state, etc., operation of the engine. A mission cycle for a turbofan engine includes, for example, a low-power operation, a mid-level power operation, and a high-power operation. Low-power operation includes, for example, engine start, idle, taxiing, and approach. Mid-level power operation includes, for example, cruise. High-power operation includes, for example, takeoff and climb.

The various power levels of the turbofan engine are defined as a percentage of a sea level static (SLS) maximum engine rated thrust. Low power operation includes, for example, less than thirty percent (30%) of the SLS maximum engine rated thrust of the turbofan engine. Mid-level power operation includes, for example, thirty percent (30%) to eighty-five percent (85%) of the SLS maximum engine rated thrust of the turbofan engine. High power operation includes, for example, greater than eighty-five percent (85%) of the SLS maximum engine rated thrust of the turbofan engine. The values of the thrust for each of the low power operation, the mid-level power operation, and the high power operation of the turbofan engine are exemplary only, and other values of the thrust can be used to define the low power operation, the mid-level power operation, and the high power operation.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the turbofan engine. Moreover, the terms “radial” and “radially” refer to directions and orientations that extend substantially perpendicular to the centerline of the turbofan engine. In addition, as used herein, the terms “circumferential” and “circumferentially” refer to directions and orientations that extend arcuately about the centerline of the turbofan engine.

As used herein, a “turbofan engine” includes a core flowpath defined by a compressor section, a combustion section, and a turbine section, and a fan that directs air into the core flowpath, and rated for use in a regional aircraft, a narrow body aircraft, or a wide body aircraft. A turbofan engine rated for use on a regional aircraft will have a maximum takeoff thrust in a range from ten thousand pound-force to twenty thousand pound-force (10,000 lbf to 20,000 lbf). A turbofan engine rated for use on a narrow body aircraft will have a maximum takeoff thrust in a range from fifteen thousand pound-force to thirty thousand pound-force (15,000 lbf to 30,000 lbf). A turbofan engine rated for use on a wide body aircraft will have a maximum takeoff thrust in a range from forty thousand pound-force to one hundred ten thousand pound-force (40,000 lbf to 110,000 lbf).

As used herein, the term “cruise” or “cruising speed” refers to operation of a turbofan engine utilized to power an aircraft that may operate at a cruising speed when the aircraft levels after climbing to a specified altitude. A turbofan engine may operate at a cruising speed that is from 50% to 90% of a rated speed, such as from 70% to 80% of the rated speed. In some aspects, a cruising speed may be achieved at about 80% of full throttle, such as from about 50% to about 90% of full throttle, such as from about 70% to about 80% full throttle. As used herein, the term “cruise flight” refers to a phase of flight in which an aircraft levels in altitude after a climb phase and prior to descending to an approach phase. In various examples, cruise flight may take place at a cruise altitude up to approximately 65,000 ft. In certain examples, cruise altitude is in a range from approximately 28,000 ft. to approximately 45,000 ft. In yet other examples, cruise altitude is expressed in flight levels (FL) based on a standard air pressure at sea level, in which cruise flight is between FL280 and FL650. In another example, cruise flight is between FL280 and FL450. In still certain examples, cruise altitude is defined based at least on a barometric pressure, in which cruise altitude is in a range from approximately 4.85 psia to approximately 0.82 psia based on a sea-level pressure of approximately 14.70 psia and sea-level temperature at approximately 59 degrees Fahrenheit. In another example, cruise altitude is in a range from approximately 4.85 psia to approximately 2.14 psia. In certain examples, the ranges of cruise altitude defined by pressure may be adjusted based on a different reference sea-level pressure and/or sea-level temperature.

As used herein, the term “ducted engine” means a turbofan engine with a fan casing or nacelle that circumferentially surrounds the fan.

As used herein, an “unducted fan engine” or an “open fan engine” means a turbofan engine without a fan casing or a nacelle surrounding the fan.

Hereafter, the term “turbofan engine” will refer to either a “ducted engine” or an “open fan engine.”

As used herein, a “fan tip diameter” is defined as a diameter of a fan blade and is measured from the longitudinal centerline axis of the turbofan engine to a fan tip of the fan blade at an axial location of the blade where the diameter is a maximum.

As used herein, a Mach number is a ratio of the speed of the aircraft to the speed of sound in the surrounding airflow. The Mach number at cruise as defined herein is a maximum operating Mach number as provided by a Type Certificate Data Sheet (TCDS) for the turbofan engine.

An aircraft's quoted cruise Mach number is generally known in the industry to be applied during a “standard day” temperature day. Therefore, the temperature is a fixed value based on altitude according to the established International Standard Atmosphere (ISA) tables. High speed civil gas turbine powered transport aircraft quote their speed by Mach number and have set cruising altitudes based on their size and mission profile (e.g., smaller aircraft fly at lower altitudes). Turboprops and smaller aircraft may have their cruising speed quoted in knots such as VTAS (velocity true airspeed) or KCAS (knots calibrated air speed), where ambient temperature is considered. Engine performance can be modeled for “hot days” or “cold days” where the ambient temperature is hotter or cooler than standard day by a prescribed amount, but this is part of off-design performance. Further, between 36,000 and 80,000 feet, where most commercial aircraft cruise, the ambient temperature is actually constant.

As used herein, a “thrust bearing radius” of a radial thrust bearing is defined in the radial direction from the longitudinal centerline axis to a radial center of the radial thrust bearing. Particularly, the radial center of the radial thrust bearing is a radial center of the rolling elements of the radial thrust bearing.

As used herein, a “fan hub axial length” is an axial length, in the axial direction (e.g., parallel with the longitudinal centerline axis 112) from a fan hub tip of the fan hub to a pitch axis P of the fan blades of the fan.

As used herein, a “fan actuation system axial length” is an axial length, in the axial direction (e.g., parallel with the longitudinal centerline axis 112), from an axially forward-most surface of the fan actuation system to the pitch axis P of the fan blades of the fan.

As used herein, a “fan bearing axial length” is an axial length, in the axial direction (e.g., parallel with the longitudinal centerline axis 112) from the pitch axis P of the fan blades of the fan to an axial center of one or more fan bearings that support rotation of the fan shaft.

The term “leading edge” refers to components and/or surfaces which are oriented predominately upstream relative to the fluid flow of the system, and the term “trailing edge” refers to components and/or surfaces which are oriented predominately downstream relative to the fluid flow of the system.

As used herein, a “rolling element diameter” of a rolling element of the fan bearing is a distance of a straight line passing from side to side through a center of the rolling element.

As used herein, a “fan hub trailing edge radius” or “R_{FHTE}” of a fan hub is defined in the radial direction from the longitudinal centerline axis to the fan hub at a trailing edge of the fan blades.

As used herein, a “fan tip radius” of a fan blade is defined in the radial direction from the longitudinal centerline axis to the fan tip at the trailing edge of the fan blade.

As used herein, a “fan hub radius ratio” is defined as a ratio of the fan hub trailing edge radius R_{FHTE} to the fan tip radius of the fan blades.

As used herein, a “fan hub leading edge radius” or “R_{FHLE}” of a fan hub is defined in the radial direction from the longitudinal centerline axis to the fan hub at a leading edge of the fan blades.

As used herein, a “fan bearing radius” or “R_{FBRG}” of a fan bearing is defined as a distance along the radial direction from the longitudinal centerline axis of the turbofan engine to a central axis or a center point of the fan bearing.

As used herein, a “fan bearing radius ratio” or “R_{FHLE}:R_{FBRG}” is a ratio of the fan hub leading edge radius R_{FHLE} to the fan bearing radius R_{FBRG}.

Here and throughout the specification and claims, range limitations are combined and interchanged. Such ranges are identified and include all the sub-ranges contained therein unless context or language indicates otherwise. For example, all ranges disclosed herein are inclusive of the endpoints, and the endpoints are independently combinable with each other.

The present disclosure provides for turbofan engines that have a variable pitch fan. Such engines include a fan actuation system that includes one or more actuators for changing a pitch of fan blades of the variable pitch fan. The fan actuation system typically includes a hydraulic system that supplies hydraulic fluid to one or more chambers to actuate the actuators. The actuators are coupled to the fan blades and actuation of the actuators causes the fan blades to rotate about a pitch axis P to change the pitch of the fan blades. Some fan actuation systems are designed for turboprop engines that include a propeller, rather than a fan.

Turboprop engines produce less thrust than turbofan engines. Turboprop engines typically provide cruise speeds for an aircraft with a Mach number that is less than 0.7 and have fewer than ten propeller blades, such as fewer than eight propeller blades or fewer than five propeller blades. Turbofan engines include ten or more fan blades that extend from a disk and provide cruise speeds for an aircraft with a Mach number that is 0.7 or greater. To achieve these higher speeds, the fan aerodynamics for the turbofan engines are different than the propeller aerodynamics for turboprop engines, resulting in the turbofan engines having more fan blades for aerodynamic efficiency at higher Mach speeds. Turbofan engines with variable pitch fan blades also benefit from guide vanes, such as outlet guide vanes behind the fan blades, and/or inlet guide vanes forward of the fan, to reduce losses at higher speeds.

The loading environment associated with the variable pitch mechanism for turboprop engines is less than the loading environment presented for a variable pitch turbofan engine. There is a lower disk loading capability requirement on parts (e.g., trunnion, bearings, gearing, actuators, etc.) and associated less actuation force resources needed (e.g., hydraulic fluid) to operate a variable pitch turboprop as compared to a variable pitch turbofan engine. At the same time, the available space, the desirable space, or the volume in that part of the engine for the higher-load-carrying fan blade pitch actuation system and the greater number of blades of a turbofan engine is not correspondingly larger than the space available for the lower-load-carrying fan blade pitch actuation system with fewer fan blades of a turboprop. Turbofan engines having variable pitch fan blades require more compactness for the pitch change system, relative to a turboprop, when considering the larger space requirements assumed if one were to simply scale-up a pitch actuation system for a turboprop for use in a turbofan engine. This can be realized when one considers that a larger, stronger structure is needed to support the more numerous blades and react the higher pitch loads associated with a turbofan engine. One cannot simply scale-up the space available for a pitch change mechanism and associated structure, and also scale up to account for the impact of a significantly increased number of blades when designing a variable pitch turbofan engine. Accommodation of the pitch change mechanism, trunnion, and associated structure for holding and articulating the fan blades within an engine housing therefore presents unique challenges for the turbofan engine in terms of the available space. The existing pitch change mechanisms and structure used to support blades in turboprop engines are not faced with similar challenges and therefore provide limited insight into how to implement a variable pitch mechanism within the more limited space, and more numerous fan blade system of a turbofan engine.

Many actuation systems for turboprop engines include a counterweight system to help pitch the propeller blades (e.g., the weight counteracts inertial loading associated with turning the propeller blade). For turbofan engines, a counterweight system may not be feasible because there is not the space available to accommodate the counterweight system. Thus, an alternative is needed to articulate the blades without exceeding load limits, which implies more compactness given the limited space available. Additionally, it was realized that pitch lock devices to lock the more-numerous fan blades in a feather position for turbofan engines, in case of fan actuation system failure, need to be considered when determining the minimum size needed for the turbofan engine fan actuation system. Additionally, it should be realized the very different types of inlets between a turboprop engine, on the one hand, and turbofan engine on the other hand, impact the amount of available space within the engine housing. Inlets to the turbofan engine (e.g., inlet to the hot gas path through the compressor section, the combustion section, and the turbine section) of a turboprop engine have a relatively narrow circumferential extent (sometimes called “chin” inlets). As such, there is more space available for a pitch change mechanism. Inlets to turbofan engines, however, have annular inlets, which take up more space within the engine housing than the more limited circumferential extent occupied by a turboprop inlet. Accommodating both a pitch change mechanism and annular inlet poses a unique challenge for a turbofan engine with variable pitch fan blades.

For at least these reasons, the loading on a pitch change mechanism and packaging of this system for a turbofan engine having greater number of blades than a turboprop engine presents challenges. It is not simply a matter of scaling-up the space available and size of component parts used in a turboprop engine fan actuation system. Indeed, it has been found that the problem is both unique to the engine type and complex—not amenable to a ready solution based on pre-existing variable pitch turboprop engine design. The inventors, seeking a need to find a solution to this problem, designed and tested several different turbofan engine architectures in an effort to arrive at a fan actuation system that met both the higher loading and more compact space requirements of a turbofan engine.

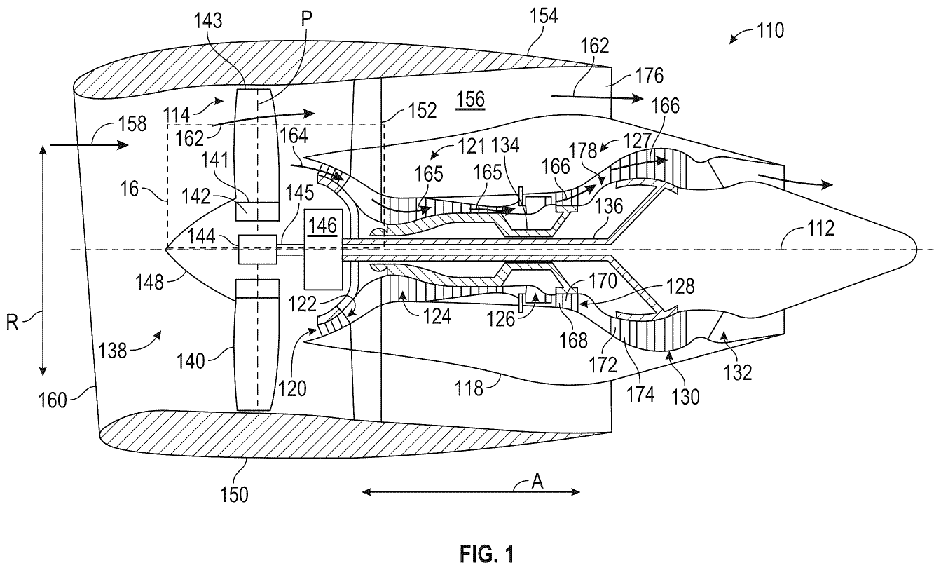

Referring now to the drawings, FIG. 1 is a schematic cross-sectional diagram of a turbofan engine 110, taken along a longitudinal centerline axis 112 of the turbofan engine 110, according to an aspect of the present disclosure. As shown in FIG. 1, the turbofan engine 110 defines an axial direction A (extending parallel to the longitudinal centerline axis 112 provided for reference) and a radial direction R that is normal to the axial direction A. In general, the turbofan engine 110 includes, in serial flow relationship, a fan assembly 114, a compressor section 121, a combustion section 126, and a turbine section 127. The compressor section 121, the combustion section 126, and the turbine section 127 are substantially enclosed within a core cowl 118 that is substantially tubular and defines a core inlet 120 having an annular shape that is annular about the longitudinal centerline axis 112. As schematically shown in FIG. 1, the compressor section 121 includes a booster or a low-pressure (LP) compressor 122 followed downstream by a high-pressure (HP) compressor 124. The combustion section 126 is downstream of the compressor section 121 and includes a combustor. The turbine section 127 is downstream of the combustion section 126 and includes a high-pressure (HP) turbine 128 followed downstream by a low-pressure (LP) turbine 130, also referred to as a power turbine. The turbofan engine 110 also includes a core exhaust nozzle 132 that is downstream of the turbine section 127. The turbofan engine 110 further includes a high-pressure (HP) shaft 134, also referred to as a high-speed shaft, that drivingly connects the HP turbine 128 to the HP compressor 124. The HP turbine 128 and the HP compressor 124 rotate in unison through the HP shaft 134. The turbofan engine 110 includes a low-pressure (LP) shaft 136, also referred to as a low-speed shaft, that drivingly connects the LP turbine 130 to the LP compressor 122. The LP turbine 130 and the LP compressor 122 rotate in unison through the LP shaft 136. The compressor section 121, the combustion section 126, the turbine section 127, and the core exhaust nozzle 132 together define a core air flow path.

In FIG. 1, the fan assembly 114 includes a fan 138 (e.g., a variable pitch fan) having a plurality of fan blades 140 coupled to a fan disk 142 in a spaced apart manner. As depicted in FIG. 1, the fan blades 140 extend outwardly from the fan disk 142 generally along the radial direction R from a fan root 141 to a fan tip 143. Each fan blade 140 is rotatable relative to the fan disk 142 about a pitch axis P by virtue of the fan blades 140 being operatively coupled to a fan actuation system 144 configured to collectively vary the pitch of the fan blades 140 in unison, as detailed further below. The fan actuation system 144 is disposed within a fan hub 148. The fan blades 140, the fan disk 142, and the fan actuation system 144 are together rotatable about the longitudinal centerline axis 112 via a fan shaft 145 that is powered by the LP shaft 136 across a power gearbox, also referred to as a gearbox assembly 146.

The gearbox assembly 146 is shown schematically in FIG. 1. The gearbox assembly 146 includes a plurality of gears for adjusting the rotational speed of the fan shaft 145 and, thus, the fan 138 relative to the LP shaft 136. The gearbox assembly 146 has a gear ratio in a range from 3.5:1 to 5:1 for a ducted engine (e.g., the turbofan engine 110). The LP shaft 136, the gearbox assembly 146, and the fan shaft 145 are disposed in an in-line configuration such that the LP shaft 136, the gearbox assembly 146, and the fan shaft 145 are coaxial and are each disposed about the longitudinal centerline axis 112. The in-line configuration helps to reduce the space needed within the turbofan engine 110 for the gearbox assembly 146 and allows a greater amount of torque to be transferred from the LP shaft 136 to the fan shaft 145 through the gearbox assembly 146 as compared to turboprop engines in which the gearbox assembly is typically disposed in a stepped configuration and is not coaxial with the LP shaft and the fan shaft.

The fan disk 142 is covered by a fan hub 148 that rotates and is aerodynamically contoured to promote an airflow through the plurality of fan blades 140. In addition, the fan assembly 114 includes an annular fan casing or a nacelle 150 that circumferentially surrounds the fan 138 and at least a portion of the core cowl 118. In this way, the turbofan engine 110 is a ducted engine. The nacelle 150 is supported relative to the core cowl 118 by a plurality of fan guide vanes 152, also referred to as outlet guide vanes, that is spaced circumferentially about the nacelle 150. Moreover, a downstream section 154 of the nacelle 150 extends over an outer portion of the core cowl 118 to define a bypass airflow passage 156 therebetween.

During operation of the turbofan engine 110, a volume of air 158 enters the turbofan engine 110 through an inlet 160 of the nacelle 150 or the fan assembly 114. As the volume of air 158 passes across the fan blades 140, a first portion of air, referred to as bypass air 162, is directed or routed into the bypass airflow passage 156, and a second portion of air, referred to as core air 164, is directed or is routed into the upstream section of the core air flow path, or, more specifically, into the core inlet 120 of the LP compressor 122. The ratio between the bypass air 162 and the core air 164 is commonly known as a bypass ratio. The pressure of the core air 164 is then increased by the LP compressor 122 to form compressed air 165, and the compressed air 165 is routed through the HP compressor 124 and into the combustion section 126, where the compressed air 165 is mixed with fuel and burned to generate combustion gases 166.

The combustion gases 166 are routed into the HP turbine 128 and expanded through the HP turbine 128 where a portion of thermal energy and kinetic energy from the combustion gases 166 is extracted via one or more stages of HP turbine stator vanes 168 that are coupled to the core cowl 118 and HP turbine rotor blades 170 that are coupled to the HP shaft 134. This causes the HP shaft 134 to rotate, thereby supporting operation of the HP compressor 124 (e.g., a self-sustaining cycle). In this way, the combustion gases 166 do work in the HP turbine 128 to cause the HP turbine rotor blades 170 (and the HP shaft 134) to rotate at a sufficient rate to maintain the compression ratio of the HP compressor 124 (e.g., self-sustaining cycle). The combustion gases 166 are then routed into the LP turbine 130 and expanded through the LP turbine 130. Here, a second portion of the thermal energy and the kinetic energy is extracted from the combustion gases 166 via one or more stages of LP turbine stator vanes 172 that are coupled to the core cowl 118 and LP turbine blades 174 that are coupled to the LP shaft 136. This causes the LP shaft 136 to rotate, thereby supporting operation of the LP compressor 122 and rotation of the fan 138 via the gearbox assembly 146 (e.g., a self-sustaining cycle). In this way, the combustion gases 166 do work in the LP turbine 130 to cause the LP turbine blades 174 (and the LP shaft 136) to rotate.

The combustion gases 166 are subsequently routed through the core exhaust nozzle 132 to provide propulsive thrust at a thrust level of the turbofan engine 110. The thrust level of the turbofan engine 110 includes a cruise thrust level defined by a cruise Mach number M_{cruise} that is the Mach number of the turbofan engine 110 at cruise conditions, or mid-level power conditions. Simultaneously, the bypass air 162 is directed through the bypass airflow passage 156 before being exhausted from a fan exhaust nozzle 176 of the turbofan engine 110, also providing propulsive thrust. The HP turbine 128, the LP turbine 130, and the core exhaust nozzle 132 at least partially define a hot gas path 178 for routing the combustion gases 166 through the turbofan engine 110.

The turbofan engine 110 depicted in FIG. 1 is by way of example only. In other aspects, the turbofan engine 110 may have other suitable configurations. In other aspects, any other suitable number or configuration of compressors, turbines, shafts, or a combination thereof may be provided. The turbofan engine 110 may also be a direct drive engine, which does not have a power gearbox. The fan speed is the same as the LP shaft speed for a direct drive engine. In still other aspects, aspects of the present disclosure may be incorporated into other suitable turbofan engines, such as, for example, propfan (e.g., unducted fan) engines.

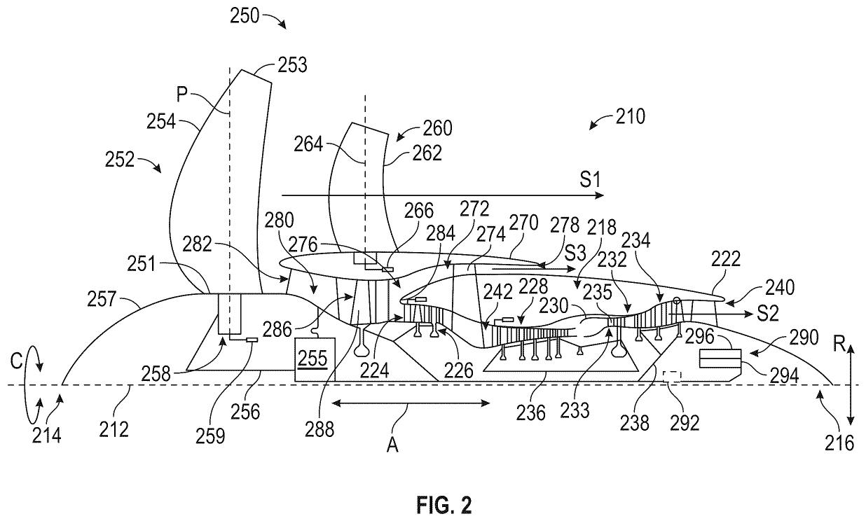

FIG. 2 shows a schematic view of an unducted, three-stream, turbofan engine 210 for an aircraft, that may incorporate one or more aspects of the present disclosure. In this way, the turbofan engine 210 is an unducted fan engine or an open fan engine. The turbofan engine 210 is a “three-stream engine” in that its architecture provides three distinct streams (labeled S1, S2, and S3) of thrust-producing airflow during operation, as detailed further below.

As shown in FIG. 2, the turbofan engine 210 defines an axial direction A, a radial direction R, and a circumferential direction C. Moreover, the turbofan engine 210 defines a longitudinal centerline axis 212 that extends along the axial direction A. In general, the axial direction A extends parallel to the longitudinal centerline axis 212, the radial direction R extends outward from, and inward to, the longitudinal centerline axis 212 in a direction orthogonal to the axial direction A, and the circumferential direction C extends three hundred sixty degrees (360°) around the longitudinal centerline axis 212. The turbofan engine 210 extends between a forward end 214 and an aft end 216, e.g., along the axial direction A.

The turbofan engine 210 includes a fan assembly 250, a compressor section, a combustion section, a turbine section, and an exhaust section. Particularly, as shown in FIG. 2, the turbofan engine 210 includes an engine core 218 and a core cowl 222 that annularly surrounds the compressor section, the combustion section, and the turbine section. The core cowl 222 define a core inlet 224 having an annular shape that is annular about the longitudinal centerline axis 212. The core cowl 222 further encloses and supports a low-pressure (LP) compressor 226 (also referred to as a booster) for pressurizing the air that enters the turbofan engine 210 through the core inlet 224. A high-pressure (HP) compressor 228 receives pressurized air from the LP compressor 226 and further increases the pressure of the air. The pressurized air flows downstream to a combustor 230 where fuel is injected into the pressurized air and ignited to raise the temperature and the energy level of the pressurized air, thereby generating combustion gases.

The combustion gases flow from the combustor 230 downstream to a high-pressure (HP) turbine 232. The HP turbine 232 drives the HP compressor 228 through a first shaft, also referred to as a high-pressure (HP) shaft 236 (also referred to as a “high-speed shaft”). In this regard, the HP turbine 232 is drivingly coupled with the HP compressor 228. Together, the HP compressor 228, the combustor 230, and the HP turbine 232 define the engine core 218. The combustion gases then flow to a power turbine or a low-pressure (LP) turbine 234. The LP turbine 234 drives the LP compressor 226 and components of the fan assembly 250 through a second shaft, also referred to as a low-pressure (LP) shaft 238 (also referred to as a “low-speed shaft”). In this regard, the LP turbine 234 is drivingly coupled with the LP compressor 226 and components of the fan assembly 250. The LP shaft 238 is coaxial with the HP shaft 236 in FIG. 2. After driving each of the HP turbine 232 and the LP turbine 234, the combustion gases exit the turbofan engine 210 through a core exhaust nozzle 240. The turbofan engine 210 defines a core flowpath, also referred to as a core duct 242, that extends between the core inlet 224 and the core exhaust nozzle 240. The core duct 242 is an annular duct positioned generally inward of the core cowl 222 along the radial direction R.

The fan assembly 250 includes a fan 252, also referred to as a primary fan. In FIG. 2, the fan 252 is an open rotor fan, also referred to as an unducted fan. However, in other aspects, the fan 252 may be ducted, e.g., by a fan casing or a nacelle circumferentially surrounding the fan 252, similar to the aspect of FIG. 1. The fan 252 includes a plurality of fan blades 254 (only one shown in FIG. 2) that extends in the radial direction R from a fan root 251 to a fan tip 253. The plurality of fan blades 254 is rotatable about the longitudinal centerline axis 212 via a fan shaft 256. As shown in FIG. 2, the fan shaft 256 is coupled with the LP shaft 238 via a speed reduction gearbox or a power gearbox, also referred to as a gearbox assembly 255, e.g., in an indirect-drive configuration.

The gearbox assembly 255 is shown schematically in FIG. 2. The gearbox assembly 255 includes a plurality of gears for adjusting the rotational speed of the fan shaft 256 and, thus, the fan 252 relative to the LP shaft 238 to a more efficient rotational fan speed. The gearbox assembly may have a gear ratio of 4:1 to 12:1, or 7:1 to 12:1, or 4:1 to 10:1, or 5:1 to 9:1, or 6:1 to 9:1, and may be configured in an epicyclic star or a planet gear configuration. Preferably, the gearbox assembly has a gear ratio of 4:1 to 10:1 for an unducted fan engine (e.g., the turbofan engine 210). The gearbox may be a single stage gearbox or a compound gearbox (e.g., having a plurality of stages). The LP shaft 238, the gearbox assembly 255, and the fan shaft 256 are disposed in an in-line configuration such that the LP shaft 238, the gearbox assembly 255, and the fan shaft 256 are coaxial and are each disposed about the longitudinal centerline axis 212.

The fan blades 254 can be arranged in equal spacing around the longitudinal centerline axis 212. Each fan blade 254 extends outwardly from a disk (not shown in FIG. 2) generally along the radial direction R. The disk is covered by a fan hub 257 that is rotatable and aerodynamically contoured to promote an airflow through the plurality of fan blades 254. Each fan blade 254 has a root and a tip, and a span defined therebetween. Each of the plurality of fan blades 254 defines a pitch axis P. In FIG. 2, each of the plurality of fan blades 254 of the fan 252 is rotatable about their respective pitch axis P, e.g., in unison with one another. A fan actuation system 258 controls one or more actuators 259 to pitch the fan blades 254 about their respective pitch axis P. The fan actuation system 258 is disposed within the fan hub 257.

The fan assembly 250 further includes a fan guide vane array 260 that includes a plurality of fan guide vanes 262 (only one shown in FIG. 2) disposed around the longitudinal centerline axis 212. In FIG. 2, the plurality of fan guide vanes 262 is not rotatable about the longitudinal centerline axis 212. Each of the plurality of fan guide vanes 262 has a root and a tip, and a span defined therebetween. The plurality of fan guide vanes 262 can be unshrouded as shown in FIG. 2 or can be shrouded, e.g., by an annular shroud spaced outward from the tips of the fan guide vanes 262 along the radial direction R. Each of the plurality of fan guide vanes 262 defines a vane pitch axis 264. In FIG. 2, each of the plurality of fan guide vanes 262 of the fan guide vane array 260 is rotatable about their respective vane pitch axis 264, e.g., in unison with one another. One or more actuators 266 are controlled to pitch the plurality of fan guide vanes 262 about their respective vane pitch axis 264. In other aspects, each of the plurality of fan guide vanes 262 is fixed or is unable to be pitched about the vane pitch axis 264. The plurality of fan guide vanes 262 is mounted to a fan cowl 270.

The fan cowl 270 annularly encases at least a portion of the core cowl 222 and is generally positioned outward of the core cowl 222 along the radial direction R. Particularly, a downstream section of the fan cowl 270 extends over a forward portion of the core cowl 222 to define a fan flowpath, also referred to as a fan duct 272. Incoming air enters through the fan duct 272 through a fan duct inlet 276 and exits through a fan exhaust nozzle 278 to produce propulsive thrust. The fan duct 272 is an annular duct positioned generally outward of the core duct 242 along the radial direction R. The fan cowl 270 and the core cowl 222 are connected together and supported by a plurality of struts 274 (only one shown in FIG. 2) that extends substantially radially and are circumferentially spaced about the longitudinal centerline axis 212. The plurality of struts 274 is each aerodynamically contoured to direct air flowing thereby. Other struts, in addition to the plurality of struts 274, can be used to connect and to support the fan cowl 270 and the core cowl 222.

The turbofan engine 210 also defines or includes an inlet duct 280. The inlet duct 280 extends between an engine inlet 282 and the core inlet 224 and the fan duct inlet 276. The engine inlet 282 is defined generally at the forward end of the fan cowl 270 and is positioned between the fan 252 and the fan guide vane array 260 along the axial direction A. The inlet duct 280 is an annular duct that is positioned inward of the fan cowl 270 along the radial direction R. Air flowing downstream along the inlet duct 280 is split, not necessarily evenly, into the core duct 242 and the fan duct 272 by a splitter 284 of the core cowl 222. The inlet duct 280 is wider than the core duct 242 along the radial direction R. The inlet duct 280 is also wider than the fan duct 272 along the radial direction R.

The fan assembly 250 also includes a mid-fan 286. The mid-fan 286 includes a plurality of mid-fan blades 288 (only one shown in FIG. 2). The plurality of mid-fan blades 288 is rotatable, e.g., about the longitudinal centerline axis 212. The mid-fan 286 is drivingly coupled with the LP turbine 234 via the LP shaft 238. The plurality of mid-fan blades 288 can be arranged in equal circumferential spacing about the longitudinal centerline axis 212. The plurality of mid-fan blades 288 is annularly surrounded (e.g., ducted) by the fan cowl 270. In this regard, the mid-fan 286 is positioned inward of the fan cowl 270 along the radial direction R. The mid-fan 286 is positioned within the inlet duct 280 upstream of both the core duct 242 and the fan duct 272. A ratio of a span of a fan blade 254 to that of a mid-fan blade 288 (a span is measured from a root to tip of the respective blade) is greater than 2 and less than 10, to achieve the desired benefits of the third stream (S3), particularly, the additional thrust it offers to the engine, which can enable a smaller diameter fan blade 254 (benefits engine installation).

Accordingly, air flowing through the inlet duct 280 flows across the plurality of mid-fan blades 288 and is accelerated downstream thereof. At least a portion of the air accelerated by the mid-fan blades 288 flows into the fan duct 272 and is ultimately exhausted through the fan exhaust nozzle 278 to produce propulsive thrust. Also, at least a portion of the air accelerated by the plurality of mid-fan blades 288 flows into the core duct 242 and is ultimately exhausted through the core exhaust nozzle 240 to produce propulsive thrust. Generally, the mid-fan 286 is a compression device positioned downstream of the engine inlet 282. The mid-fan 286 is operable to accelerate air into the fan duct 272, also referred to as a secondary bypass passage.

During operation of the turbofan engine 210, an initial airflow or an incoming airflow passes through the fan blades 254 of the fan 252 and splits into a first airflow and a second airflow. The first airflow bypasses the engine inlet 282 and flows generally along the axial direction A outward of the fan cowl 270 along the radial direction R. The first airflow accelerated by the fan blades 254 passes through the fan guide vanes 262 and continues downstream thereafter to produce a primary propulsion stream or a first thrust stream S1. A majority of the net thrust produced by the turbofan engine 210 is produced by the first thrust stream S1. The second airflow enters the inlet duct 280 through the engine inlet 282.

The second airflow flowing downstream through the inlet duct 280 flows through the plurality of mid-fan blades 288 of the mid-fan 286 and is consequently compressed. The second airflow flowing downstream of the mid-fan blades 288 is split by the splitter 284 located at the forward end of the core cowl 222. Particularly, a portion of the second airflow flowing downstream of the mid-fan 286 flows into the core duct 242 through the core inlet 224. The portion of the second airflow that flows into the core duct 242 is progressively compressed by the LP compressor 226 and the HP compressor 228, and is ultimately discharged into the combustion section. The discharged pressurized air stream flows downstream to the combustor 230 where fuel is introduced to generate combustion gases or products.

The combustor 230 defines an annular combustion chamber that is generally coaxial with the longitudinal centerline axis 212. The combustor 230 receives pressurized air from the HP compressor 228 via a pressure compressor discharge outlet. A portion of the pressurized air flows into a mixer. Fuel is injected by a fuel nozzle (omitted for clarity) to mix with the pressurized air thereby forming a fuel-air mixture that is provided to the combustion chamber for combustion. Ignition of the fuel-air mixture is accomplished by one or more igniters (omitted for clarity), and the resulting combustion gases flow along the axial direction A toward, and into, a first stage turbine nozzle 233 of the HP turbine 232. The first stage turbine nozzle 233 is defined by an annular flow channel that includes a plurality of radially extending, circumferentially spaced nozzle vanes 235 that turn the combustion gases so that the combustion gases flow angularly and impinge upon first stage turbine blades of the HP turbine 232. The combustion gases exit the HP turbine 232 and flow through the LP turbine 234, and exit the core duct 242 through the core exhaust nozzle 240 to produce a core air stream, also referred to as a second thrust stream S2. As noted above, the HP turbine 232 drives the HP compressor 228 via the HP shaft 236, and the LP turbine 234 drives the LP compressor 226, the fan 252, and the mid-fan 286 via the LP shaft 238.

The other portion of the second airflow flowing downstream of the mid-fan 286 is split by the splitter 284 into the fan duct 272. The air enters the fan duct 272 through the fan duct inlet 276. The air flows generally along the axial direction A through the fan duct 272 and is ultimately exhausted from the fan duct 272 through the fan exhaust nozzle 278 to produce a third stream, also referred to as a third thrust stream S3.

The third thrust stream S3 is a secondary air stream that increases fluid energy to produce a minority of total propulsion system thrust. In some aspects, a pressure ratio of the third stream is higher than that of the primary propulsion stream (e.g., a bypass or a propeller driven propulsion stream). The thrust may be produced through a dedicated nozzle or through mixing of the secondary air stream with the primary propulsion stream or a core air stream, e.g., into a common nozzle. In certain aspects, an operating temperature of the secondary air stream is less than a maximum compressor discharge temperature for the engine. Furthermore, aspects of the third stream (e.g., airstream properties, mixing properties, or exhaust properties), and thereby a percent contribution to total thrust, are passively adjusted during engine operation or can be modified purposefully through the use of engine control features (such as fuel flow, electric machine power, variable stators, variable inlet guide vanes, valves, variable exhaust geometry, or fluidic features) to adjust or to improve overall system performance across a broad range of potential operating conditions.

The turbofan engine 210 depicted in FIG. 2 is by way of example only. In other aspects, the turbofan engine 210 may have other suitable configurations. For example, the fan 252 can be ducted by a fan casing or a nacelle such that a bypass passage is defined between the fan casing and the fan cowl 270. Moreover, in other aspects, any other suitable number or configuration of compressors, turbines, shafts, or a combination thereof may be provided. Further, aspects of the present disclosure may be incorporated into any other suitable turbofan engine, such as, for example, turbofan engines defining two streams (e.g., a bypass stream and a core air stream).

Further, in FIG. 2, the turbofan engine 210 includes an electric machine 290 (e.g., a motor-generator) operably coupled with a rotating component thereof. In this regard, the turbofan engine 210 is a hybrid-electric propulsion machine. Particularly, as shown in FIG. 2, the electric machine 290 is operatively coupled with the LP shaft 238. The electric machine 290 can be mechanically connected to the LP shaft 238, either directly, or indirectly, e.g., by way of a gearbox assembly 292 (shown schematically in FIG. 2). Further, although the electric machine 290 is operatively coupled with the LP shaft 238 at an aft end of the LP shaft 238, the electric machine 290 can be coupled with the LP shaft 238 at any suitable location or can be coupled to other rotating components of the turbofan engine 210, such as the HP shaft 236 or the LP shaft 238. For instance, in some aspects, the electric machine 290 can be coupled with the LP shaft 238 and positioned forward of the mid-fan 286 along the axial direction A. In some aspects, the turbofan engine of FIG. 1 also includes an electric machine coupled to the LP shaft and located in the tail cone of the engine.

In some aspects, the electric machine 290 can be an electric motor operable to drive or to motor the LP shaft 238. In other aspects, the electric machine 290 can be an electric generator operable to convert mechanical energy into electrical energy. In this way, electrical power generated by the electric machine 290 can be directed to various engine systems or aircraft systems. In some aspects, the electric machine 290 can be a motor/generator with dual functionality. The electric machine 290 includes a rotor 294 and a stator 296. The rotor 294 is coupled to the LP shaft 238 and rotates with rotation of the LP shaft 238. In this way, the rotor 294 rotates with respect to the stator 296, thereby generating electrical power. Although the electric machine 290 has been described and illustrated in FIG. 2 as having a particular configuration, the present disclosure may apply to electric machines having alternative configurations. For instance, the rotor 294 or the stator 296 may have different configurations or may be arranged in a different manner than illustrated in FIG. 2.

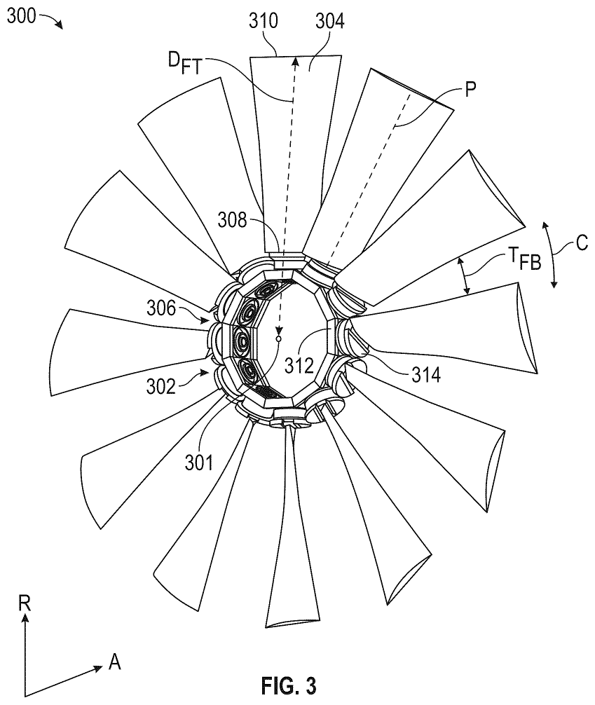

FIG. 3 shows a fan 300 having a fan actuation system 302, according to the present disclosure. The fan 300 can be utilized as the fan 138 of FIG. 1 or as the fan 252 of FIG. 2. The fan 300 includes a plurality of fan blades 304 that is coupled to a disk 306 and is spaced circumferentially about a longitudinal centerline axis 301 of the fan 300. The fan 300 includes a number of fan blades, and, in particular, includes ten to eighteen fan blades 304. In FIG. 3, the fan 300 includes twelve fan blades 304. Each fan blade 304 extends in the radial direction R along a span of the fan blade 304 and from a fan root 308 to a fan tip 310. Each fan blade 304 has a fan tip diameter D_{FT} that extends from the longitudinal centerline axis 301 to the fan tip 310 of each fan blade 304. While the fan tip diameter D_{FT} is detailed with respect to the plurality of fan blades 304, the fan tip diameter D_{FT} is a measurement of any of the fan blades detailed herein. The fan tip diameter D_{FT} is in a range from seven feet to fourteen feet (7 ft. to 14 ft.), as detailed further below. A tangential fan blade distance T_{FB} is defined in the circumferential direction C as a circumferential distance or a tangential distance between adjacent fan blades 304. As used herein, adjacent means two fan blades with no intervening fan blade therebetween.

The disk 306 includes a plurality of disk segments 312 that is rigidly coupled together or integrally molded together in a generally annular shape. One fan blade 304 is coupled to each disk segment 312 at a trunnion mechanism 314 of the fan actuation system 302. The trunnion mechanism 314 facilitates retaining the respective fan blade 304 on the disk 306 during rotation of the disk 306, while still rendering the respective fan blade 304 rotatable relative to the disk 306 about a pitch axis P of the fan blade 304. For example, the trunnion mechanism 314 provides a load path to the disk 306 for the centrifugal load generated by the fan blade 304 during rotation of the fan blade 304 about the longitudinal centerline axis 301. The trunnion mechanism 314 includes a plurality of bearings disposed within the disk segment 312 that allows the fan blade 304 to rotate about the pitch axis P.

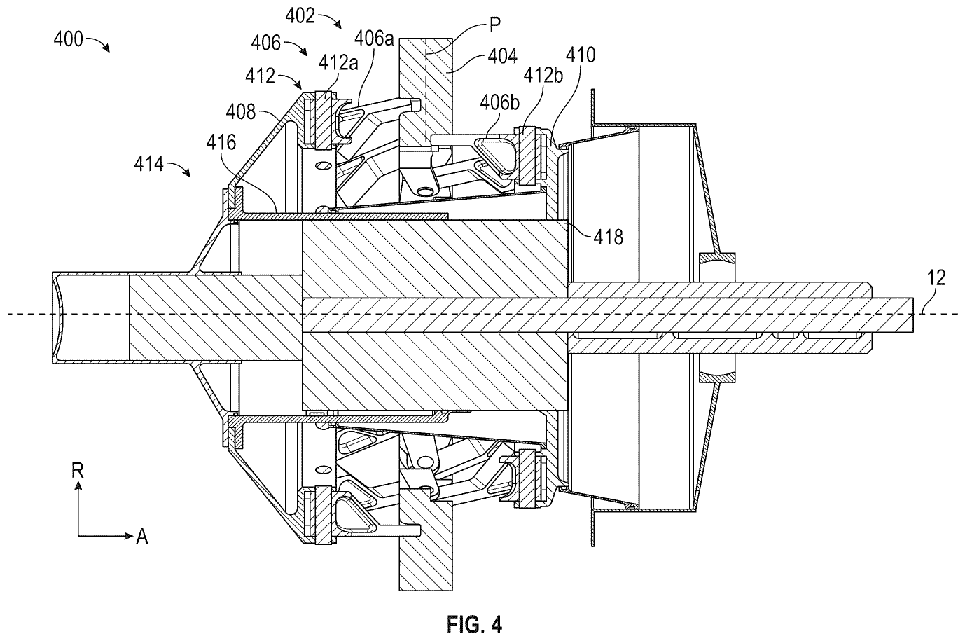

FIG. 4 is a schematic cross-sectional diagram of a fan actuation system 400 for a turbofan engine, taken along a longitudinal centerline axis 112 of the turbofan engine, according to the present disclosure. The fan actuation system 400 can be utilized for any of the fans detailed herein. The fan actuation system 400 includes a trunnion mechanism 402 and one or more actuators 414. The trunnion mechanism 402 includes a plurality of trunnions 404. Each fan blade of the fan is coupled to a respective trunnion 404. Each of the plurality of trunnions 404 is rotatable about a pitch axis P to pitch the fan blades of the fan. The trunnion mechanism 402 includes a plurality of trunnion links 406 that is coupled to the plurality of trunnions 404. For example, a respective trunnion link 406 is coupled to a respective trunnion 404. The plurality of trunnion links 406 includes a plurality of forward trunnion links 406a and a plurality of aft trunnion links 406b that are coupled to the plurality of trunnions 404. The plurality of forward trunnion links 406a is pivotably coupled to the plurality of trunnions 404.

The trunnion mechanism 402 includes a plurality of unison rings 408, 410 including a forward unison ring 408 positioned forward of the plurality of trunnions 404 and an aft unison ring 410 positioned aft of the plurality of trunnions 404. The forward unison ring 408 and the aft unison ring 410 couple the plurality of trunnions 404 together. The plurality of trunnion links 406 is coupled to the forward unison ring 408 or the aft unison ring 410 via a plurality of pins 412. The plurality of forward trunnion links 406a is pivotably coupled to the forward unison ring 408 by a plurality of forward pins 412a such that the plurality of trunnions 404 is coupled to the forward unison ring 408. For example, each forward trunnion link 406a extends forward from a respective trunnion 404 to the forward unison ring 408 and a respective forward pin 412a is disposed through the forward trunnion link 406a at the forward unison ring 408 to pivotably couple the forward trunnion link 406a to the forward unison ring 408. Each aft trunnion link 406b extends aftward from the respective trunnion 404 to the aft unison ring 410 and a respective aft pin 412b is disposed through the aft trunnion link 406b at the aft unison ring 410 to pivotably couple the aft trunnion link 406b to the aft unison ring 410. In this way, each of the plurality of trunnions 404 is pivotably coupled to the forward unison ring 408 and to the aft unison ring 410 such that the plurality of trunnions 404 can pivot about the pitch axis P in unison.

The one or more actuators 414 include a hydraulic cylinder 416 and a piston 418 disposed within the hydraulic cylinder 416. The hydraulic cylinder 416 and the piston 418 are movable along the axial direction A. In this way, the one or more actuators 414 are hydraulic linear actuators such that the hydraulic cylinder 416 and the piston 418 move linearly along the axial direction A (e.g., in opposite directions along the longitudinal centerline axis 112). The forward unison ring 408 is coupled to the hydraulic cylinder 416 such that the forward unison ring 408 moves when the hydraulic cylinder 416 moves. The aft unison ring 410 is coupled to the piston 418 such that aft unison ring 410 moves when the piston 418 moves.

In operation, the fan actuation system 400 moves the plurality of fan blades 140 (FIG. 1) between a first end position and a second end position. The first end position, referred to herein as a feather position, corresponds to a position in which the plurality of fan blades 140 produces the least (e.g., minimal) amount of resistance or drag. In some examples, this position corresponds to a position in which the plurality of fan blades 140 is aligned or substantially aligned (e.g., ±5°) with the flow of the volume of air (e.g., the volume of air 158 of FIG. 1). The second end position is a reverse position in which the plurality of fan blades 140 exceeds, for example, a plane that is transverse to the longitudinal centerline axis 112 (the direction of forward movement of the aircraft) by a certain degree (e.g., 30°) so as to assist with the braking of the aircraft. Therefore, in some examples, the angular stroke of the plurality of fan blades 140 between the feather position and the reverse position is, for example, approximately 120°. The plurality of fan blades 140 can be moved to any position or any angle between the feather position and the reverse position depending on the phase of flight to improve (e.g., optimize) efficiency of the turbofan engine 110 (FIG. 1). In some examples, one or more stops or limits are provided to prevent the plurality of fan blades 140 from being rotated beyond the two end positions. In other examples, the fan actuation system 400 can be configured to provide a greater stroke or a lesser stroke and/or the end positions may be different.

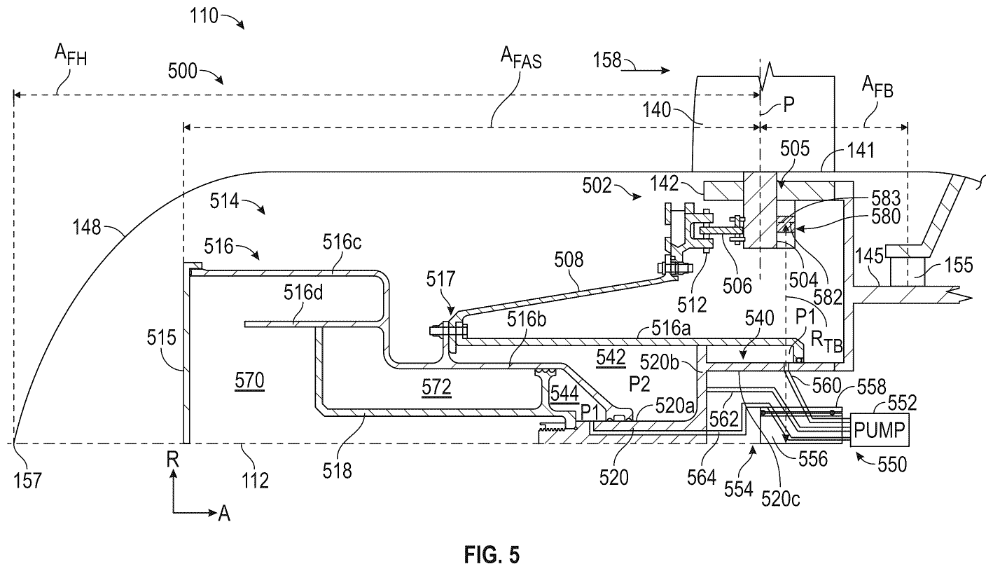

A hydraulic system supplies a hydraulic fluid (e.g., oil) to one or more hydraulic chambers of the one or more actuators 414 to move the hydraulic cylinder 416 and the piston 418 to pitch the plurality of fan blades 140. An exemplary hydraulic system and hydraulic chambers are detailed below with respect to FIG. 5. The plurality of trunnions 404 is disposed in FIG. 4 such that the plurality of fan blades 140 is in the first end position (e.g., the feather position). The pressure of the hydraulic fluid in the one or more hydraulic chambers can be increased to move the hydraulic cylinder 416 in a first direction and to move the piston 418 in a second direction such that the plurality of trunnions 404 move the plurality of fan blades 140 from the feather position towards the reverse position (e.g., the second end position). For example, the hydraulic cylinder 416 can move axially aftward (e.g., to the right in FIG. 4) and the piston 418 can move axially forward (e.g., to the left in FIG. 4) when the pressure of the hydraulic fluid is increased. To move the plurality of fan blades 140 from the reverse position to the feather position, the pressure of the hydraulic fluid in the one or more hydraulic chambers can be decreased to move the hydraulic cylinder 416 in the second direction (e.g., axially forward) and to move the piston 418 in the first direction (e.g., axially aftward).

As the hydraulic cylinder 416 moves axially along the axial direction A, the hydraulic cylinder 416 causes the forward unison ring 408 to move, thereby causing the plurality of forward trunnion links 406a to pivot and to pitch the plurality of trunnions 404, and, therefore, pitching the plurality of fan blades 140 about the pitch axis P. At the same time, movement of the piston 418 along the axial direction A causes the aft unison ring 410 to move, thereby, causing the plurality of aft trunnion links 406b to pivot in an opposite direction as the forward trunnion links 406a, and, therefore, pitching the plurality of fan blades 140 about the pitch axis P. In this way, the fan actuation system 400 translates linear motion of the one or more actuators 414 (e.g., along the axial direction A) into rotational motion of the plurality of fan blades 140. Such a configuration enables a compact and lightweight design of the fan actuation system 400. Further, each of the hydraulic cylinder 416 and the piston 418 provides only half of the force needed to actuate the plurality of trunnions 404 and provides a redundant path in the event that one of the hydraulic cylinder 416 or the piston 418 fails.

FIG. 5 is a schematic cross-sectional view of a fan actuation system 500 for a turbofan engine, according to another aspect. The fan actuation system 500 is shown as being utilized in the turbofan engine 110, but can be utilized in the turbofan engine 210. Only the top half of the fan actuation system 500 is shown in FIG. 5. However, the fan actuation system 500 is symmetrical about the longitudinal centerline axis 112. The fan actuation system 500 may also be referred to as a fan pitch actuation system (FPAS). The fan actuation system 500 controls the pitch (e.g., angle, orientation) of the plurality of fan blades 140 about the pitch axis P. In some examples, the fan actuation system 500 can move the fan blades 140 between a first end position and a second end position.

FIG. 5 shows the fan shaft 145 of the turbofan engine 110 (FIG. 1). The fan shaft 145 is coupled to, and driven by, the LP shaft 136 (FIG. 1). One or more fan bearings 155 support rotation of the fan shaft 145. The one or more fan bearings 155 can include roller bearings, tapered roller bearings, ball bearings, or the like. The one or more fan bearings 155 are disposed aft of the fan disk 142. As shown in FIG. 5, the fan disk 142 is coupled to (e.g., directly or indirectly), and driven by, the fan shaft 145. Each of the plurality of fan blades 140 is coupled to, and extends radially outward from, the fan disk 142. Therefore, as the fan shaft 145 is rotated (via the LP shaft 136), the fan shaft 145 rotates the fan disk 142, which rotates the plurality of fan blades 140 to generate thrust. The fan hub 148 (shown schematically in FIG. 5) includes a fan hub tip 157 that defines an axially forward-most point of the fan hub 148.

The fan actuation system 500 includes a trunnion mechanism 502 including a plurality of trunnions 504. Each fan blade 140 is coupled to a respective one of the plurality of trunnions 504. The plurality of trunnions 504 extends through an opening 505 in the fan disk 142. The plurality of trunnions 504 is rotatable in the opening 505. This enables the plurality of fan blades 140 to rotate about the pitch axis P. As such, the pitch of the plurality of fan blades 140 can be changed relative to the flow of the volume of air 158. In particular, the plurality of fan blades 140 can be rotated (e.g., pitched) to any position between the first end position (e.g., the feather position) and the second end position (e.g., the reverse position). In FIG. 5, the plurality of fan blades 140 is shown in the feather position. In the feather position, the plurality of fan blades 140 is substantially aligned with the flow of the volume of air 158, which reduces resistance or drag. The plurality of fan blades 140 is typically held in the feather position when the turbofan engine 110 (FIG. 1) is not operating.

The fan actuation system 500 includes a plurality of trunnion links 506 and a unison ring 508. The plurality of trunnion links 506 is pivotably coupled to the plurality of trunnions 504. For example, each trunnion link 506 is coupled to a respective trunnion 504 and to the unison ring 508. In this way, the unison ring 508 couples the plurality of trunnions 504 together. The plurality of trunnion links 506 is coupled to the unison ring 508 via a plurality of pins 512. In this way, the plurality of trunnions 504 is pivotably coupled to the unison ring 508 such that the plurality of trunnions 504, and, thus, the plurality of fan blades 140, can pivot about the pitch axis P in unison, as detailed further below.

The fan actuation system 500 includes one or more actuators 514 that include a hydraulic cylinder 516, a piston 518, and a piston retainer 520. The piston retainer 520 is coupled (e.g., bolted) to the fan shaft 145 such that the piston retainer 520 rotates with the fan shaft 145. Therefore, the piston retainer 520 is coupled (e.g., indirectly) to, and rotated by, the LP shaft 136 (FIG. 1). Also, the piston 518 is coupled to, and extends in a forward direction, from the piston retainer 520. Therefore, the piston 518 also rotates with the piston retainer 520 and the fan shaft 145. The hydraulic cylinder 516 also rotate with the piston retainer 520 and the piston 518, but is axially slidable relative to the piston retainer 520 and the piston 518, as disclosed in further detail herein. In some examples, the hydraulic cylinder 516 is disposed within the fan hub 148 (FIG. 1) of the turbofan engine 110 (FIG. 1).

In the illustrated example of FIG. 5, the piston retainer 520 has a first portion 520a (e.g., a post), a second portion 520b (e.g., a flange) that extends radially outward from the first portion 520a, and a third portion 520c (e.g., a shaft) that extends axially from the second portion 520b. The third portion 520c is coupled (e.g., bolted) to the fan shaft 145. The piston retainer 520 can be constructed as multiple parts coupled (e.g., welded) together or as a single unitary part or component (e.g., a monolithic structure). The piston 518 is coupled to, and extends forward from, the first portion 520a of the piston retainer 520.

The hydraulic cylinder 516 is disposed radially outward of (e.g., around, surrounding) the piston retainer 520 and the piston 518. The hydraulic cylinder 516 is keyed to the piston retainer 520. As such, the piston retainer 520 rotates the hydraulic cylinder 516. However, the hydraulic cylinder 516 is slidable along the piston retainer 520 in the axial direction A (left and right in FIG. 5). This movement is used to change the pitch of the plurality of fan blades 140. The hydraulic cylinder 516 is coupled to the unison ring 508 at a joint 517 such that the hydraulic cylinder 516 is coupled to the plurality of fan blades 140 via the trunnion mechanism 502. The fan actuation system 500 can be activated to move the hydraulic cylinder 516 axially (left or right in FIG. 5), which causes the plurality of trunnion links 506 to rotate the plurality of trunnions 504, which rotates the plurality of fan blades 140 about the pitch axis P. As such, movement of the hydraulic cylinder 516 causes all of the fan blades 140 to rotate (e.g., pitch) simultaneously. When the hydraulic cylinder 516 is moved in a first axial direction (the forward direction, or to the left in FIG. 5), the plurality of fan blades 140 is rotated to the feather position, and when the hydraulic cylinder 516 is moved in a second axial direction (the rearward direction, or to the right in FIG. 5), the plurality of fan blades 140 is rotated away from the feather position and toward the reverse position. However, in other examples, the fan actuation system 500 can be configured so that the movement of the hydraulic cylinder 516 is reversed.

The hydraulic cylinder 516 has a first portion 516a, a second portion 516b, a third portion 516c, and a fourth portion 516d. The first portion 516a extends generally in the axial direction A and is coupled to the unison ring 508 at the joint 517 (e.g., a bolted joint). The second portion 516b is disposed radially inward of the first portion 516a and is coupled to the first portion 516a and to the unison ring 508 at the joint 517. The third portion 516c extends forward from the joint 517 (e.g., from the first portion 516a, the second portion 516b, and the unison ring 508) and forms a pressurized pneumatic chamber 570, disclosed in further detail herein. The fourth portion 516d is coupled to, and extends axially within, the third portion 516c. The first portion 516a, the second portion 516b, the third portion 516c, and the fourth portion 516d form the hydraulic cylinder 516. In some examples, the first portion 516a, the second portion 516b, the third portion 516c, and the fourth portion 516d are separate parts or components that are coupled (e.g., welded, bolted) together. In other examples, one or more of the first portion 516a, the second portion 516b, the third portion 516c, and the fourth portion 516d can be constructed as a single unitary part or component (e.g., a monolithic structure). In some aspects, the hydraulic cylinder 516 and the unison ring 508 form a single unitary part or component.

The first portion 516a of the hydraulic cylinder 516 is sealingly engaged with (e.g., engaged with a seal to prevent fluid leakage) the third portion 520c of the piston retainer 520. The second portion 520b of the piston retainer 520 is sealingly engaged with the first portion 516a of the hydraulic cylinder 516. The second portion 516b of the hydraulic cylinder 516 is sealingly engaged with the first portion 520a of the piston retainer 520. The piston 518 is sealingly engaged with the second portion 516b and with the fourth portion 516d of the hydraulic cylinder 516.

The fan actuation system 500 includes one or more hydraulic chambers defined between the hydraulic cylinder 516, the piston 518, and the piston retainer 520. These hydraulic chamber(s) are used to control the position of the hydraulic cylinder 516, and, thus, to control the pitch of the plurality of fan blades 140. As shown in FIG. 5, the fan actuation system 500 includes a first hydraulic chamber 540, a second hydraulic chamber 542, and a third hydraulic chamber 544. The first hydraulic chamber 540 is formed or is defined between the first portion 516a of the hydraulic cylinder 516, the second portion 520b of the piston retainer 520, and the third portion 520c of the piston retainer 520. The second hydraulic chamber 542 is formed or is defined between the first portion 516a of the hydraulic cylinder 516, the second portion 516b of the hydraulic cylinder 516, the first portion 520a of the piston retainer 520, and the second portion 520b of the piston retainer 520. The third hydraulic chamber 544 is formed or is defined between second portion 516b of the hydraulic cylinder 516, an aft end of the piston 518, and the first portion 520a of the piston retainer 520. In this example, the first hydraulic chamber 540 and third hydraulic chamber 544 are provided with hydraulic fluid at a first pressure, referred to herein as P1, and the second hydraulic chamber 542 is provided with hydraulic fluid at a second pressure, referred to herein as P2. The first pressure P1 and the second pressure P2 can be any amount depending on the specific design. In some examples, the first pressure P1 and the second pressure P2 can be as high as one thousand pounds per square inch (1000 psi) or even higher. The first pressure P1 and the second pressure P2 can be increased or can be decreased to cause the hydraulic cylinder 516 to move axially forward or axially rearward, thus changing the pitch of the plurality of fan blades 140. For example, if the force acting on the hydraulic cylinder 516 from the first pressure P1 in the first hydraulic chamber 540 and the third hydraulic chamber 544 is greater than the force acting on the hydraulic cylinder 516 from the second pressure P2 in the second hydraulic chamber 542, the hydraulic cylinder 516 moves (e.g., slides) rearward (axially aftward, or to the right in FIG. 5) along the piston 518 and the piston retainer 520. Conversely, if the force acting on the hydraulic cylinder 516 from the first pressure P1 in the first hydraulic chamber 540 and the third hydraulic chamber 544 is less than the force acting on the hydraulic cylinder 516 from the second pressure P2 in the second hydraulic chamber 542, the hydraulic cylinder 516 moves (e.g., slides) axially forward (to the left in FIG. 5) along the piston 518 and the piston retainer 520. Therefore, the first hydraulic chamber 540 and the third hydraulic chamber 544 receive hydraulic fluid to move the hydraulic cylinder 516 in the rearward direction (e.g., aftward direction) while the second hydraulic chamber 542 receives hydraulic fluid to move the hydraulic cylinder 516 in the forward direction.

The fan actuation system 500 includes a hydraulic system 550 to provide hydraulic fluid, such as oil, to one or more of the hydraulic chambers 540, 542, 544 to control the movement of the hydraulic cylinder 516. The hydraulic system 550 includes a pump 552 to control the first pressure P1 and the second pressure P2. The pump 552 is activated to move the hydraulic fluid into, or out of, the hydraulic chambers 540, 542, 544 to increase or to decrease the first pressure P1 and the second pressure P2, and, therefore, to cause the hydraulic cylinder 516 to move forward or to move rearward. In the illustrated example, the hydraulic system 550 includes an oil transfer bearing 554. The oil transfer bearing 554 includes a fixed portion 556 (e.g., a shaft) with fluid passageways fluidly coupled to the pump 552. The fixed portion 556 is a static component and does not rotate or move axially. The oil transfer bearing 554 includes a sleeve 558 that is rotatable about the fixed portion 556. The hydraulic system 550 includes a first fluid line 560, a second fluid line 562, and a third fluid line 564 fluidly coupled between the oil transfer bearing 554 and the respective hydraulic chambers 540, 542, and 544. The first fluid line 560 is in fluid communication with the first hydraulic chamber 540, the second fluid line 562 is in fluid communication with the second hydraulic chamber 542, and the third fluid line 564 is in fluid communication with the third hydraulic chamber 544. The first fluid line 560, the second fluid line 562, and the third fluid line 564 are coupled to the sleeve 558. The sleeve 558 enables fluid communication among the first fluid line 560, the second fluid line 562, and the third fluid line 564, which are rotating with the fan actuation system 500, and the fixed portion 556 of the oil transfer bearing 554. Thus, the oil transfer bearing 554 enables the hydraulic fluid to be transferred between a stationary component and a rotating component. As disclosed above, the first hydraulic chamber 540 and the third hydraulic chamber 544 are provided with the hydraulic fluid at the same first pressure P1. The oil transfer bearing 554 fluidly couples the hydraulic fluid in the first fluid line 560 and the third fluid lines 564 such that the first hydraulic chamber 540 and the third hydraulic chamber 544 remain at the same first pressure P1.

To move the plurality of fan blades 140 away from the feather position and toward the reverse position, the pump 552 is activated to increase the first pressure P1 in the first hydraulic chamber 540 and the third hydraulic chamber 544 and to reduce the second pressure P2 in the second hydraulic chamber 542. As a result, the hydraulic cylinder 516 moves in the rearward direction (to the right in FIG. 5). The hydraulic cylinder 516 pushes the plurality of trunnion links 506 rearward (to the right in FIG. 5), which causes the plurality of fan blades 140 to rotate away from the feather position and toward the reverse position. In this way, the plurality of fan blades 140 can be moved between the feather position and the reverse position. When the desired position is reached, the pump 552 is deactivated or can otherwise balance the loads on the hydraulic cylinder 516 to maintain the current position. The pump 552 can further increase the first pressure P1 or decrease the second pressure P2 to further move the plurality of fan blades 140 toward the reverse position. Otherwise, to move the plurality of fan blades 140 back to the feather position, the pump 552 is activated to reduce the first pressure P1 in the first hydraulic chamber 540 and the third hydraulic chamber 544 or to increase the second pressure P2 in the second hydraulic chamber 542. Thus, the hydraulic system 550 is used to control the position of the hydraulic cylinder 516 for controlling the pitch of the plurality of fan blades 140 along the pitch axis P. The first pressure P1 being the same in the first hydraulic chamber 540 and the third hydraulic chambers 544 reduces the overall first pressure P1 required to control the hydraulic cylinder 516. In other examples, however, the first hydraulic chamber 540 and the third hydraulic chamber 544 can be pressurized at different pressures.

The pressurized pneumatic chamber 570 is formed or is defined by the third portion 516c of the hydraulic cylinder 516 and the piston 518. The pressurized pneumatic chamber 570 is filled with a pressurized gas. In some examples, the pressurized pneumatic chamber 570 contains pressurized nitrogen. In other examples, the pressurized pneumatic chamber 570 can be filled with another pressurized gas (e.g., air). The pressurized pneumatic chamber 570 is sealed. A such, the volume of the pressurized gas (e.g., nitrogen) in the pressurized pneumatic chamber 570 does not change. During manufacture or assembly of the fan actuation system 500, the pressurized pneumatic chamber 570 can be charged with gas (e.g., nitrogen) and then sealed. The pressurized pneumatic chamber 570 can be pressurized to any amount depending on the size of the pressurized pneumatic chamber 570 and on the size of the hydraulic chambers 540, 542, 544 and the desired biasing force. In some examples, the pressure in the pressurized pneumatic chamber 570 is in a range from seven hundred twenty pounds per square inch to nine hundred twenty pounds per square inch (720 psi to 920 psi). In other examples, however, the pressure may be less than, or greater than, these exemplary values.

The pressurized gas in the pressurized pneumatic chamber 570 generates a constant force or a constant load that biases the hydraulic cylinder 516 in the forward direction (to the left in FIG. 5), which corresponds to the feather position of the plurality of fan blades 140. This provides a failsafe to move the plurality of fan blades 140 to the feather position in an event of failure of the hydraulic system 550 or a shutdown of the turbofan engine 110. For example, if the hydraulic system 550 or the turbofan engine 110 fails or is shut down, the hydraulic system 550 is not able to provide pressurized hydraulic fluid to the hydraulic chambers 540, 542, and 544 to control or to maintain the position of the hydraulic cylinder 516. In such an instance, the force on the hydraulic cylinder 516 from the pressurized gas in the pressurized pneumatic chamber 570 overcomes the force on the hydraulic cylinder 516 from the first hydraulic chamber 540 and the third hydraulic chamber 544. As such, the hydraulic cylinder 516 moves in the forward direction (to the left in FIG. 5), which moves the plurality of fan blades 140 to the feather position shown in FIG. 5. As such, the pressurized pneumatic chamber 570 provides a passive system that moves the plurality of fan blades 140 to the feather position in the event of a failure or a deactivation of the hydraulic system 550, which may occur if the turbofan engine 110 fails or is shut down. Therefore, if one of the turbofan engines of an aircraft fails or is deactivated during flight, the fan actuation system 500 automatically moves the plurality of fan blades 140 to the feather position (FIG. 5). This is advantageous because, in the feather position, the plurality of fan blades 140 produces less resistance, which reduces drag on the turbofan engine 110 and on the aircraft. This also reduces or prevents the plurality of fan blades 140 from spinning (due to incoming airflow) the internal turbo-machinery parts of the turbofan engine 110.

The example pressurized pneumatic chamber 570 is advantageous because it has a high load capability due to the compressibility of the pneumatic gas (e.g., nitrogen). Further, the pressurized pneumatic chamber 570 enables a longer travel of the hydraulic cylinder 516 with relatively little change in load. Therefore, the pressurized pneumatic chamber 570 provides a relatively constant load throughout the stroke. Also, the volume and areas of the pressurized pneumatic chamber 570 and the piston 518 can be varied to optimize the load versus travel of the hydraulic cylinder 516.

Therefore, during normal operation of the fan actuation system 500, the first hydraulic chamber 540 and the third hydraulic chamber 544 act to bias the hydraulic cylinder 516 in the rearward direction, while the second hydraulic chamber 542 and the pressurized pneumatic chamber 570 act to bias the hydraulic cylinder 516 in the forward direction. The pressures in the hydraulic chambers 540, 542, and 544 and in the pressurized pneumatic chamber 570 can be controlled to substantially balance the forces and to maintain the hydraulic cylinder 516 in a desired position. In the illustrated example of FIG. 5, a chamber 572 is formed or is defined between the hydraulic cylinder 516 and the piston 518. The chamber 572 is vented to the atmosphere. As such, the chamber 572 does not provide a force in either direction. In this example, the pressurized pneumatic chamber 570 is forward of the piston retainer 520 and the piston 518. In some examples, this is beneficial because there is additional space forward of these components. In other examples, however, the pressurized pneumatic chamber 570 can be disposed rearward of the piston 518 and the piston retainer 520.

In the example of FIG. 5, the fan actuation system 500 is devoid of a pitch lock device and counterweights for reducing inertial loading associated with rotation of fan blades. In particular, in known fan actuation systems, a separate pitch lock device is required to hold the plurality of fan blades 140 once the plurality of fan blades 140 is in the feather position. Further, in known fan actuation systems, a counterweight is used to provide additional force to help pitch the fan blades. However, with the fan actuation system 500, the pressurized pneumatic chamber 570 provides a constant biasing force to hold the plurality of fan blades 140 in the feather position, which eliminates the need for a separate pitch lock device. Further, the hydraulic system 550 provides the first pressure P1 in both the first hydraulic chamber 540 and the third hydraulic chamber 544 to provide a higher pressure to pitch the fan blades 140, which eliminates the need for a counterweight. This reduces parts, complexity, weight, and costs of the fan actuation system 500.

Examples have been disclosed herein that improve the ability for the fan actuation system 500 to move the fan blades 140 to the feather position in the event of failure of the fan actuation system 500 or a shutdown of the turbofan engine 110. The example systems disclosed herein are passive and, thus, do not require complicated activation components or control systems. The example pressurized pneumatic chamber 570 is capable of handling high rotational speeds and a large variation in operating temperatures, such as encountered during use on aircraft. The examples disclosed herein also eliminate the need for a pitch lock device. As such, the example systems can result in fewer parts, less complexity, reduced weight, and lower costs compared to known systems. The fan actuation system 500 is particularly useful in turbofan engines (e.g., the turbofan engine 110 of FIG. 1 or the turbofan engine 210 of FIG. 2) in which the space for the fan actuation system 500 is smaller as compared to turboprop engines. Components of the fan actuation system 500 can be used in combination with any of the fan actuation systems disclosed herein.

The turbofan engine 110 also includes one or more thrust bearings, also referred to as one or more radial thrust (radial blade load) bearings 580, disposed between the trunnion 504 and the fan disk 142 such that the trunnion 504 rotates about the pitch axis P with respect to the fan disk 142. The one or more radial thrust bearings 580 transmit the load (the radial blade load) from the respective fan blade 140 to a static structure of the turbofan engine 110. In particular, the radial thrust bearings 580 include a plurality of rolling elements 582. The rolling elements 582 can include, for example, ball bearings, tapered roller bearings, or the like, for transmitting the radial blade load from the fan blade 140 to the static structure.

The one or more radial thrust bearings 580 are disposed radially at a thrust bearing radius R_{TB}. The thrust bearing radius R_{TB} is defined in the radial direction R from the longitudinal centerline axis 112 to a radial center 583 of the one or more radial thrust bearings 580. The radial center 583 is a center of the radial thrust bearings 580 in the radial direction R. Particularly, the radial center 583 is defined as a radial center of the rolling elements 582. The amount of space, or the volume, beneath the fan 138 that is available for the fan actuation system 500 is defined by the thrust bearing radius R_{TB}. The fan actuation system 500 needs to be accommodated radially below the one or more radial thrust bearings 580 and within the thrust bearing radius R_{TB}.

The turbofan engine 110 includes a fan hub axial length A_{FH}, a fan actuation system axial length A_{FAS}, and a fan bearing axial length A_{FB}. The fan hub axial length A_{FH} is an axial length, in the axial direction (e.g., parallel with the longitudinal centerline axis 112) from the fan hub tip 157 to the pitch axis P of the fan blades 140. The fan actuation system axial length A_{FAS} is an axial length, in the axial direction (e.g., parallel with the longitudinal centerline axis 112), from an axially forward-most surface 515 of the fan actuation system 500 to the pitch axis P of the fan blades 140. In FIG. 5, the axially forward-most surface 515 is defined by an axially forward-most surface of the actuators 514 (e.g., of the hydraulic cylinder 516). The fan actuation system axial length A_{FAS} is a maximum of 80% of the fan hub axial length A_{FH}. In this way, the fan actuation system 500 fits within the fan hub 148 such that the actuators 514 can move axially without contacting the fan hub 148. The fan bearing axial length A_{FB} is an axial length, in the axial direction (e.g., parallel with the longitudinal centerline axis 112) from the pitch axis P of the fan blades 140 to an axial center of the fan bearings 155.

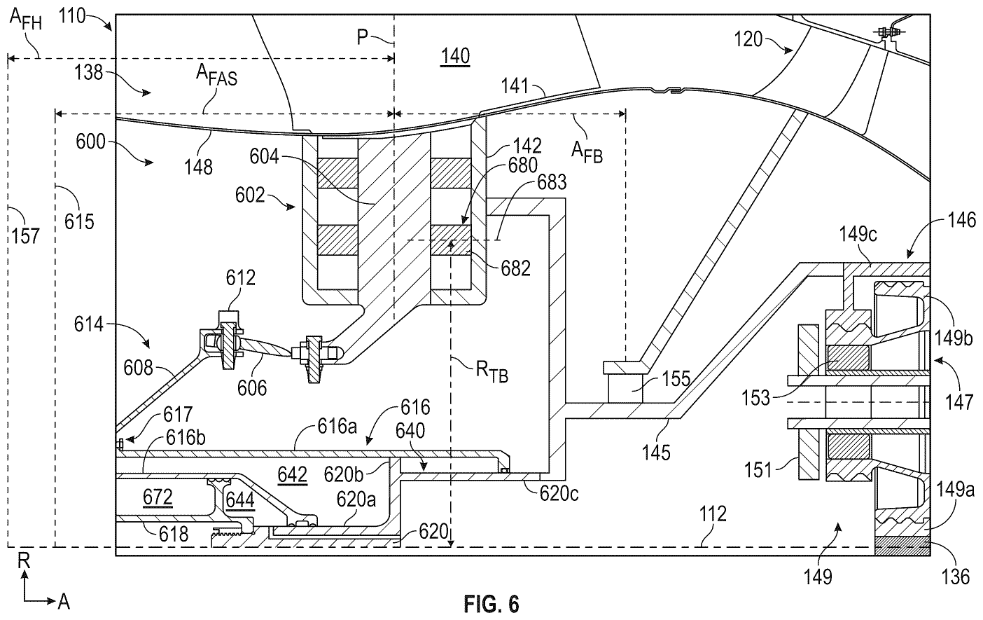

FIG. 6 is a schematic cross-sectional view of a fan actuation system 600 for the turbofan engine 110, taken along the longitudinal centerline axis 112 of the turbofan engine 110, according to the present disclosure. While the fan actuation system 600 is described as being utilized in the turbofan engine 110, the fan actuation system 600 can be utilized in the turbofan engine 210 of FIG. 2. The fan actuation system 600 is substantially similar to the fan actuation system 500 of FIG. 5. The same reference numerals will be used for components of the fan actuation system 600 that are the same as or similar to the components of the fan actuation system 500 discussed above. The description of these components above also applies to this aspect, and a detailed description of these components is omitted here.

The fan actuation system 600 includes a trunnion mechanism 602, a plurality of trunnions 604, a plurality of trunnion links 606, a unison ring 608, a plurality of pins 612, one or more actuators 614, a hydraulic cylinder 616, a joint 617, a piston 618, and a piston retainer 620. The hydraulic cylinder 616 has a first portion 616a and a second portion 616b. Although not shown in the view of FIG. 6, the hydraulic cylinder 616 also includes a third portion and a fourth portion similar to the third portion 516c and the fourth portion 516d of the hydraulic cylinder 516 of FIG. 5. The piston retainer 620 has a first portion 620a, a second portion 620b, and a third portion 620c. The fan actuation system 600 also includes a first hydraulic chamber 640, a second hydraulic chamber 642, a third hydraulic chamber 644, and a pressurized pneumatic chamber (not shown in the view of FIG. 6), and a chamber 672. The first hydraulic chamber 640 and the third hydraulic chamber 644 receive the hydraulic fluid at a first pressure P1, and the second hydraulic chamber 642 receives the hydraulic fluid at a second pressure P2, as detailed above with respect to FIG. 5. The fan actuation system 600 operates substantially similar as to the fan actuation system 500 of FIG. 5.

FIG. 6 shows one fan blade 140 of the fan 138, the core inlet 120, and the gearbox assembly 146. The gearbox assembly 146 includes a gear assembly 147 having a plurality of gears 149 including a first gear 149a, one or more second gears 149b secured by a planet carrier 151, and a third gear 149c. In FIG. 6, the first gear 149a is a sun gear, the one or more second gears 149b are planet gears, and the third gear 149c is a ring gear. The gear assembly 147 is an epicyclic gear assembly. When the gear assembly 147 is an epicyclic gear assembly, the one or more second gears 149b include a plurality of second gears 149b (e.g., two or more second gears 149b).

In the epicyclic gear assembly, the gear assembly 147 can be in a star arrangement or a rotating ring gear type gear assembly (e.g., the third gear 149c is rotating and the planet carrier 151 is fixed and stationary). In such an arrangement, the fan 138 is driven by the third gear 149c. For example, the third gear 149c is coupled to the fan shaft 145 such that rotation of the third gear 149c causes the fan shaft 145, and, thus, the fan 138, to rotate. In this way, the third gear 149c is an output of the gear assembly 147. However, other suitable types of gear assemblies may be employed. In one non-limiting aspect, the gear assembly 147 is a planetary arrangement, in which the third gear 149c is held fixed, with the planet carrier 151 allowed to rotate. In such an arrangement, the fan 138 is driven by the planet carrier 151. For example, the planet carrier 151 is coupled to the fan shaft 145 such that rotation of the planet carrier 151 causes the fan shaft 145, and, thus, the fan 138, to rotate. In this way, the one or more second gears 149b (e.g., via the planet carrier 151) are the output of the gear assembly 147. In another non-limiting aspect, the gear assembly 147 may be a differential gear assembly in which the third gear 149c and the planet carrier 151 are both allowed to rotate. While an epicyclic gear assembly is detailed herein, the gear assembly can include any type of gear assembly including, for example, a single stage gear assembly or a compound gear assembly (e.g., a gear assembly having a plurality of stages).

The plurality of gears 149 includes one or more gear bearings 153 disposed therein. For example, the one or more second gears 149b each includes one or more gear bearings 153 disposed therein. The one or more gear bearings 153 enable the plurality of gears 149 to rotate about the one or more gear bearings 153 such that the plurality of gears 149 rotates. The one or more gear bearings 153 can include any type of bearing for a gear, such as, for example, journal bearings, roller bearings, or the like. The gearbox assembly 146 can include a plurality of gear bearings that includes a forward gear bearing and an aft gear bearing. The one or more gear bearings 153 shown in the view of FIG. 6 are the forward gear bearing.

The first gear 149a is coupled to an input shaft of the turbofan engine 110. For example, the first gear 149a is coupled to the LP shaft 136 such that rotation of the LP shaft 136 causes the first gear 149a to rotate. Radially outward of the first gear 149a, and intermeshing therewith, is the one or more second gears 149b that are coupled together and supported by the planet carrier 151. The planet carrier 151 supports and constrains the one or more second gears 149b such that the each of the one or more second gears 149b is enabled to rotate about a corresponding axis of each second gear 149b without rotating about the periphery of the first gear 149a. Radially outwardly of the one or more second gears 149b, and intermeshing therewith, is the third gear 149c, which is an annular ring gear. The third gear 149c is coupled via an output shaft to the fan 138 and rotates to drive rotation of the fan 138 about the longitudinal centerline axis 112. For example, the fan shaft 145 is coupled to the third gear 149c.

The fan shaft 145 is coupled to the fan disk 142 such that rotation of the fan shaft 145 causes the plurality of fan blades 140 to rotate about the longitudinal centerline axis 112. The turbofan engine 110 also includes one or more radial thrust bearings 680, disposed between the trunnion 604 and the fan disk 142 such that the trunnion 604 rotates about the pitch axis P with respect to the fan disk 142. In particular, the radial thrust bearings 680 include a plurality of rolling elements 682.

The one or more radial thrust bearings 680 are disposed radially at the thrust bearing radius R_{TB} defined in the radial direction R from the longitudinal centerline axis 112 to a radial center 683 of the one or more radial thrust bearings 680, as discussed above. The fan actuation system axial length A_{FAS} is an axial length, in the axial direction (e.g., parallel with the longitudinal centerline axis 112), from an axially forward-most surface 615 (shown schematically in FIG. 6) of the fan actuation system 600 to the pitch axis P of the fan blades 140.

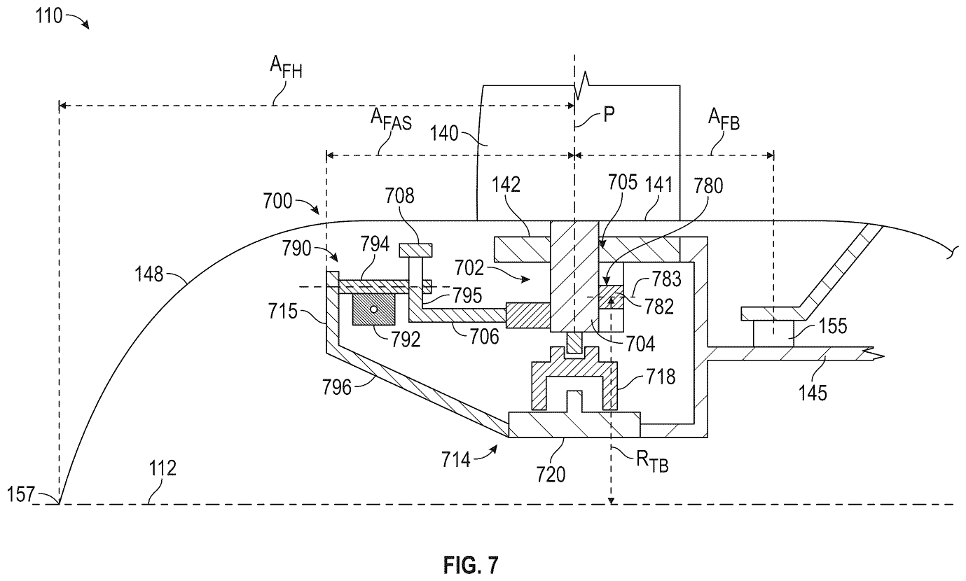

FIG. 7 is a schematic cross-sectional view of a fan actuation system 700 for the turbofan engine 110, taken along the longitudinal centerline axis 112 of the turbofan engine 110, according to the present disclosure. While the fan actuation system 700 is described as being utilized in the turbofan engine 110, the fan actuation system 700 can be utilized in the turbofan engine 210 of FIG. 2. The fan actuation system 700 is substantially similar to the fan actuation system 500 of FIG. 5. The same or similar reference numerals will be used for components of the fan actuation system 700 that are the same as or similar to the components of the fan actuation system 500 discussed above. The description of these components above also applies to this aspect, and a detailed description of these components is omitted here.

The fan actuation system 700 includes a trunnion mechanism 702, a plurality of trunnions 704, an opening 705, one or more trunnion links 706, a unison ring 708, one or more actuators 714, an axially forward-most surface 715, a piston 718, a piston retainer 720, and one or more radial thrust bearings 780. The piston retainer 720 is stationary (e.g., coupled to a static structure of the turbofan engine 110) and the piston 718 moves with respect to the piston retainer 720 to change a pitch of the fan blades 140. For example, the piston 718 can be coupled to a hydraulic cylinder that receives hydraulic fluid for moving the piston 718, as detailed above. The one or more trunnion links 706 include one or more ring gears that mesh with a corresponding gear of the trunnions 704.

The fan actuation system 700 also includes a counterweight assembly 790 including one or more counterweights 792. The counterweights 792 are axially spaced from the trunnions 704 to counter a centrifugal twisting moment of the fan blades 140. The counterweights 792 can be any high-density mass that can rotate about a counterweight centerline. The counterweights 792 can have offset masses that are movable relative to the counterweight centerline. In particular, the counterweights 792 are coupled to one or more counterweight shafts 794 that are drivingly coupled to the trunnion links 706 via one or more counterweight gears 795. The counterweight shafts 794 are supported by one or more counterweight support members 796 that are coupled to the piston retainer 720. In FIG. 7, the axially forward-most surface 715 is defined by an axially forward-most surface of the counterweight support member 796. In this way, the axially forward-most surface 715 is defined by the counterweight assembly 790.

As the trunnions 704 rotate, the trunnions 704 cause the trunnion links 706 to rotate with respect to the unison ring 708, and in turn, the trunnion links 706 cause the counterweight shafts 794 to rotate. As the trunnion links 706 and the counterweight shafts 794 rotate, the counterweights 792 rotate via the counterweight shafts 794. In this way, the counterweights 792 change position relative to the counterweight centerline. Thus, the counterweight assembly 790 counters a centrifugal twisting moment of the fan blades 140 to help rotate the fan blades 140 when the pitch of the fan blades 140 changes.

A mass of the counterweights 792 can be changed based on a length of the counterweight shafts 794. In particular, the counterweights 792 can have less mass with longer counterweight shafts 794 and can have more mass with shorter counterweight shafts 794. In this way, the axially further the counterweights 792 are disposed from the pitch axis P of the fan blades 140, the lesser mass the counterweights 792 can have, while still countering the centrifugal twisting moment of the fan blades 140 and helping to rotate the fan blades 140 when the pitch of the fan blades 140 changes. Accordingly, the mass of the counterweights 792 needed to pitch the fan blades 140 and counter the twisting moment is a function of the axial position of the counterweights 792 with respect to the pitch axis P.

The one or more radial thrust bearings 780 are disposed radially at the thrust bearing radius R_{TB} defined in the radial direction R from the longitudinal centerline axis 112 to a radial center 783 of a plurality of rolling elements 782 of the radial thrust bearings 780, as discussed above. The fan actuation system axial length A_{FAS} is an axial length, in the axial direction (e.g., parallel with the longitudinal centerline axis 112), from an axially forward-most surface 715 of the fan actuation system 700 to the pitch axis P of the fan blades 140.

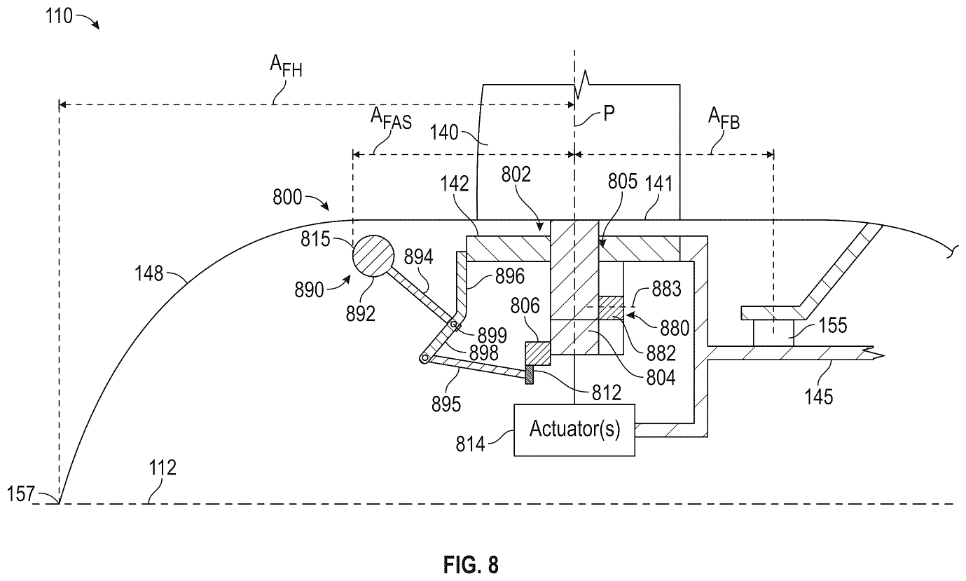

FIG. 8 is a schematic cross-sectional view of a fan actuation system 800 for the turbofan engine 110, taken along the longitudinal centerline axis 112 of the turbofan engine 110, according to the present disclosure. While the fan actuation system 800 is described as being utilized in the turbofan engine 110, the fan actuation system 800 can be utilized in the turbofan engine 210 of FIG. 2. The fan actuation system 800 is substantially similar to the fan actuation system 700 of FIG. 7. The same or similar reference numerals will be used for components of the fan actuation system 800 that are the same as or similar to the components of the fan actuation system 700 discussed above. The description of these components above also applies to this aspect, and a detailed description of these components is omitted here.

The fan actuation system 800 includes a trunnion mechanism 802, a plurality of trunnions 804, an opening 805, one or more trunnion links 806, a plurality of pins 812, one or more actuators 814 (shown schematically in FIG. 8), an axially forward-most surface 815, and one or more radial thrust bearings 880. The actuators 814 can include any of the actuators disclosed herein for changing a pitch of the fan blades 140. The one or more trunnion links 806 include arms that extend from the trunnions 804. The pins 812 extend through the arms and are coupled to a counterweight assembly 890.

The counterweight assembly 890 includes one or more counterweights 892, one or more counterweight shafts 894, and one or more counterweight support members 896. The one or more counterweight support members 896 are coupled to the fan disk 142 such that the counterweight assembly 890 rotates about the longitudinal centerline axis 112 with rotation of the fan 138. The counterweight assembly 890 also includes one or more link arms 895 and one or more lever arms 898. The one or more lever arms 898 are pivotably coupled to the counterweight support members 896 via a pivot 899. The link arms 895 are coupled to the trunnion links 806 via the pins 812 and are pivotably coupled to the lever arms 898. The counterweight shafts 894 are pivotably coupled to the lever arms 898 at the pivot 899.

In FIG. 8, the axially forward-most surface 815 is defined by an axially forward-most surface of the counterweights 892 at a maximum axial extent of the counterweights 892, as detailed further below. In this way, the axially forward-most surface 815 is defined by the counterweight assembly 890.

As the trunnions 804 rotate, the trunnions 804 cause the trunnion links 806 to rotate, and in turn, the trunnion links 806 cause the pins 812 to rotate, and, thus, cause the link arms 895 to pivot. As the link arms 895 pivot, the link arms 895 cause the lever arms 898 to pivot, and, thus, cause the counterweight shafts 894 to pivot about the pivot 899. In this way, the counterweight shafts 894 cause the counterweights 892 to travel along a partially circular arc radially outward away from the longitudinal centerline axis 112 or radially inward towards the longitudinal centerline axis 112. Thus, the counterweight assembly 890 counters a centrifugal twisting moment of the fan blades 140 to help rotate the fan blades 140 when the pitch of the fan blades 140 changes.

The one or more radial thrust bearings 880 are disposed radially at the thrust bearing radius R_{TB} defined in the radial direction R from the longitudinal centerline axis 112 to a radial center 883 of a plurality of rolling elements 882 of the radial thrust bearings 880, as discussed above. The fan actuation system axial length A_{FAS} is an axial length, in the axial direction (e.g., parallel with the longitudinal centerline axis 112), from an axially forward-most surface 815 of the fan actuation system 800 to the pitch axis P of the fan blades 140.

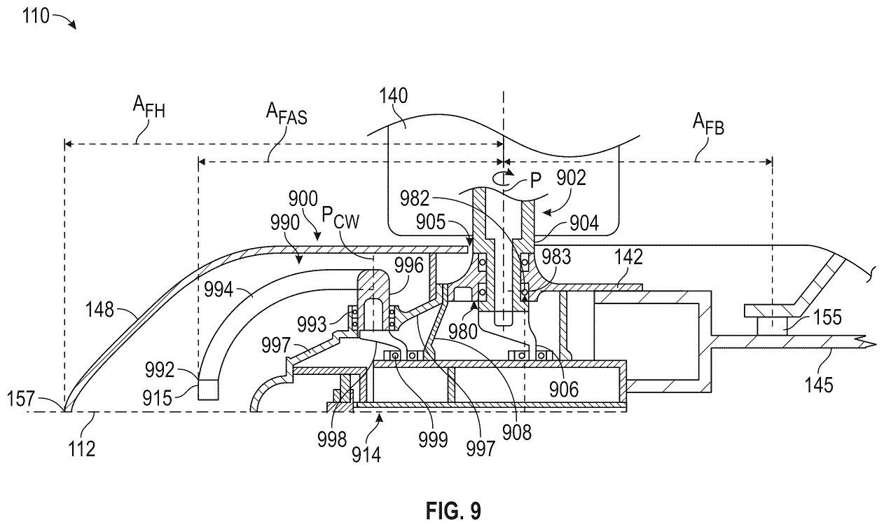

FIG. 9 is a schematic cross-sectional view of a fan actuation system 900 for the turbofan engine 110, taken along the longitudinal centerline axis 112 of the turbofan engine 110, according to the present disclosure. While the fan actuation system 900 is described as being utilized in the turbofan engine 110, the fan actuation system 900 can be utilized in the turbofan engine 210 of FIG. 2. The fan actuation system 900 is substantially similar to the fan actuation system 700 of FIG. 7. The same or similar reference numerals will be used for components of the fan actuation system 900 that are the same as or similar to the components of the fan actuation system 700 discussed above. The description of these components above also applies to this aspect, and a detailed description of these components is omitted here.

The fan actuation system 900 includes a trunnion mechanism 902, a plurality of trunnions 904, an opening 905, one or more trunnion links 906, a unison ring 908, one or more actuators 914, an axially forward-most surface 915, and one or more radial thrust bearings 980. The actuators 914 can include any of the actuators disclosed herein for changing a pitch of the fan blades 140. The one or more trunnion links 906 and the unison ring 908 couple the trunnions 904 to the actuators 914 such that movement of the actuators 914 causes the trunnions 904 to rotate, thus, causing the fan blades 140 to rotate about the pitch axis P.

The counterweight assembly 990 includes one or more counterweights 992, one or more counterweight shafts 994, one or more counterweight support members 996, and one or more lever arms 998. In FIG. 9, the counterweight shafts 994 are counterweight levers and the counterweight support members 996 are counterweight trunnions.

The counterweight assembly 990 includes a counterweight hub 997 that may be connected to the fan disk 142, such that rotation of the fan disk 142 about the longitudinal centerline axis 112 drives rotation of the counterweight hub 997 about the longitudinal centerline axis 112. The counterweight shafts 994 are rotationally connected to the counterweight hub 997. For example, each of the counterweight shafts 994 may be mounted to the counterweight hub 997 via one or more counterweight bearings 993 that provide the ability for the counterweight shafts 994 to rotate about a counterweight lever rotational axis P_{CW}. The counterweight bearings 993 may be any type of bearing (e.g., tapered roller bearings, spherical roller bearings, cylindrical roller bearings, needle roller bearings, thrust ball bearings, angular contact roller bearings, deep groove ball bearings, etc.), and are not limited to any particular type of bearing Each of the counterweight support members 996 are rotational about a counterweight lever rotational axis P_{CW} that extends through a respective counterweight support member 996 and extends radially (i.e., in the radial direction R) from the longitudinal centerline axis 112.

Each counterweight shaft 994 is a cantilever arm having a first end connected to a respective counterweight support member 996 and a second end offset from the respective counterweight lever rotational axis P_{CW}. A respective counterweight 992 is connected to the second end of the counterweight shaft 994. Each counterweight 992 has a counterweight center-of-gravity that is utilized in locating the counterweight 992 within the counterweight assembly 990.

The one or more counterweight support members 996 are coupled to the fan disk 142 such that the counterweight assembly 990 rotates about the longitudinal centerline axis 112 with rotation of the fan 138. The counterweight assembly 990 also includes one or more lever arms 998 that are rotationally connected to the actuators 914 via one or more lever bearings 999. The lever arms 998 are connected to the counterweight support members 996 such that axial translation of the actuators 914 along the longitudinal centerline axis 112 drives the lever arms 998 and the counterweight support members 996 about the respective counterweight lever rotational axis P_{CW} so as to rotate the counterweight shafts 994. In FIG. 9, the counterweight shafts 994 are at a ninety-degree rotated position.

In FIG. 9, the axially forward-most surface 915 is defined by an axially forward-most surface of the counterweights 992 at a maximum axial extent of the counterweights 992 (e.g., at the ninety-degree rotated position). In this way, the axially forward-most surface 915 is defined by the counterweight assembly 990.

As the actuators 914 move axially, the actuators 914 cause the trunnions 904 and the counterweight support members 996 to rotate. In turn, the counterweight support members 996 cause the counterweight shafts 994 to rotate about the counterweight lever rotational axis P_{CW}, and, thus, cause the counterweights 992 to rotate. In particular, the counterweight shafts 994, and the counterweights 992, rotate in to or out of the page between the ninety-degree rotated position that defines a maximum axial extent of the counterweights 992 and a zero-degree rotated position that defines a minimum axial extend of the counterweights 992. Thus, the counterweight assembly 990 counters a centrifugal twisting moment of the fan blades 140 to help rotate the fan blades 140 when the pitch of the fan blades 140 changes.

The one or more radial thrust bearings 980 are disposed radially at the thrust bearing radius R_{TB} defined in the radial direction R from the longitudinal centerline axis 112 to a radial center 983 of a plurality of rolling elements 982 of the radial thrust bearings 980, as discussed above. The fan actuation system axial length A_{FAS} is an axial length, in the axial direction (e.g., parallel with the longitudinal centerline axis 112), from an axially forward-most surface 915 of the fan actuation system 900 to the pitch axis P of the fan blades 140.

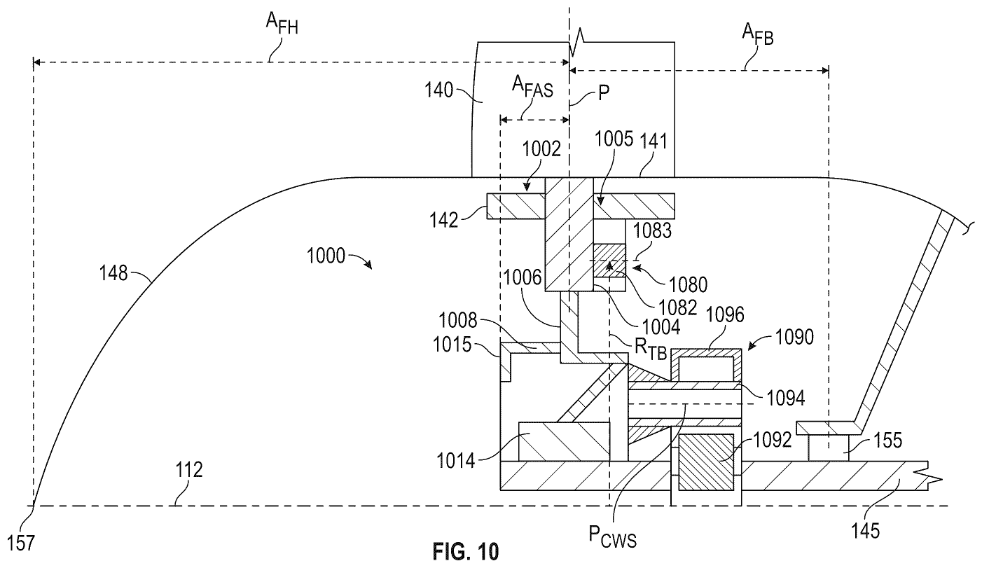

FIG. 10 is a schematic cross-sectional view of a fan actuation system 1000 for the turbofan engine 110, taken along the longitudinal centerline axis 112 of the turbofan engine 110, according to the present disclosure. While the fan actuation system 1000 is described as being utilized in the turbofan engine 110, the fan actuation system 1000 can be utilized in the turbofan engine 210 of FIG. 2. The fan actuation system 1000 is substantially similar to the fan actuation system 500 of FIG. 5. The same or similar reference numerals will be used for components of the fan actuation system 1000 that are the same as or similar to the components of the fan actuation system 500 discussed above. The description of these components above also applies to this aspect, and a detailed description of these components is omitted here.

The fan actuation system 1000 includes a trunnion mechanism 1002, a plurality of trunnions 1004, an opening 1005, one or more trunnion links 1006, a unison ring 1008, one or more actuators 1014, an axially forward-most surface 1015, one or more radial thrust bearings 1080, and a counterweight assembly 1090. The actuators 1014 can include any of the actuators disclosed herein for changing a pitch of the fan blades 140. The one or more trunnion links 1006 and the unison ring 1008 couple the trunnions 1004 to the actuators 1014 such that movement of the actuators 1014 causes the trunnions 1004 to rotate, thus, causing the fan blades 140 to rotate about the pitch axis P. In FIG. 10, the axially forward-most surface 1015 is defined by an axially forward-most surface of the unison ring 1008.

The counterweight assembly 1090 includes one or more counterweights 1092, one or more counterweight shafts 1094, and one or more counterweight support members 1096. The one or more counterweight support members 1096 are coupled to the fan disk 142 via the unison ring 1008 such that the counterweight assembly 1090 rotates about the longitudinal centerline axis 112 with rotation of the fan 138. The counterweights 1092 are positioned axially aft of the fan blades 140, particularly, axially aft of the pitch axis P. For example, the counterweights 1092 are positioned axially between the pitch axis P and the fan bearings 155.

The counterweight support members 1096 act as a carrier for the counterweight shafts 1094. The counterweight shafts 1094 are aligned generally parallel to the longitudinal centerline axis 112 and pass through the counterweight support members 1096. The counterweight shafts 1094 are rotatably connected (e.g., via one or more gears) at a first end to the unison ring 1008. The counterweights 1092 are connected to a second end of the counterweight shafts 1094. The counterweight shafts 1094, and the counterweights 1092, are rotatable relative to the counterweight support members 1096, about a respective counterweight shaft axis P_{CWS}.

All of the counterweight shafts 1094 are meshed via one or more gears with the unison ring 1008. Thus connected, the movement of the fan blades 140, unison ring 1008, and the counterweights 1092 are linked together such that rotary motion of the unison ring 1008, for example, caused by the actuators 1014, will cause a simultaneous change in the pitch angle of all of the fan blades 140, and of the angular orientation of the counterweights 1092. The unison ring 1008 transmits forces between the fan blades 140 and the counterweights 1092. In this way, the counterweight shafts 1094 cause the counterweights 1092 to travel along a partially circular arc radially outward away from the longitudinal centerline axis 112 or radially inward towards the longitudinal centerline axis 112, and axially closer to, or axially further from, the pitch axis P. Thus, the counterweight assembly 1090 counters a centrifugal twisting moment of the fan blades 140 to help rotate the fan blades 140 when the pitch of the fan blades 140 changes.

The one or more radial thrust bearings 1080 are disposed radially at the thrust bearing radius R_{TB} defined in the radial direction R from the longitudinal centerline axis 112 to a radial center 1083 of a plurality of rolling elements 1082 of the radial thrust bearings 1080, as discussed above. The fan actuation system axial length A_{FAS} is an axial length, in the axial direction (e.g., parallel with the longitudinal centerline axis 112), from an axially forward-most surface 1015 of the fan actuation system 1000 to the pitch axis P of the fan blades 140.

As mentioned earlier, the inventors sought to address the problem implementing a variable pitch actuation system within the more limited packaging space available in a turbofan engine and while accounting for the significantly higher loading environment and more numerous blades relative to a turboprop engine. By way of testing various engine architectures the inventors experimented with different configurations of the pitch actuation system, fine and coarse pitch actuators, hydraulic actuators, and bearing placement that could sustain the higher loading associated with more numerous blades, higher disk loading, and Mach speed sufficient to satisfy operational and safety requirements in the event of, e.g., loss of hydraulic pressure. Additionally, while it was possible to arrive at such a system after experiments and testing, there was a challenge to determine how to fit the system within a comparatively more limited space of a turbofan engine.

During the course of evaluating the different embodiments as set forth herein, with the goal of providing the necessary force to pitch the fan blades, taking due account for the number of blades, accounting for loss in fluid pressure or generally lost power conditions, aerodynamic performance, cooling, aeromechanics, and disc loading/fan blade loading, etc., the inventors had discovered there was indeed much less space available for this system to operate as required for the engine's pitch actuation system. After evaluating several different architectures of pitch change mechanisms (with and without counterweight, oil transfer devices, fine and coarse pitch system, torque transfer load path for pitching blades and delivery of shaft power from gearbox, etc.—both for a ducted engine and an open fan engine—it was discovered, unexpectedly, that there is relationships among the number of fan blades, the fan tip diameter D_{FT}, the cruise Mach number, and the thrust bearing radius R_{TB}, and an axial length L_{AXIAL} capable of differentiating an architecture that satisfies operational and packaging requirements from an architecture that does not satisfy these requirements. These relationships moreover are capable of uniquely identifying a finite and readily ascertainable number of embodiments suitable for a particular architecture that accounts for the size and the loading requirements needed to pitch the fan blades without overly sacrificing the aerodynamic performance, cooling aeromechanics, and load margins on the fan blades. For example, the cruise Mach number was not expected to be a significant factor, but as discussed further below, the cruise Mach number was found to be a factor and particularly in conjunction with fan diameter at higher Mach numbers. The inventors submit that the relationships enable one to select a size for the fan pitch actuation system that can reduce the size and the weight of the fan pitch actuation system, while accounting for the factors discussed above. The inventors further submit that the relationships can help identify an improved fan efficiency, or penalties to efficiency by choosing one fan pitch actuation system architecture over another. A relationship is referred to as a fan actuation system (FAS) envelope, in relationship (1):

$$FAS envelope = \frac{{N}_{FB} \times {D}_{FT} \times {M}_{cruise}}{( \frac{{R}_{TB}}{{N}_{FB}} )} . \qquad ( 1 )$$

N_{FB} is the number of fan blades of the fan, D_{FT} is the fan tip diameter, M_{cruise} is the Mach number at cruise (mid-level power operation), and R_{TB} is the thrust bearing radius of the radial thrust bearings (any of the radial thrust bearings detailed herein). N_{FB}×D_{FT}×M_{cruise} is referred to as a loading envelope, and R_{TB}/N_{FB} is referred to as a spacing envelope. Accordingly, the FAS envelope is given by the loading envelope divided by the spacing envelope.

A second relationship is referred to as a fan actuation system length (FASL) envelope, in relationship (2):

$$FASL envelope = \frac{{N}_{FB} \times {D}_{FT}}{{L}_{AXIAL} ( \frac{{R}_{TB}}{{N}_{FB}} )} . \qquad ( 2 )$$

N_{FB} is the number of fan blades of the fan, D_{FT} is the fan tip diameter, R_{TB} is the thrust bearing radius of the radial thrust bearings, and L_{AXIAL} is an axial length, along the longitudinal centerline axis 112 from the fan hub tip 157 to the fan bearings 155. In particular, L_{AXIAL} is a summation of the fan hub axial length A_{FH} and the fan bearing axial length A_{FB}. N_{FB}×D_{FT} is referred to as a loading envelope, and L_{AXIAL}×(R_{TB}/N_{FB}) is referred to as a spacing envelope. Accordingly, the FASL envelope is given by the loading envelope divided by the spacing envelope.

As discussed further below, the inventors identified a range for the FAS envelope and the FASL envelope that enables a fan actuation system design for different turbofan engine architectures that accounts for the integrity/reliability of load paths needed to pitch the fan blades within the space constraints imposed by a turbofan engine (vs. a turboprop's space constraints). Fan pitch actuation system architectures that fall within this range are believed to satisfy packaging requirements for a turbofan engine, while those architectures that do not fall within the FAS envelope range or the FASL envelope range are believed to not satisfy the packaging requirements, which indicate that the system would be unacceptably large and not result in an aircraft engine that met aero efficiency and weight requirements (i.e., an undesirable engine architecture). Using these unique relationships, the size of the fan actuation system can be selected to achieve a more compact fan pitch actuation system for a turbofan engine. Using the FAS envelope or the FASL envelope as a guide, a fan pitch actuation system can be developed that takes into account the loading associated with pitching of the fan blades based on the size of the fan blades, the number of fan blades, the size of thrust bearing, the cruise Mach number, or the axial length, which factors were found—as a result of the extensive number of architectures considered for different thrust class engines, some successful and some not successful—to largely define the packaging size needed to accommodate a pitch actuation system capable of handling the fan loading environment.

Table 1 represents exemplary embodiments 1 to 14 and their corresponding FAS envelope and FASL envelope values for various turbofan engines at various cruise Mach numbers. Embodiments 1 to 14 may represent the turbofan engine 110 of FIG. 1 (e.g., ducted engine) or the turbofan engine 210 of FIG. 2 (e.g., unducted fan engine) and can be applied to any of the pitch actuation systems detailed herein. In particular, embodiments 7, 9, and 13 are ducted engines (e.g., such as the turbofan engine 110 of FIG. 1), and embodiments 1 to 6, 8, 10 to 12, and 14 are unducted fan engines (e.g., such as the turbofan engine 210 of FIG. 2). In Table 1, the FAS envelope values were determined based on relationship (1) described above, the FASL envelope values were determined based on relationship (2) described above, and using fan tip diameters D_{FT}, thrust bearing radiuses R_{TB}, and axial lengths L_{AXIAL} in inches.

TABLE 1

| | | D_{FT} | R_{TB} | A_{FH} | A_{FB} | | FAS | FASL |
|---|---|---|---|---|---|---|---|---|
| Emb. | N_{FB} | (in.) | (in.) | (in.) | (in.) | M_{cruise} | Envelope | Envelope |
| 1 | 12 | 156.0 | 26.9 | 60.60 | 21.60 | 0.8 | 668 | 10.2 |
| 2 | 14 | 156.0 | 24.9 | 60.60 | 20.98 | 0.8 | 982 | 15.1 |
| 3 | 14 | 154.0 | 24.7 | 59.82 | 20.92 | 0.8 | 978 | 15.1 |
| 4 | 14 | 153.8 | 24.3 | 59.75 | 20.79 | 0.8 | 992 | 15.4 |
| 5 | 14 | 164.3 | 24.6 | 63.82 | 20.89 | 0.8 | 1047 | 15.5 |
| 6 | 14 | 110.4 | 19.5 | 42.89 | 19.31 | 0.8 | 888 | 17.8 |
| 7 | 12 | 88.7 | 19.0 | 34.46 | 19.15 | 0.9 | 605 | 12.5 |
| 8 | 10 | 120.0 | 14.8 | 46.62 | 17.85 | 0.9 | 730 | 12.6 |
| 9 | 10 | 84.0 | 14.0 | 32.63 | 17.61 | 0.75 | 450 | 11.9 |
| 10 | 18 | 168.0 | 27.0 | 65.26 | 21.63 | 0.9 | 1814 | 23.2 |
| 11 | 10 | 120 | 14.0 | 46.62 | 17.61 | 0.8 | 686 | 13.3 |
| 12 | 14 | 168.0 | 19.0 | 65.26 | 19.15 | 0.88 | 1525 | 20.5 |
| 13 | 10 | 84.0 | 19.0 | 32.63 | 19.15 | 0.8 | 354 | 8.5 |
| 14 | 14 | 120.0 | 27.0 | 46.62 | 21.63 | 0.88 | 767 | 12.8 |
| 15 | 14 | 180.0 | 19.0 | 69.92 | 19.15 | 0.92 | 1708 | 20.8 |

The FAS envelope and the FASL envelope are only valid for an engine with fan blades N_{FB} in a range from ten to eighteen for a ducted engine, and from ten to sixteen for an open fan engine. In some aspects, the number of fan blades N_{FB} is in ten to fourteen for an open fan engine. The number of fan blades N_{FB} affects the volume (e.g., amount of space) circumscribed by the fan blades. Increasing the number of fan blades N_{FB} increases the amount of airflow that the fan can produce for a particular fan tip diameter and fan rotation speed, but a higher N_{FB} also reduces the tangential distance T_{FB} between fan blades at the fan hub, which impacts the available space for pitch actuation of each individual blade, referring to the space needed per blade for pitch levers, gearing, oil transfer devices, related mechanisms for pitching fan blades and size of load bearing parts of the trunnion and related supporting structure capable of carrying the fan blade loads. This space is at a premium because with an increased number of fan blades the loading capability per blade needs to be satisfied within a smaller space compared to an engine with fewer blades (e.g., such as a turboprop engine). The FAS envelope values and the FASL envelope values account for the number of fan blades N_{FB} selected to increase the amount of airflow but without imposing an unrealistically narrow tangential fan blade distance T_{FB} between adjacent fan blades in order to fit within the desired packaging envelope.

The FAS envelope and the FASL envelope are only valid for a fan tip diameter D_{FT} in a range from eighty-four inches to one hundred ninety-two inches (84.0 in. to 192.0 in.). In some aspects, the FAS envelope and the FASL envelope are valid for a fan tip diameter D_{FT} in a range from eighty-four inches to one hundred eighty inches (84.0 in. to 180.0 in.). In some aspects, the FAS envelope and the FASL envelope are valid for a fan tip diameter D_{FT} in a range from eighty-four inches to one hundred sixty-eight inches (84.0 in. to 168.0 in.). The fan tip diameter D_{FT} also affects the volume needed for supporting the fan blades during operation. Increasing the fan tip diameter D_{FT} increases the fan tip speed for a given rotational speed and therefore the load that needs to get reacted at the trunnion, and torque needed in the pitching mechanism for pitching the blade. The radial spacing between blades and within the volume circumscribed by the fan blades (e.g., within the space circumscribed by the radial thrust bearings) decreases, thereby decreasing the volume beneath the fan and providing less space for the load bearing structure that can react the blade loads. Furthermore, as the bearing radius R_{TB} is extended out, the structure supporting the blade at its root needs to be capable of sustaining higher loads because the blade is disposed further from the fan rotation axis. The more robust root results in a larger fan disk, further providing less space underneath the fan for the fan actuation system. In view of these weight and size considerations, as well as the ability to install such fan blades and fans without resulting in unacceptable aero efficiency penalties, the inventors determined that a fan tip diameter D_{FT} should be less than one hundred ninety-two inches (192.0 in.). In some aspects, the fan tip diameter D_{FT} should be less than one hundred eighty inches (180.0 in.). In some aspects, the fan tip diameter D_{FT} should be less than one hundred sixty-eight inches (168.0 in.). The fan tip diameter D_{FT} may therefore be limited as it impacts the space available for a pitch actuation system suitable for carrying fan blade loads. The size of the fan blades in ducted engines is limited by the duct (e.g., the nacelle). In embodiments for a ducted engine (e.g., the turbofan engine 110 of FIG. 1), the fan tip diameter D_{FT} is in a range from eighty-four inches to one hundred twenty inches (84.0 in. to 120.0 in.). In embodiments for an open fan engine (e.g., the turbofan engine 210 of FIG. 2), the fan tip diameter D_{FT} is in a range from one hundred twenty inches to one hundred ninety-two inches (120.0 in. to 192.0 in.). In some aspects for an open fan engine (e.g., the turbofan engine 210 of FIG. 2), the fan tip diameter D_{FT} is in a range from one hundred twenty inches to one hundred eighty inches (120.0 in. to 180.0 in.). In some aspects for an open fan engine (e.g., the turbofan engine 210 of FIG. 2), the fan tip diameter D_{FT} is in a range from one hundred twenty inches to one hundred sixty-eight inches (120.0 in. to 168.0 in.).

The FAS envelope and the FASL envelope are only valid for a thrust bearing radius R_{TB} in a range from ten inches to twenty-seven inches (10 in. to 27 in.). In some aspects, the thrust bearing radius R_{TB} is in a range from twelve inches to twenty-seven inches (12 in. to 27 in.). In some aspects, the thrust bearing radius R_{TB} is in a range from fourteen inches to twenty-seven inches (14 in. to 27 in.). The thrust bearing radius R_{TB} defines the amount of space, or the volume available for the fan actuation system. Increasing the thrust bearing radius R_{TB} provides more space for the fan actuation system but sacrifices aerodynamic performance by making the fan hub radius ratio (i.e., the ratio of the fan hub radius to the fan blade radius) larger. Decreasing the thrust bearing radius R_{TB} reduces the fan hub radius ratio and reduces the size of the turbofan engine but provides less space to carry the loads from the fan blades. The thrust bearing radius R_{TB} reflects the need for adequately accommodating the diameter needed for packaging the fan actuation system but without overly sacrificing aerodynamic performance of the turbofan engine. In embodiments for a ducted engine (e.g., the turbofan engine 110 of FIG. 1), the thrust bearing radius R_{TB} is in a range from twelve inches to nineteen inches (12 in. to 19 in.). In some aspects for a ducted engine, the thrust bearing radius R_{TB} is in a range from fourteen inches to nineteen inches (14 in. to 19 in.). In embodiments for an open fan engine (e.g., the turbofan engine 210 of FIG. 2), the thrust bearing radius R_{TB} is in a range from ten inches to twenty-seven inches (10 in. to 27 in.). In some aspects for an open fan engine (e.g., the turbofan engine 210 of FIG. 2), the thrust bearing radius R_{TB} is in a range from twelve inches to twenty-seven inches (12 in. to 27 in.). In some aspects for an open fan engine, the thrust bearing radius R_{TB} is in a range from nineteen inches to twenty-seven inches (19 in. to 27 in).

The FAS envelope and the FASL envelope are valid for a cruise Mach number M_{cruise} in a range from 0.7 to 0.92. In some aspects, the FAS envelope and the FASL envelope are valid for a cruise Mach number M_{cruise} in a range from 0.7 to 0.9. As mentioned above, turbofan engines operate at higher cruise speeds than turboprop engines. At higher cruise speeds, the aerodynamic loads on fan blades increase, thereby requiring more torque for actuating blades in pitch. This means a larger actuation system is needed to handle the higher reaction loads resulting when a torque is applied in flight to change the blade pitch, to move the blade to a feathered position, or coarse/fine pitch changes. The cruise Mach number M_{cruise} reflects this higher loading environment when pitching fan blades. In some aspects, the cruise Mach number M_{cruise} in a range from 0.75 to 0.9. In some aspects, the cruise Mach number M_{cruise} is in a range from 0.8 to 0.88.

The FAS envelope and the FASL envelope are only valid for a fan hub axial length A_{FH} of twenty-five inches to eighty-five inches (25 in. to 85 in.). In some aspects, the FAS envelope and the FASL envelope are only valid for a fan hub axial length A_{FH} of twenty-five inches to seventy-five inches (25 in. to 75 in.). In some aspects, the FAS envelope and the FASL envelope are only valid for a fan hub axial length A_{FH} of forty inches to eighty-five inches (40 in. to 85 in.). The fan hub axial length A_{FH} defines the amount of axial space, or the volume available for the fan actuation system, forward of the pitch axis P of the fan blades 140. Increasing the fan hub axial length A_{FH} provides more space for the fan actuation system but increases the overall weight of the turbofan engine. Decreasing the fan hub axial length A_{FH} reduces the fan performance and the pressure distribution to the fan due to a smaller axial length for the aerodynamic flow lines into the fan hub but provides less axial space to fit the fan actuation system within the fan hub 148. The fan hub axial length A_{FH} reflects the need for aerodynamic performance for the fan and adequately accommodating the axial length needed for packaging the fan actuation system but without overly sacrificing aerodynamic performance of the turbofan engine and allowing for a more efficient fan actuation system. In embodiments for a ducted engine (e.g., the turbofan engine 110 of FIG. 1), the fan hub axial length A_{FH} is in a range from twenty-five inches to forty inches (25 in. to 40 in.). In some aspects for an open fan engine (e.g., the turbofan engine 210 of FIG. 2), the fan hub axial length A_{FH} is in a range from twenty-five inches to seventy-five inches (25 in. to 75 in). In some aspects for an open fan engine (e.g., the turbofan engine 210 of FIG. 2), the fan hub axial length A_{FH} is in a range from forty inches to eighty-five inches (40 in. to 85 in). In this way, the fan hub axial length A_{FH} is greater for open fan engines as compared to ducted fan engines as more space is needed due to the longer fan blades of the open fan engines as compared to the ducted engines.

The FAS envelope and the FASL envelope are only valid for a fan bearing axial length A_{FB} of ten inches to twenty-three inches (10 in. to 23 in.). In some aspects, the FAS envelope and the FASL envelope are only valid for a fan bearing axial length A_{FB} of sixteen inches to twenty-three inches (16 in. to 23 in.). The fan bearing axial length A_{FB} defines the amount of axial space, or the volume available for the fan actuation system, aft of the pitch axis P of the fan blades 140. Increasing the fan bearing axial length A_{FB} provides more space for the fan actuation system but increases the overall weight of the engine and increases loads on the bearings. Decreasing the fan bearing axial length A_{FB} decreases overall engine weight and reduces loads on the bearings but provides less axial space to fit the fan actuation system within the fan hub 148. The fan bearing axial length A_{FB} reflects the need for adequately accommodating the axial length needed for packaging the fan actuation system while minimizing the fan bearing axial length AFB to reduce loads on the bearings and reduce overall weight of the engine. In embodiments for a ducted engine (e.g., the turbofan engine 110 of FIG. 1), the fan hub axial length A_{FH} is in a range from seventeen inches to twenty inches (17 in. to 20 in.). In embodiments for an open fan engine (e.g., the turbofan engine 210 of FIG. 2), the fan hub axial length A_{FH} is in a range from ten inches to twenty-three inches (10 in. to 23 in). In some aspects for an open fan engine (e.g., the turbofan engine 210 of FIG. 2), the fan hub axial length A_{FH} is in a range from sixteen inches to twenty-three inches (16 in. to 23 in).

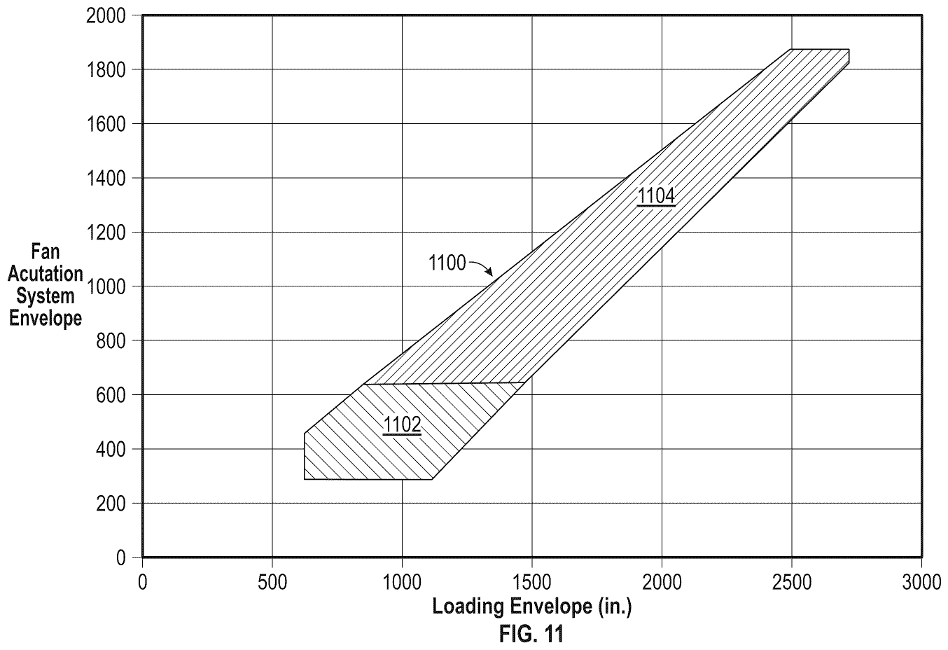

FIG. 11 represents, in graph form, the FAS envelope as a function of the loading envelope (N_{FB}×D_{FT}×M_{cruise}). An area 1100 represents the boundaries of the FAS envelope. The FAS envelope is in a range from three hundred to one thousand eight hundred sixty (300 to 1860) for a loading envelope in a range from five hundred eighty-eight inches to two thousand seven hundred twenty-two inches (588 in. to 2722 in.). Table 1 and FIG. 11 show that the FAS envelope increases as the loading envelope increases. In this way, the FAS envelope increases as the number of fan blades N_{FB}, the fan tip diameter D_{FT}, or the cruise Mach number M_{cruise} increase. The range of the FAS envelope identifies the specific architectures that can accommodate the fan pitch actuation system, accounting for both the mechanisms and structural load paths needed to pitch the fan blades under an aerodynamic loading, but without exceeding the volume available for packaging the pitch actuation system within the limited space of a turbofan engine.

A first area 1102 represents the boundaries of the FAS envelope for ducted engines, such as, for example, the turbofan engine 110 of FIG. 1. A second area 1104 represents the boundaries of the FAS envelope for unducted fan engines, such as, for example, the turbofan engine 210 of FIG. 2. Ducted engines tend to have more limited space for the fan actuation system due to the presence of a fan casing, fan duct, or outer nacelle. On the other hand, the fan actuation system of ducted engines are expected to experience lower loads associated with supporting fan blades and pitching fan blades due to the fan blades having a smaller diameter compared to an open fan engine. The FAS envelope, represented by the first area 1102, is in a range from three hundred to six hundred sixty (300 to 660) for ducted engines. The FAS envelope, represented by the second area 1104, is in a range from six hundred sixty to one thousand eight hundred sixty (660 to 1860) and, preferably, in a range from six hundred sixty to one thousand twenty (660 to 1020) and includes open fan engines.

FIG. 12 represents, in graph form, the FAS envelope as a function of the spacing envelope (R_{TB}/N_{FB}). An area 1200 represents the boundaries of the FAS envelope. The FAS envelope is in a range from three hundred to one thousand eight hundred sixty (300 to 1860) for a spacing envelope in a range from one point three five inches to two point two five inches (1.35 in. to 2.25 in.). Table 1 and FIG. 12 show that the FAS envelope decreases as the spacing envelope increases. In this way, the FAS envelope decreases as the thrust bearing radius R_{TB} increases or the number of fan blades N_{FB} decreases. A first area 1202 represents the boundaries of the FAS envelope for ducted engines, and is in a range from three hundred to six hundred sixty (300 to 660) for ducted engines, as detailed above. A second area 1204 represents the boundaries of the FAS envelope for unducted fan engines, and is in a range from six hundred sixty to one thousand eight hundred sixty (660 to 1860) and, preferably, in a range from six hundred sixty to one thousand twenty (660 to 1020), as detailed above.

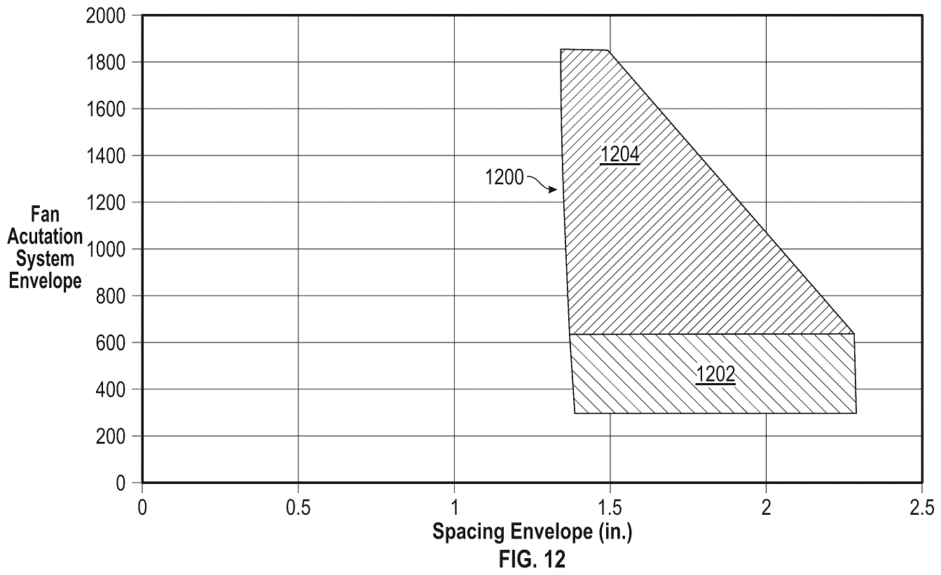

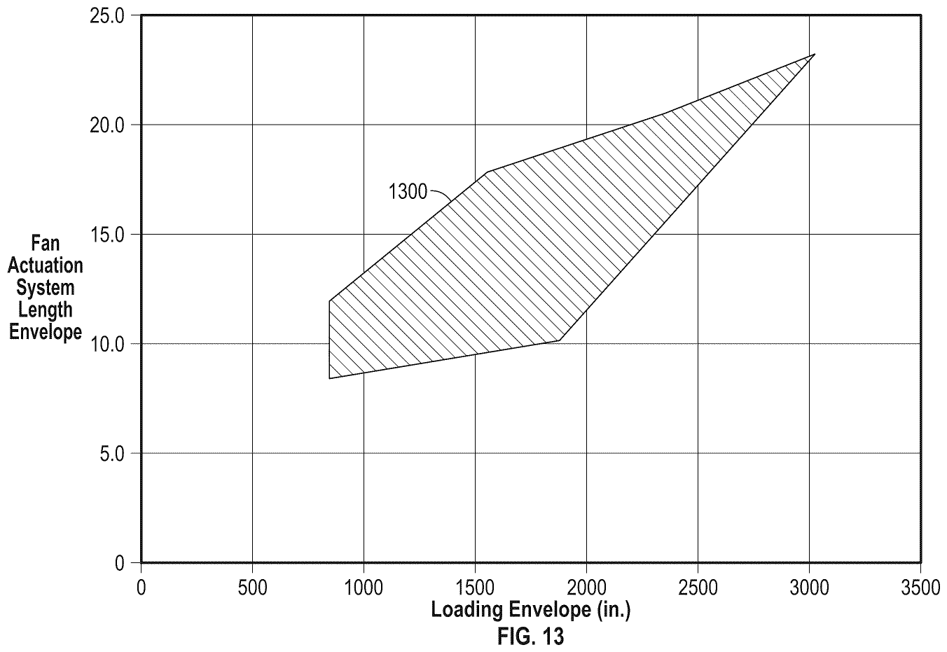

FIG. 13 represents, in graph form, the FASL envelope as a function of the loading envelope (N_{FB}×D_{FT}). An area 1300 represents the boundaries of the FASL envelope. The FASL envelope is in a range from eight point five to twenty-four (8.5 to 24) for a loading envelope in a range from eight hundred forty inches to three thousand twenty-four inches (840 in. to 3,024 in.). Table 1 and FIG. 13 show that the FASL envelope increases as the loading envelope increases. In this way, the FASL envelope increases as the number of fan blades N_{FB} or the fan tip diameter D_{FT} increase. The range of the FASL envelope identifies the specific architectures that can accommodate the fan pitch actuation system, accounting for both the mechanisms and structural load paths needed to pitch the fan blades under an aerodynamic loading, but without exceeding the volume available for packaging the pitch actuation system within the limited space of a turbofan engine. As mentioned above, ducted engines tend to have more limited space for the fan actuation system due to the presence of a fan casing, fan duct, or outer nacelle, while experiencing lower loads associated with supporting fan blades and pitching fan blades due to the fan blades having a smaller diameter compared to an open fan engine. For ducted engines, the FASL envelope is in a range from eight point five to thirteen (8.5 to 13).

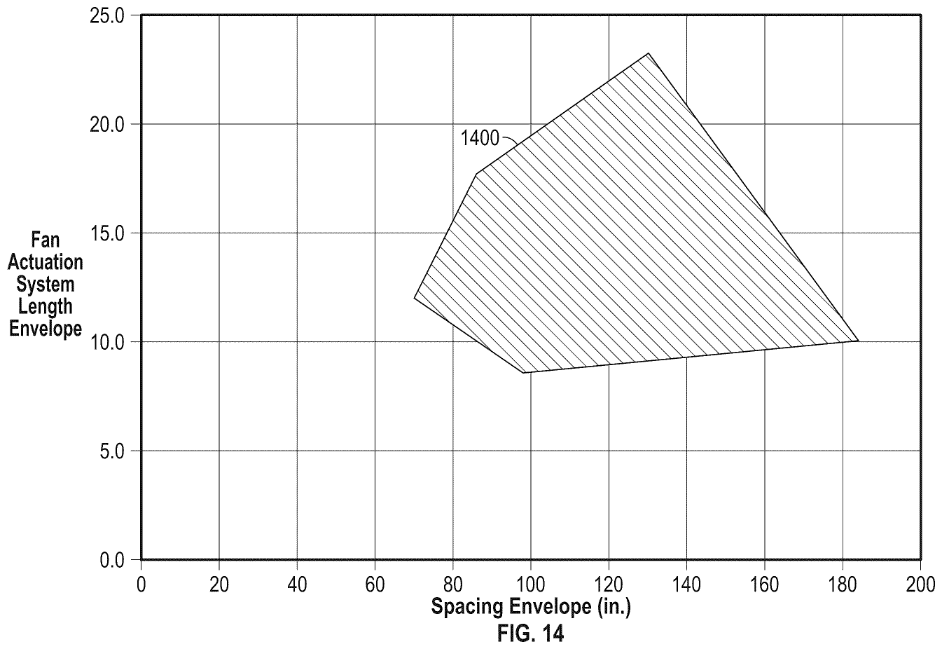

FIG. 14 represents, in graph form, the FASL envelope as a function of the spacing envelope L_{AXIAL}×(R_{TB}/N_{FB}). An area 1400 represents the boundaries of the FASL envelope. The FASL envelope is in a range from eight point five to twenty-four (8.5 to 24) for a spacing envelope in a range from seventy square inches to one hundred eighty-five square inches (70 in.² to 185 in.²). Table 1 and FIG. 14 show that the FASL envelope decreases as the spacing envelope increases. In this way, the FASL envelope decreases as the thrust bearing radius R_{TB} increases, or the number of fan blades N_{FB} or the axial length L_{AXIAL} decreases. As mentioned above, for ducted engines, the FASL envelope is in a range from eight point five to thirteen (8.5 to 13).

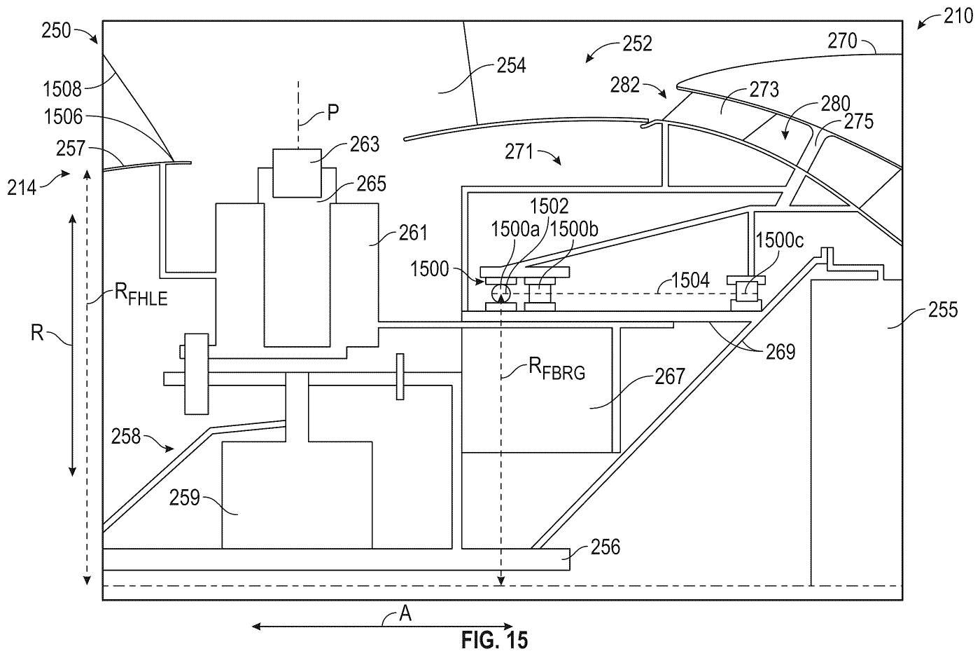

The FAS envelope and the FASL envelope herein provide a fan actuation system a low fan hub radius ratio (a ratio of the hub radius of the blades to the tip radius of the blades of the fan) and a high fan blade count. In one example, a low hub fan radius ratio is in a range from 0.22 to 0.30. This allows the fan diameter to be minimized to meet competing efficiency and installation requirements. To further enable a low fan hub radius ratio, the turbofan engine can include a relatively high fan bearing radius relative to the fan hub radius, as detailed further below with respect to FIGS. 15 to 20. Such a high fan bearing radius allows for a desired packaging of, e.g., the fan actuation system and the fan counterweights. The increased fan bearing radius allows the fan bearings to carry the forward thrust load of the turbofan engine while minimizing, e.g., any moments on the fan bearings in the event of a variation in a distribution of the forward thrust load on the fan bearings. In this way, the high fan bearing radius allows for a variable pitch fan (e.g., the inclusion of a fan actuation system) while maintaining a low fan hub radius ratio and a smaller outer casing, which provides for less drag and a larger frontal area for a given fan blade size.

FIG. 15 is a schematic view of the forward end 214 of the fan assembly 250 of the turbofan engine 210 of FIG. 2. As depicted in FIG. 15, each fan blade 254 defines a base 263 at an inner end along a radial direction R. Each fan blade 254 is coupled at the base 263 to a disk 261 via a trunnion mechanism 265. In FIG. 15, the base 263 is configured as a dovetail received within a correspondingly shaped dovetail slot of the trunnion mechanism 265. In other aspects, the base 263 may be attached to the trunnion mechanism 265 in any other suitable manner. For example, the base 263 may be attached to the trunnion mechanism 265 using a pinned connection, or any other suitable connection. In still other aspects, the base 263 may be formed integrally with the trunnion mechanism 265. Notably, the trunnion mechanism 265 facilitates rotation of a respective fan blade 254 about the pitch axis P of the respective fan blades 254. The fan assembly 250 can also include one or more fan counterweights 267 to balance the fan 252 during operation. Further, the disk 261 is attached to the gearbox assembly 255 through the fan shaft 256, which includes one or more individual structural members 269.

The fan assembly 250 includes a fan frame 271 that is connected to the fan cowl 270 through an inlet vane 273 and a strut 275. In this way, the fan frame 271 is a static or a stationary component that supports static components of the fan assembly 250. While the fan frame 271 is depicted as being connected to the fan cowl 270 through both the inlet vane 273 and the strut 275, the fan frame 271 can be connected to the fan cowl 270 through at least one of the inlet vane 273 or the strut 275.

The fan assembly 250 also includes one or more fan bearings 1500 for supporting rotation of the various rotating components of the fan assembly 250, such as the plurality of fan blades 254 via the fan shaft 256 and the disk 261. More particularly, the various rotating components of the fan assembly 250 rotate with respect to the fan frame 271 via the one or more fan bearings 1500. In FIG. 15, the one or more fan bearings 1500 includes a first fan bearing 1500a, a second fan bearing 1500b, and a third fan bearing 1500c. The first fan bearing 1500a is a ball bearing, the second fan bearing 1500b is a roller bearing, and the third fan bearing 1500c is a roller bearing. The first fan bearing 1500a is positioned forward of the second fan bearing 1500b and the third fan bearing 1500c. The fan bearings 1500 can include any other suitable number or type of bearings for supporting rotation of the plurality of fan blades 254. For example, the one or more fan bearings 1500 can include a pair (two) tapered roller bearings, or any other suitable bearings.

Referring still to FIG. 15, the one or more fan bearings 1500 are located axially aft of the disk 261 and the trunnion mechanisms 265 and radially outward of the one or more actuators 259 along the radial direction R and also outward of the one or more fan counterweights 267 along the radial direction R. In particular, the fan bearings 1500 are located axially between the disk 261 and the gearbox assembly 255. Such a configuration of the fan bearings 1500 allows for the actuators 259 to be axially aligned with the disk 261 and the trunnion mechanisms 265 along the axial direction A and radially inward of the disk 261 and the trunnion mechanisms 265 along the radial direction R. Moreover, such a configuration allows for the one or more fan counterweights 267 to be positioned adjacent to the one or more actuators 259.

As shown in FIG. 15, the one or more fan bearings 1500 define a fan bearing radius R_{FBRG} along the radial direction R. The fan bearing radius R_{FBRG} is defined as a distance along the radial direction R from the longitudinal centerline axis 212 of the turbofan engine 210 to a central axis or a center point of the one or more fan bearings 1500. More particularly, each of the first fan bearing 1500a, the second fan bearing 1500b, and the third fan bearing 1500c are radially aligned such that a center point 1502 of the first fan bearing 1500a and a central axis 1504 of the second fan bearing 1500b and the third fan bearing 1500c are each positioned at the same radial distance from the longitudinal centerline axis 212. In some aspects, one or more of the fan bearings 1500 may be stepped or otherwise positioned at different distances from the longitudinal centerline axis 212 along the radial direction R. In such aspects, the fan bearing radius R_{FBRG} refers to a radius of the innermost fan bearing 1500 along the radial direction R (i.e., a distance of the central point 1502 or the center axis 1504 of the innermost fan bearing 1500 along the radial direction R to the longitudinal centerline axis 212).

The fan hub 257 defines a fan hub leading edge radius R_{FHLE} along the radial direction R. The fan hub leading edge radius R_{FHLE} is defined as a radial distance of an outermost point of the fan hub 257 along the radial direction R to the longitudinal centerline axis 212 of the turbofan engine 210. In particular, the fan hub leading edge radius R_{FHLE} is a distance along the radial direction R from the longitudinal centerline axis 212 to a radially innermost point 1506 of a leading edge 1508 of the fan blades 254 (to the fan root 251 at the leading edge 1508. The fan hub leading edge radius R_{FHLE} is indicative of an overall size of a core portion of the fan assembly 250. Accordingly, the fan assembly 250 defines a fan bearing radius ratio R_{FHLE}:R_{FBRG} (i.e., a ratio of the fan hub leading edge radius R_{FHLE} to the fan bearing radius R_{FBRG}) in a range from 1.0 to 2.75. In some aspects, the fan bearing radius ratio is less than or equal to 2.75, such as less than or equal to 2.5, such as less than or equal to 2.0, such as less than or equal to 1.75. More particularly, the hub radius to fan bearing radius ratio R_{FHLE}:R_{FBRG} is greater than or equal to 1.0 and less than or equal to 1.5.

The plurality of fan blades 254 are rotatable about the axial direction A at a maximum rotational speed during operation of the fan assembly 250. The maximum rotational speed refers to a maximum speed at which the fan blades 254 are configured to rotate during a full power condition of the turbofan engine 210, such as when the turbofan engine 210 is generating a maximum takeoff thrust. The one or more fan bearings 1500 supporting rotation of the plurality of fan blades 254 may define a DN value during operation of the fan assembly 250 and rotation of the plurality of fan blades 254 at the maximum rotational speed of at least about 0.6 million. For example, in certain exemplary embodiments, the one or more fan bearings 1500 supporting rotation of the plurality of fan blades 254 may define a DN value during rotation of the plurality of fan blades 254 of at least 0.7 million, at least 0.8 million, at least 1 million, or at least 1.5 million. As used herein, the term “DN value” refers to a fan bearing speed quantifier calculated by multiplying a bore of the bearing in millimeters by a rotational speed in revolutions per minute (RPM). The bore of the one or more fan bearings 1500 supporting rotation of the plurality of fan blades 254 of the fan assembly 250 refers to a distance from the longitudinal centerline axis 112 to an inner race of the one or more fan bearings 1500.

Accordingly, in order to maintain the DN value of the one or more fan bearings 1500 below one or more of the above stated DN values, the fan assembly 250 may define a relatively low maximum rotational speed during operation. For example, in certain exemplary embodiments, the fan assembly 250 may define a maximum rotational speed in a range from 300 RPM to 8,500 RPM during operation. In some aspects, the maximum rotational speed is less than 8,500 RPM during operation. More specifically, in certain exemplary embodiments, the fan assembly 250 may define a maximum rotational speed of less than 8,000 RPM during operation, less than 7,500 rpm during operation, less than 7,000 RPM during operation, less than 6,500 rpm during operation, or less than 6,000 RPM during operation. In some aspects, the maximum rotational speed is in a range from 300 RPM to 1,100 RPM during operation.

As discussed above, inclusion of a relatively high fan bearing radius relative to a fan hub radius may allow for a desired packaging of, e.g., the fan actuation system and one or more fan counterweights in the fan assembly of the turbofan engine. Moreover, when the turbofan engine is an indirect drive turbofan engine (e.g., including a gearbox connecting a driveshaft and a fan shaft while reducing a rotational speed of the fan shaft relative to the driveshaft) the increased fan bearing radius may additionally provide for a more stable fan during operation. Specifically, with direct drive turbofan engine (e.g., without a gearbox), a forward thrust load generated by the fan during operation may be counteracted by a reverse thrust load generated by the turbine section of the turbofan engine (the turbine section being directly connected to the fan via a shaft in such a configuration). By contrast, within an indirect drive turbofan engine, such as the turbofan engine 110 depicted in FIG. 1 and the turbofan engine 210 in FIG. 2, the forward ball bearing (e.g., the first fan bearing 1500a) is required to carry substantially all of an amount of forward thrust generated by the fan during operation, as the gearbox assembly prevents the LP shaft from offsetting such forward thrust load of the fan with a reverse thrust load of the turbine section. Accordingly, the increased fan bearing radius allows the one or more fan bearings to carry the forward thrust load while minimizing, e.g., any moments on such one or more fan bearings in the event of a variation in a distribution of the forward thrust load on the one or more fan bearings.

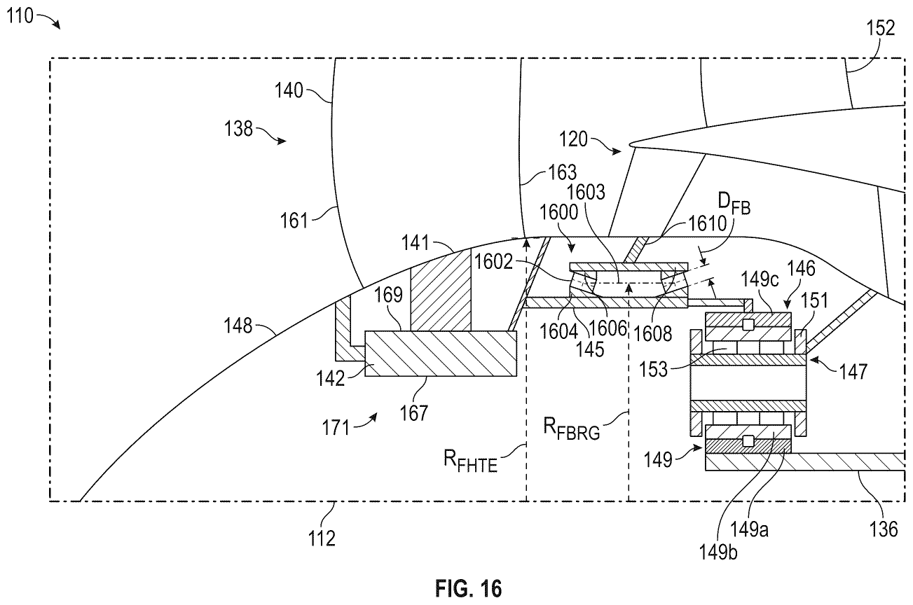

FIG. 16 is an enlarged, schematic, cross-sectional diagram of the turbofan engine 110 of FIG. 1 and having one or more fan bearings 1600, taken along the longitudinal centerline axis 112, according to the present disclosure. While FIG. 16 shows the turbofan engine 110 of FIG. 1, the fan bearings 1600 can also be implemented in the turbofan engine 210 of FIG. 2. FIG. 16 shows one fan blade 140 of the fan 138, the fan disk 142, the core inlet 120, and the gearbox assembly 146. Further, although not shown for clarity, the turbofan engine 110 can include any of the fan actuation systems disclosed herein.

The fan shaft 145 is coupled to the fan disk 142 such that rotation of the fan shaft 145 causes the plurality of fan blades 140 to rotate about the longitudinal centerline axis 112. Each of the fan blades 140 extends from a leading edge 161 and a trailing edge 163. The fan root 141 is at the fan hub 148. The fan disk 142 is defined between an inner surface 167 and an outer surface 169. The inner surface 167 is a radially-most inner surface of the fan disk 142 and the outer surface 169 is a radially-most outer surface of the fan disk 142. The fan disk 142 includes a disk bore 171 defined by the inner surface 167 of the fan disk 142. In particular, the disk bore 171 is defined from the longitudinal centerline axis 112 to the inner surface 167. The fan hub 148 includes a fan hub trailing edge radius R_{FHTE} that is defined in the radial direction from the longitudinal centerline axis 112 to the fan hub 148 at the trailing edge 163 of the fan blades 140.

The turbofan engine 110 also has a fan hub radius ratio that is defined as a ratio of the fan hub trailing edge radius R_{FHTE} to a fan tip radius of the fan blades 140 (e.g., the radius from the longitudinal centerline axis 112 to the fan tip 143 at the trailing edge 163 of the fan blades 140). The fan hub radius ratio is in a range from 0.1 to 0.4. Lower fan hub radius ratios result in lower core engine inlets. A lower fan hub radius and a lower core engine inlet radius result in a core engine with a lesser diameter (e.g., smaller core engine), and, thus, a reduced overall engine weight, as compared to turbofan engines with fan hub radius ratios greater than 0.4. In some aspects, the fan hub radius ratio is in a range from 0.15 to 0.32. In some aspects, the fan hub radius ratio is in a range from 0.2 to 0.35. In some aspects, the fan hub radius ratio is in a range from 0.2 to 0.3. The lower fan hub can also reduce the probability of foreign object damage (FOD), such as, for example, from bird strikes, in the core engine, as the fan tends to push the foreign objects radially outward by the centripetal force imparted to the foreign object by the spinning fan blades. A lower fan hub also improves aerodynamic efficiency of the fan. The lower fan hub radius ratios disclosed herein are enabled by the fan actuation system being characterized by the FASL as detailed above. In particular, the FASL enables a smaller fan actuation system to fit within a tighter packaging underneath the fan while ensuring the fan actuation system can provide an adequate force or torque to pitch the fan blades in the higher loading environment of a turbofan engine (as compared to a turboprop engine). In this way, if the fan actuation system has a FASL that falls within the ranges detailed above, the fan hub radius ratio can be made lower to achieve the improved aerodynamic efficiency of the fan in guiding the incoming airflow into the core inlet.

The fan bearings 1600 are radial thrust (radial shaft load) bearings that transmit a load (e.g., the radial shaft load) from the fan shaft 145 to a static structure of the turbofan engine 110. The fan bearings 1600 each includes one or more rolling elements 1602, an inner race 1604, and an outer race 1606. The fan bearings 1600 support rotation of the fan shaft 145. In FIG. 16, fan bearings 1600 include a forward fan bearing and an aft fan bearing. The rolling elements 1602 are tapered rolling elements that include tapered cylindrical bodies and are disposed between the inner race 1604 and the outer race 1606. In this way, the one or more fan bearings 1600 are roller bearings. The outer race 1606 of each of the fan bearings 1600 is connected to a fan bearing support member 1608. The fan bearing support member 1608 is connected to a fan bearing housing 1610 that is connected to a static component of the turbofan engine 110. The inner race 1604 is connected to the fan shaft 145. In this way, the fan bearings 1600 are connected to the static component and to the fan shaft 145 such that the inner race 1604, and the rolling elements 1602, rotates with respect to the outer race 1606, such that the fan bearings 1600 support rotation of the fan shaft 145.

The fan bearings 1600 are positioned aft, and radially outward, of the fan disk 142. In particular, the fan bearings 1600 are positioned entirely axially aft of the fan disk 142 and entirely radially outward of the fan disk 142 (e.g., radially outward of the outer surface 169 of the fan disk 142). In this way, the fan bearings 1600 are positioned radially outward of the disk bore 171 (e.g., of the inner surface 167) of the fan disk 142. The fan bearings 1600 are positioned axially between the fan disk 142 and the gearbox assembly 146. Further, the fan bearings 1600 are positioned radially outward of the gearbox assembly 146, particularly, radially outward of the third gear 149c.

The fan bearings 1600 have a fan bearing radius R_{FBRG} that is defined in the radial direction from the longitudinal centerline axis 112 to a radial center 1603 of the fan bearings 1600. Particularly, the radial center 1603 of the fan bearings 1600 is the radial center 1603 of the rolling elements 1602. The fan bearings 1600 also have a rolling element diameter D_{FB} of the rolling elements 1602 that is defined as a distance of a straight line passing from side to side of a respective rolling element 1602 through a center (e.g., the radial center 1603) of the respective rolling element 1602.

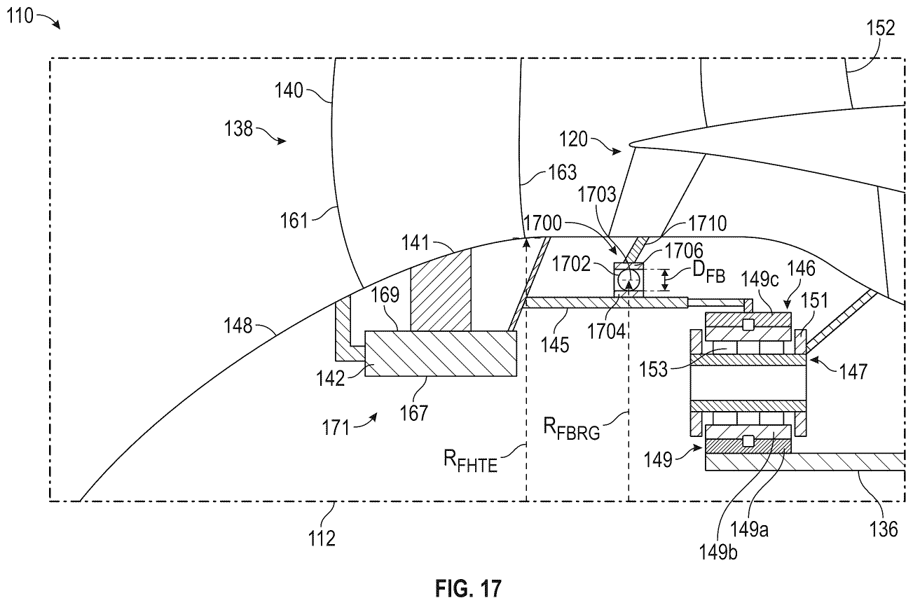

FIG. 17 is an enlarged, schematic, cross-sectional diagram of the turbofan engine 110 and having one or more fan bearings 1700, taken along the longitudinal centerline axis 112, according to another aspect. The fan bearings 1700 are substantially similar to the fan bearings 1600 of FIG. 16. The same reference numerals will be used for components of the fan bearings 1700 that are the same as or similar to the components of the fan bearings 1600 discussed above. The description of these components above also applies to this embodiment, and a detailed description of these components is omitted here.

The fan bearings 1700 each includes one or more rolling elements 1702, an inner race 1704, and an outer race 1706. The fan bearings 1700 support rotation of the fan shaft 145. The rolling elements 1702 are balls that are disposed between the inner race 1704 and the outer race 1706. In this way, the fan bearings 1700 are ball bearings. The turbofan engine 110 also includes a fan bearing housing 1710.

The fan bearings 1700 are positioned aft, and radially outward, of the fan disk 142. In particular, the fan bearings 1700 are positioned entirely axially aft of the fan disk 142 and entirely radially outward of the fan disk 142 (e.g., radially outward of the outer surface 169 of the fan disk 142). In this way, the fan bearings 1700 are positioned radially outward of the disk bore 171 (e.g., of the inner surface 167) of the fan disk 142. The fan bearings 1700 are positioned axially between the fan disk 142 and the gearbox assembly 146. Further, the fan bearings 1700 are positioned radially outward of the gearbox assembly 146, particularly, radially outward of the third gear 149c.

The fan bearings 1700 have a fan bearing radius R_{FBRG} that is defined in the radial direction from the longitudinal centerline axis 112 to a radial center 1703 of the fan bearings 1700 (e.g., of the rolling elements 1702). The fan bearings 1700 also have a rolling element diameter D_{FB} of the rolling elements 1702 that is defined as a distance of a straight line passing from side to side of a respective rolling element 1702 through a center (e.g., the radial center 1703) of the respective rolling element 1702.

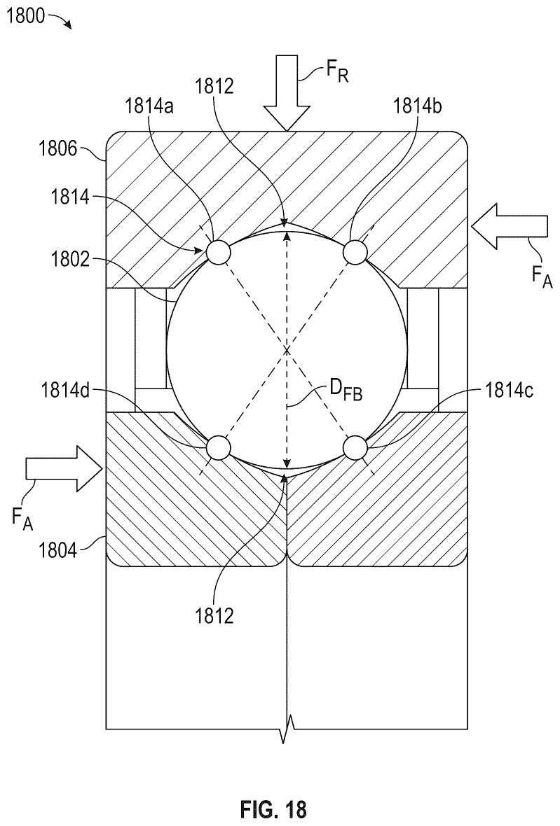

FIG. 18 is a schematic cross-sectional view of a fan bearing 1800 for the turbofan engine 110, according to another aspect. The fan bearing 1800 can be utilized as any of the fan bearings detailed herein. The fan bearing includes one or more rolling elements 1802, an inner race 1804, and an outer race 1806. In some embodiments, the inner race 1804 has a split ring configuration to facilitate easier mounting of the bearing and improved precision. In some embodiments, each of the inner race 1804 and the outer race 1806 defines a concavity having an arch 1812 to allow the rolling element 1802 to have four contact points 1814 with the inner race 1804 and the outer race 1806. In particular, the fan bearing 1800 has two contact points, including a first contact point 1814a and a second contact point 1814b, on the outer race 1806 and two contact points, including a third contact point 1814c and a fourth contact point 1814d, on the inner race 1804. In this way, the fan bearing 1800 is a four-point contact ball bearing. The four-point contact design allows the fan bearing 1800 to handle both radial loads F_{R} and axial loads F_{A} by transmitting the load between the second contact point 1814b and the fourth contact point 1814d, and between the first contact point 1814a and the third contact point 1814c.

In some embodiments, the fan bearing 1800 has a tight bearing configuration, i.e., there is minimal clearance between the rolling elements 1802 and the inner race 1804 and the outer race 1806. In particular, the clearance between the rolling elements 1802 and the inner race 1804 and the outer race 1806 is dimensioned to limit axial movement of the fan shaft 145 (FIG. 1) in relation to the gearbox assembly 146 (FIG. 1) to no greater than 0.010 inches or 10 mil. In some embodiments, the clearance between the rolling elements 1802 and the inner race 1804 and the outer race 1806 is dimensioned to limit axial movement of the fan shaft 145 to no greater than 0.007 inches or 7 mil. The fan bearing 1800 limits axial endplay, i.e., axial movement of the fan shaft 145 in relation to the gearbox assembly 146, thus protecting the gearbox assembly 146 from excessive stress and facilitating a reduction in size and extension of the life of the gearbox assembly 146.

The fan bearing 1800 is designed to withstand extreme conditions including high temperatures, high loads, and high rotational speeds. The materials used to construct the fan bearing 1800 are selected to maximize durability, temperature resistance, and fatigue life. In some embodiments, the fan bearing 1800 can be formed from steel, steel alloys, ceramic materials, cobalt and nickel-based superalloys, or polytetrafluoroethylene (PTFE) and phenolic resins. In addition, the fan bearing 1800 may include coatings, such as, for example, titanium nitride or other anti-friction coatings to further reduce wear and to minimize friction.

The fan bearings of FIGS. 15 to 18 are designed to address the problem of sizing the fan bearings to account for the stresses encountered from the fan shaft, while balancing for minimizing the space under the fan for the fan bearings and other fan components, as well as providing a required amount of thrust for a particular size of the turbofan engine. Additionally, the fan bearings address the challenge in reducing the inner radius of the engine flow path and lowering the fan hub radius ratio, while increasing the fan bearing radius.

Moving the fan bearings aft of the fan disk and increasing the fan bearing radius provide for a reduction in the inner radius of the flow path and the fan hub radius, without overly increasing the heat load on the fan bearings. Further, moving the fan bearings radially outward enables a greater number of rolling elements, which results in a reduced rolling element diameter.

The set of novel embodiments detailed herein include several different architectures of fan bearings and turbofan engines with various sizes and locations. A set of fan bearing designs, producing favorable results, can be characterized by a combination of the fan hub trailing edge radius, the fan bearing radius, the rolling element diameter, and the takeoff thrust, capable of differentiating an architecture that satisfies the operational requirements (e.g., fan bearings capable of handling the stresses from the fan shaft) and the packaging requirements (e.g., lowering the fan hub radius and the inner radius of the flow path) from an architecture that does not satisfy these requirements. As such, a finite and readily ascertainable number of embodiments of the fan bearings account for the operational requirements and the packaging requirements without overly increasing the fan bearing heat load. The novel designs are based on a size of the fan bearings, a size of the rolling elements, and a location of the fan bearings that can reduce the size and the weight of the turbofan engine, while accounting for the factors discussed above. These novel designs can be characterized as a fan bearing envelope (FBE), as set forth in expression (3):

$$FBE = ( \frac{{R}_{FBRG}}{{R}_{FHTE}} ) \times ( \frac{{D}_{FB}}{( \frac{{Thrust}_{TO}}{1000} )} ) . \qquad ( 3 )$$

In expression (3), R_{FBRG} is the fan bearing radius, R_{FHTE} is the fan hub trailing edge radius, D_{FB} is the rolling element diameter, and Thrust_{TO} is the takeoff thrust of the turbofan engine. The takeoff thrust Thrust_{TO} is a high power operation (e.g., greater than 85% of the SLS maximum engine rated thrust) of the turbofan engine during a takeoff condition of the aircraft.

As discussed further below, the fan bearings include fan bearing designs for different turbofan engine architectures that accounts for handling the stresses from the fan shaft during operation, while reducing the fan hub radius, and, thus, providing for an improved specific flow through the fan and reducing the fan diameter required to achieve a certain thrust or reduces the fan pressure ratio and improves propulsive efficiency of the fan. These improved fan bearing designs can be characterized according to a defined range for the FBE.

Table 2 below represents exemplary embodiments 16 to 27 and their corresponding FBE values for various turbofan engines and fan bearings. Embodiments 16 to 27 may represent the turbofan engine 110 of FIG. 1 (e.g., ducted engine) or the turbofan engine 210 of FIG. 2 (e.g., unducted fan engine) and can be applied to any of the fan bearings detailed herein. In Table 2, the FBE values were determined based on expression (3) described above, and using fan hub trailing edge radius, fan bearing radius, fan bearing diameter values in millimeters and takeoff thrust values in kilo-Newtons. In particular, embodiments 16, 17, 22, 24, and 26 are tapered roller bearings (e.g., the fan bearings 1600 of FIG. 16). Embodiments 18 to 21, 23, 25, and 27 are ball bearings (e.g., the fan bearings 1700 of FIG. 17 or the fan bearing 1800 of FIG. 18).

TABLE 2

| | | | | | | Fan Bearing |
|---|---|---|---|---|---|---|
| | R_{FHTE} | R_{FBRG} | R_{FBRG}/ | D_{FB} | Thrust_{TO} | Envelope |
| Emb. | (mm) | (mm) | R_{FHTE} | (mm) | (kN) | (FBE) |
| 16 | 360.934 | 212.09 | 0.588 | 19.05 | 155.688 | 71.901 |
| 17 | 628.396 | 312.42 | 0.497 | 19.05 | 155.688 | 60.834 |
| 18 | 360.934 | 212.09 | 0.588 | 50.80 | 155.688 | 191.735 |
| 19 | 628.396 | 312.42 | 0.497 | 50.80 | 155.688 | 162.224 |
| 20 | 360.934 | 212.09 | 0.588 | 57.15 | 155.688 | 215.702 |
| 21 | 360.934 | 212.09 | 0.588 | 63.50 | 155.688 | 239.669 |
| 22 | 103.124 | 60.60 | 0.588 | 5.00 | 44.482 | 66.050 |
| 23 | 103.124 | 60.60 | 0.588 | 15.00 | 44.482 | 198.151 |
| 24 | 902.335 | 530.23 | 0.588 | 50.80 | 389.220 | 76.694 |
| 25 | 902.335 | 530.23 | 0.588 | 127.00 | 389.220 | 191.735 |
| 26 | 1191.082 | 699.90 | 0.588 | 63.50 | 513.770 | 72.627 |
| 27 | 1191.082 | 699.90 | 0.588 | 170.00 | 513.770 | 194.434 |

The fan bearing designs provide the aforementioned benefits including achieving a lower radius ratio (ratio of hub to fan tip radii) for a rated thrust, or a percentage thereof at takeoff. During the course of creating those designs it was determined what ranges would be suitable to achieve the desired results, while taking into account fan shaft stresses, packaging and accessibility, reliability and lubrication requirements for the engine. The values for terms used to compute an FBE value are strictly limited to certain ranges based on the various designs evaluated where those values had varied. Otherwise, the engine made will not produce the favorable results.

The FBE is only valid for a fan hub trailing edge radius R_{FHTE} in a range from ninety millimeters (90 mm) to one thousand two hundred millimeters (1,200 mm). In some embodiments, the fan hub trailing edge radius R_{FHTE} is in a range from one hundred millimeters (100 mm) to nine hundred millimeters (900 mm). The ranges of the fan hub trailing edge radius R_{FHTE} provide for a fan hub radius ratio that satisfies the operational requirements and the packaging requirements of a particular engine without overly increasing the fan bearing heat load. Values of the fan hub trailing edge radius R_{FHTE} outside of the ranges disclosed herein either have a fan hub radius ratio that is too small such that the fan bearings cannot be packaged under the fan disk or too great such that the aerodynamic efficiency of the fan is reduced.

The FBE is only valid for a fan bearing radius R_{FBRG} in a range from fifty millimeters (50 mm) to seven hundred millimeters (700 mm). In some embodiments, the fan bearing radius R_{FBRG} is in a range from sixty millimeters (60 mm) to five hundred fifty millimeters (550 mm). The ranges of the fan bearing radius R_{FBRG} provide for a lower fan hub radius ratio that satisfies the operational requirements and the packaging requirements of a particular engine without overly increasing the fan bearing heat load. Values of the fan bearing radius R_{FBRG} outside of the ranges disclosed herein either have a fan hub radius ratio that is too small such that the fan bearings cannot be packaged under the fan disk or too great such that the aerodynamic efficiency of the fan is reduced and the heat load on the fan bearings is increased so much that the fan bearings require a great amount of lubricant to cool the fan bearings. Thus, fan bearings having a fan bearing radius R_{FBRG} greater than seven hundred millimeters (700 mm) also result in a greater sized lubrication system, and, thus, results in a heavier turbofan engine.

The FBE is only valid for a radius ratio of the fan bearing radius to the fan hub trailing edge radius (R_{FBRG}/R_{FHTE}) in a range from 0.4 to 1.0. The range of R_{FBRG}/R_{FHTE} provides satisfies the operational requirements and the packaging requirements of a particular engine without overly increasing the fan bearing heat load. Values of the R_{FBRG}/R_{FHTE} outside of the ranges disclosed herein either have a fan hub radius ratio that is too small such that the fan bearings cannot be packaged under the fan disk or too great such that the aerodynamic efficiency of the fan is reduced. In particular, values of R_{FBRG}/R_{FHTE} greater than 1.0 provide for the fan bearings to be radially outward of the fan hub trailing edge, and, thus, reduce the radius of the core engine inlet. Values of R_{FBRG}/R_{FHTE} less than 0.4 provide for fan bearings that require larger rolling elements to account for the stresses, while also increasing the fan hub radius and the inner radius of the flow path.

The FBE is only valid for a rolling element diameter D_{FB} in a range from three millimeters (3 mm) to one hundred fifty millimeters (150 mm). In some embodiments, the rolling element diameter D_{FB} is in a range from five millimeters (5 mm) to one hundred twenty-seven millimeters (127 mm).

The FBE is only valid for a takeoff thrust Thrust_{TO} in a range from forty kilo-Newtons (40 kN) to five hundred twenty-five kilo-Newtons (525 kN). In some embodiments, the takeoff thrust Thrust_{TO} is in a range from forty-four kilo-Newtons (44 kN) to four hundred fifty kilo-Newtons (450 kN).

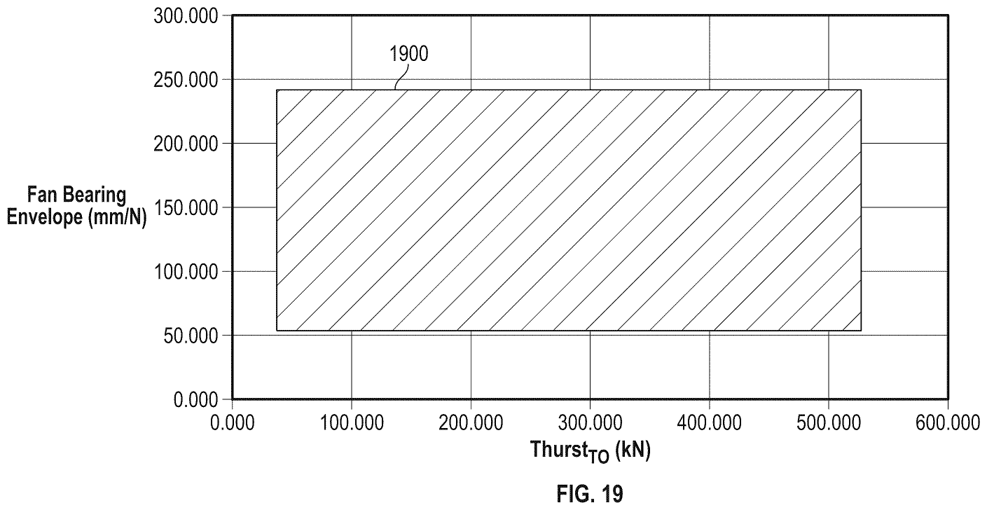

FIG. 19 represents, in graph form, the FBE as a function of the Thrust_{TO} of the turbofan engine, according to the present disclosure. An area 1900 represents the boundaries of the FBE. The FBE is in a range from fifty-four millimeters per Newton (54 mm/N) to two hundred forty millimeters per Newton (240 mm/N) for a takeoff thrust Thrust_{TO} in a range from forty kilo-Newtons (40 kN) to five hundred twenty-five kilo-Newtons (525 kN). The range of the FBE identifies the specific architectures (fan bearing sizing and location), rolling elements sizing, and takeoff thrusts, while accounting for the stresses from the fan shaft and the inner flow path radius and the fan hub radius. In particular, if the FBE is within the area 1900, then the fan bearing and the turbofan engine architecture are capable of handling the stresses from the fan shaft during operation, while reducing the fan hub radius, and, thus, providing for an improved specific flow through the fan and reducing the fan diameter required to achieve a certain thrust, or reduces the fan pressure ratio and improves propulsive efficiency of the fan. If the FBE is outside of the area 1900, then the fan bearings may become damaged or fail under the stresses from the fan shaft, or the fan hub radius (e.g., the inner radius of the flow path) is too great, such that the fan efficiency decreases or the specific flow through the fan is reduced for a certain thrust. Thus, the turbofan engine having an FBE within the area 1900 provides for an improved fan bearing architecture that is capable of handling the stresses from the fan shaft, while accounting for the fan hub radius to improve propulsive efficiency and specific flow for achieving a certain thrust.

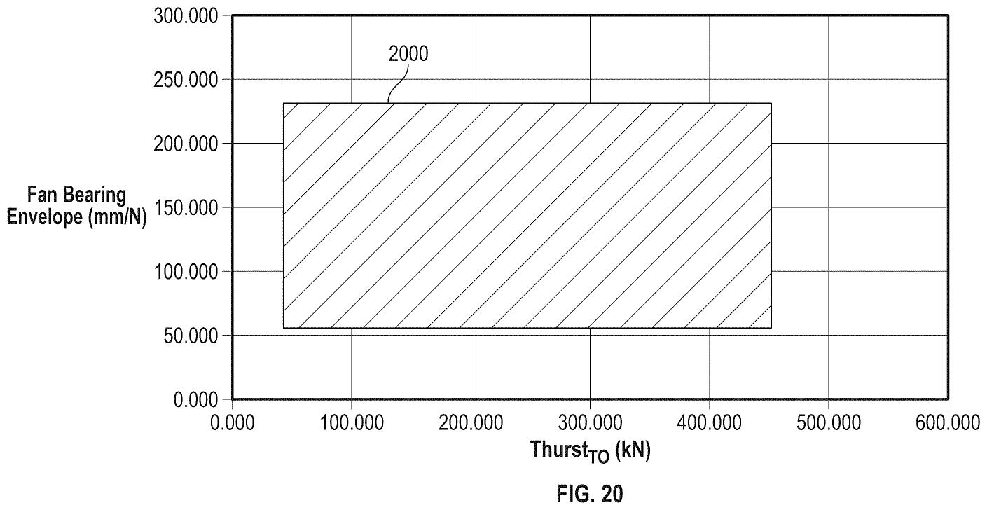

FIG. 20 represents, in graph form, the FBE as a function of the Thrust_{TO}, according to another aspect. An area 2000 represents the boundaries of the FBE. The FBE is in a range from fifty-eight millimeters per Newton (58 mm/N) to two hundred thirty millimeters per Newton (230 mm/N) for a takeoff thrust Thrust_{TO} in a range from forty-four kilo-Newtons (44 kN) to four hundred fifty kilo-Newtons (450 kN). The range of the FBE identifies the specific architectures (fan bearing sizing and location), rolling elements sizing, and takeoff thrusts, while accounting for the stresses from the fan shaft and the inner flow path radius and the fan hub radius. In particular, if the FBE is within the area 2000, then the fan bearing and the turbofan engine architecture are capable of handling the stresses from the fan shaft during operation, while reducing the fan hub radius, and, thus, providing for an improved specific flow through the fan and reducing the fan diameter required to achieve a certain thrust, or reduces the fan pressure ratio and improves propulsive efficiency of the fan. If the FBE is outside of the area 2000, then the fan bearings may become damaged or fail under the stresses from the fan shaft, or the fan hub radius (e.g., the inner radius of the flow path) is too great, such that the fan efficiency decreases or the specific flow through the fan is reduced for a certain thrust. Thus, the turbofan engine having an FBE within the area 2000 provides for an improved fan bearing architecture that is capable of handling the stresses from the fan shaft, while accounting for the fan hub radius to improve propulsive efficiency and specific flow for achieving a certain thrust.

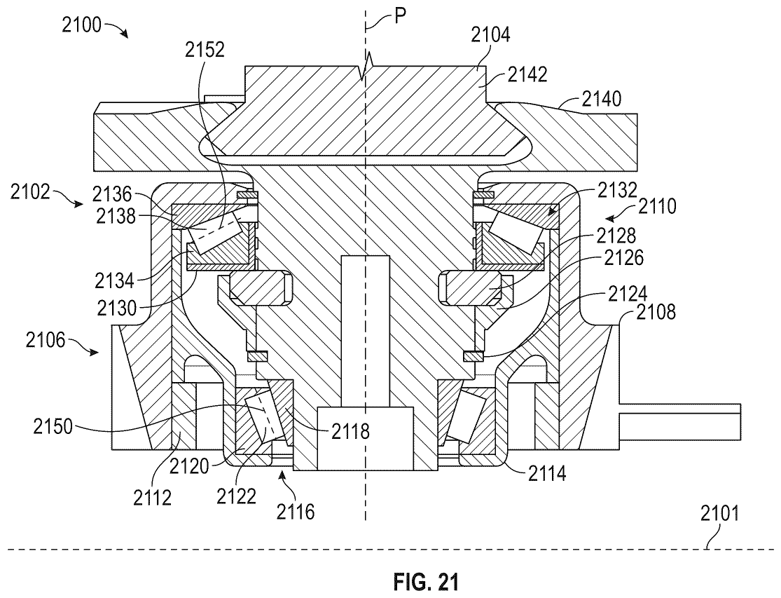

FIG. 21 is an enlarged schematic, cross-sectional view of a segment of a fan 2100 having a fan actuation system 2102, taken along a longitudinal centerline axis 2101 of the fan 2100, according to the present disclosure. The fan 2100 can be utilized as the fan 138 of FIG. 1 or as the fan 252 of FIG. 2. The fan 2100 includes a plurality of fan blades 2104 that is coupled to a disk 2106 and is spaced circumferentially about the longitudinal centerline axis 2101 of the fan 2100.

The disk 2106 includes a plurality of disk segments 2108 (only one shown in FIG. 21) that is rigidly coupled together or integrally molded together in a generally annular shape. One fan blade 2104 is coupled to each disk segment 2108 at a trunnion mechanism 2110 of the fan actuation system 2102. The trunnion mechanism 2110 facilitates retaining the respective fan blade 2104 on the disk 2106 during rotation of the disk 2106, while still rendering the respective fan blade 2104 rotatable relative to the disk 2106 about a pitch axis P of the fan blade 104. The trunnion mechanism 2110 includes a plurality of bearings disposed within the disk segment 2108 that allows the fan blade 2104 to rotate about the pitch axis P, as detailed above and below.

The trunnion mechanism 2110 extends through a respective disk segment 2108 and includes a coupling nut 2112, a lower bearing support 2114, a first radial thrust bearing 2116 (having, for example, an inner race 2118, an outer race 2120, and a plurality of rolling elements 2122), a snap ring 2124, a key hoop retainer 2126, a segmented key 2128, a bearing support 2130, a second radial thrust bearing 2132 (having, for example, an inner race 2134, an outer race 2136, and a plurality of rolling elements 2138), a trunnion 2140, and a base 2142 (e.g., a dovetail). The first radial thrust bearing 2116 and the second radial thrust bearing 2132 can include any type of roller bearings, including, for example, cylindrical roller radial thrust bearings, tapered roller radial thrust bearings, spherical roller radial thrust bearings (e.g., ball bearings), needle roller radial thrust bearings, or tapered roller needle radial thrust bearings. The coupling nut 2112 is threadedly engaged with the disk segment 2108 so as to sandwich the remaining components of the trunnion mechanism 2110 between the coupling nut 2112 and the disk segment 2108, thus, retaining the trunnion mechanism 2110 attached to the disk segment 2108.

The first radial thrust bearing 2116 is oriented at a different angle than the second radial thrust bearing 2132 (as measured from a rolling element longitudinal centerline axis 2150 of the plurality of rolling elements 2122 relative to the pitch axis P, and from a rolling element longitudinal centerline axis 2152 of the plurality of rolling elements 2138 relative to the pitch axis P). More specifically, the first radial thrust bearing 2116 and the second radial thrust bearing 2132 are preloaded against one another in a face-to-face (or duplex) arrangement, in which the rolling element longitudinal centerline axes 2150, 2152 are oriented substantially perpendicular to one another, as opposed to being arranged in tandem so as to be oriented substantially parallel to one another.

The centrifugal loads experienced closer to the pitch axis P are larger than the centrifugal loads experienced further away from the pitch axis P. As such, to facilitate making the trunnion mechanism 2110 more compact, the bearings of the trunnion mechanism 2110 are positioned closer to the pitch axis P. Such a configuration enables a greater number of trunnion mechanisms 2110 to be assembled on the disk 2106 and, thus, more fan blades 2104 to be coupled to the disk 2106 for a given diameter of the disk 2106. The trunnion mechanism 2110 herein is made more compact due to the first radial thrust bearing 2116 and the second radial thrust bearing 2132 being line contact bearings as compared to trunnion mechanisms that utilize angular point contact ball bearings. In this way, the trunnion mechanism 2110 is made more compact while being better able to withstand larger centrifugal loads associated with such a bearing placement without fracturing or plastically deforming. In particular, the first radial thrust bearing 2116 and the second radial thrust bearing 2132 being line contact bearings provide for larger contact surfaces, and, thus, can withstand larger centrifugal loads as compared to angular point contact ball bearings. Thus, line contact bearings (e.g., the first radial thrust bearing 2116 and the second radial thrust bearing 2132) can be spaced closer to the pitch axis P than angular point contact ball bearings.

In one aspect, the first radial thrust bearing 2116 and the second radial thrust bearing 2132 are a tapered roller bearings in which the rolling elements 2122 and the rolling elements 2138 are tapered. In one example, the first radial thrust bearing 2116 is fabricated from a steel material and has twenty rolling elements 2122 arranged at a 20° contact angle and a 3.6 inch pitch diameter, with each rolling element 2122 being 0.6 inches long and having a 0.525 inch minor diameter, a 0.585 inch major diameter, and a 6° taper angle. In the same example, the second radial thrust bearing 2132 is fabricated from a steel material and has 36 rolling elements 2138 arranged at a 650 contact angle and a 6 inch pitch diameter, with each rolling element 2138 being 0.8 inches long and having a 0.45 inch minor diameter, a 0.6 inch major diameter, and a 9° taper angle. In other aspects, the first radial thrust bearing 2116 and the second radial thrust bearing 2132 can be configured in any suitable manner that facilitates enabling the first radial thrust bearing 2116 and the second radial thrust bearing 2132 to function as described herein.

The first radial thrust bearing 2116 and the second radial thrust bearing 2132 facilitate providing a turbofan engine with a smaller variable pitch fan that can generate larger amounts of thrust. Particularly, the first radial thrust bearing 2116 and the second radial thrust bearing 2132 facilitate providing a turbofan engine with a variable pitch fan having a higher blade count and a lower blade length, while also providing the turbofan engine with a lower fan hub radius ratio. The first radial thrust bearing 2116 and the second radial thrust bearing 2132 further facilitate providing a trunnion mechanism that is more compact and is better able to withstand the higher centrifugal loads associated with higher blade counts, given that higher blade counts tend to yield a higher tip velocity and, therefore, a higher centrifugal loading. The first radial thrust bearing 2116 and the second radial thrust bearing 2132 further facilitate providing a smaller diameter disk for a variable pitch fan by providing the variable pitch fan with a fan counterweight device for the fan blades.

In various exemplary aspects of the present disclosure, a turbofan engine is provided with a rotating airfoil assembly (e.g., a fan) that includes a spring and damper system coupled to individual airfoils of the rotating airfoil assembly. This system connects to an airfoil root of an individual airfoils and enables the airfoil to rotate about its longitudinal axis to change pitch passively in response to aerodynamic loads applied to the airfoil. Specifically, dampers (e.g., hydraulic dampers) and a spring can be arranged to counterbalance rotational forces, allowing the airfoil pitch to adjust dynamically as the airfoil rotates through varying airflow angles, such as when the aircraft operates at an angle of attack. This passive adjustment helps mitigate asymmetric or cyclic (1P) loading on the airfoils and supporting structure.

The inventors of the present disclosure have found that integrating a passive spring and damper system into the airfoil structure of the turbofan engines defined by the relationships described hereinabove provides complementary structural and operational benefits. The fan actuation systems described herein are designed to fit within specific, compact spatial envelopes (e.g., the fan actuation system length envelope) while managing the high collective pitch loads associated with high-speed turbofan architectures. By incorporating the spring and damper system at the airfoil roots of the airfoils, the fan assembly can passively mitigate cyclic (1P) aerodynamic loads caused by inlet airflow distortion or aircraft angle of attack, reducing the vibratory and fatigue loads transmitted to the main fan actuation system.

Consequently, the reduced fatigue loading on the trunnion and actuation components can allow the fan actuation system to be sized primarily for collective pitch requirements (e.g., feathering, reversing, and cruise optimization) rather than for withstanding excessive cyclic stresses. This load alleviation can assists in maintaining the compact form factor required to satisfy the fan actuation system length envelope described hereinabove. Without such load mitigation, the structural components might require reinforcement or upsizing that could push the system outside the desirable packaging envelopes, potentially compromising the low hub-to-tip radius ratio and aerodynamic efficiency.

Similarly, the present disclosure includes misalignment correction systems, such as a pivotable engine support structure, a tilting fan shaft, and an active cyclic pitch mechanism, which provide a similar benefit regarding the fan actuation system envelope. In particular, by actively aligning the fan rotation plane more perpendicularly to an incoming airflow or actively managing cyclic pitch, these systems can reduce a 1P aerodynamic loading at the source. Consequently, asymmetric loads on the primary fan actuation system (responsible for collective pitch) can be reduced. This load reduction enables the structural components of the fan actuation system to be designed more for compactness, thereby facilitating achievement of a desirable fan actuation system length envelope and lower fan hub radius ratios, even in higher blade count architectures.

Furthermore, these combinations allow for a high blade count architecture to operate effectively under a wider range of flight conditions. The fan actuation system length envelope disclosed hereinabove facilitate packaging of numerous blades in a relatively small hub space, while the spring and damper system improves the likelihood that these blades can individually adapt to asymmetric loading without requiring, e.g., complex and bulky active cyclic pitch control mechanisms. This synergy enables a turbofan engine that achieves both the aerodynamic performance of a high-solidity fan and the mechanical robustness required for varied flight attitudes, all within a reduced hub volume.

With reference to the disclosure hereinbelow, as previously noted, thrust used to move an aircraft through the air may be produced by a plurality of airfoils rotating about a central axis, such as, for example, the fan blades of a fan for a turbofan engine, with some of the blades traveling in a downward direction and others traveling in an upward direction. When the aircraft is flying level, air flows into the fan in an axial direction of the fan, and the downward traveling blades and the upward traveling blades produce an equal amount of thrust. But, when the aircraft has an angle of attack, the air flows into the fan with a non-axial component and the downward traveling blades produce a different amount of thrust than the upward traveling blades. For example, when the aircraft is pitched upward, such as during takeoff, the downward traveling blades produce a greater amount of thrust than the upward traveling blades, resulting in asymmetric loading of the fan blades. Thus, in one rotation, the rotating airfoil (fan blade) is subjected to differential loads (a 1P load) resulting in a cyclic loading condition for the rotating airfoil. Among other things, these cyclic loads can subject the rotating airfoil to fatigue stresses and strains.

A rotating airfoil, such as the fan blades of a fan for a turbofan engine, may be subjected to differential loading during rotation (1P loading) when the rotation axis, about which the rotating airfoil rotates, is angled (such as pitched upward or pitched downward) relative to the flow of air into the fan. Put another way, this 1P loading may occur when the airflow into a fan is not perpendicular to the plane in which the rotating airfoil rotates. The embodiments discussed herein reduce the magnitude of the asymmetric load produced by the rotating airfoils or even eliminate the asymmetric load. In some embodiments discussed herein, the rotation axis of rotating airfoil assembly is aligned with the airflow into the rotating airfoil assembly or at least the angle of attack is reduced when the aircraft has an angle of attack. In some embodiments discussed herein, the entire engine is rotated when the aircraft has an angle of attack to align the engine and, thus, the rotating airfoil assembly is aligned with the airflow into the rotating airfoil assembly, but, in other embodiments, the rotating airfoil assembly is rotated with other portions of the engine remaining fixed relative to their orientation to the aircraft. In still other embodiments, the rotating airfoils themselves may change their orientation as they rotate about the rotation axis, thereby changing the plane of rotation of the rotating airfoil. In some embodiments discussed herein, the rotating airfoils are actively rotated by a controller and actuators. In a further embodiment, the angle of the rotating airfoil (blade) may be changed to reduce the asymmetric loading on the rotating airfoil assembly, and, in the embodiment discussed below, this rotation is passive driven by the differential pressure on the rotating airfoil.

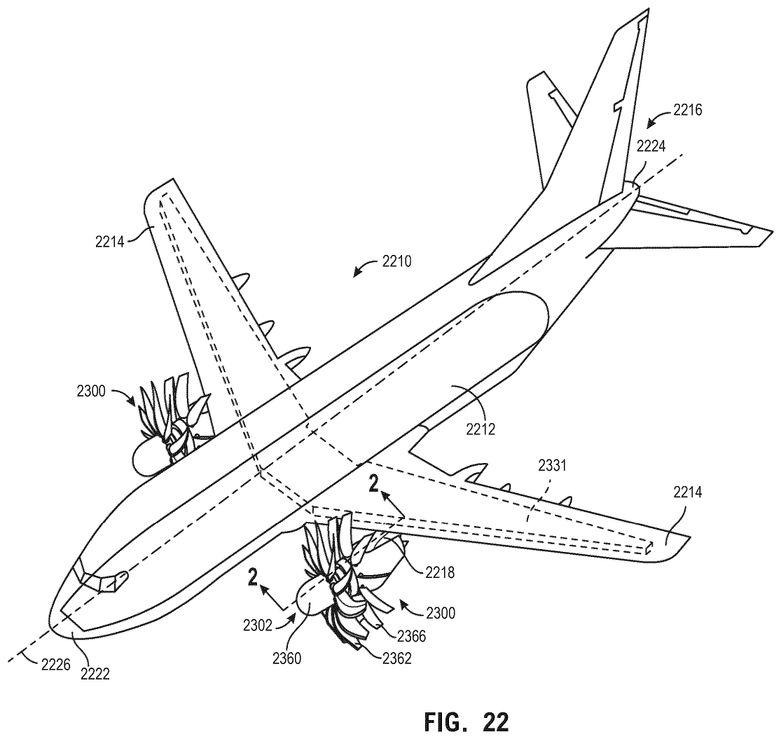

The rotating airfoils discussed herein are suitable for use with rotating airfoil assemblies used to produce thrust for fixed wing aircraft, and, in particular, for open rotor engines such as unducted fan engines. FIG. 22 is a perspective view of an aircraft 2210 that may implement various preferred embodiments. The aircraft 2210 includes a fuselage 2212, a pair of wings 2214 attached to the fuselage 2212, and an empennage 2216. The fuselage 2212 includes a nose 2222 and a tail 2224 with a centerline 2226 extending from the nose 2222 to the tail 2224. The centerline 2226 of the fuselage 2212 is also the centerline 2226 of the aircraft 2210 in this embodiment. The aircraft 2210 also includes a propulsion system that produces a propulsive thrust required to propel the aircraft 2210 in flight, during taxiing operations, and the like. The propulsion system for the aircraft 2210 shown in FIG. 22 includes a pair of engines 2300. In this embodiment, each engine 2300 is attached to one of the wings 2214 by a pylon 2218 in an under-wing configuration. Although the engines 2300 are shown attached to the wing 2214 in an under-wing configuration in FIG. 22, in other embodiments, the engine 2300 may have alternative configurations and be coupled to other portions of the aircraft 2210. For example, the engine 2300 may additionally or alternatively include one or more aspects coupled to other parts of the aircraft 2210, such as, for example, the empennage 2216, and the fuselage 2212.

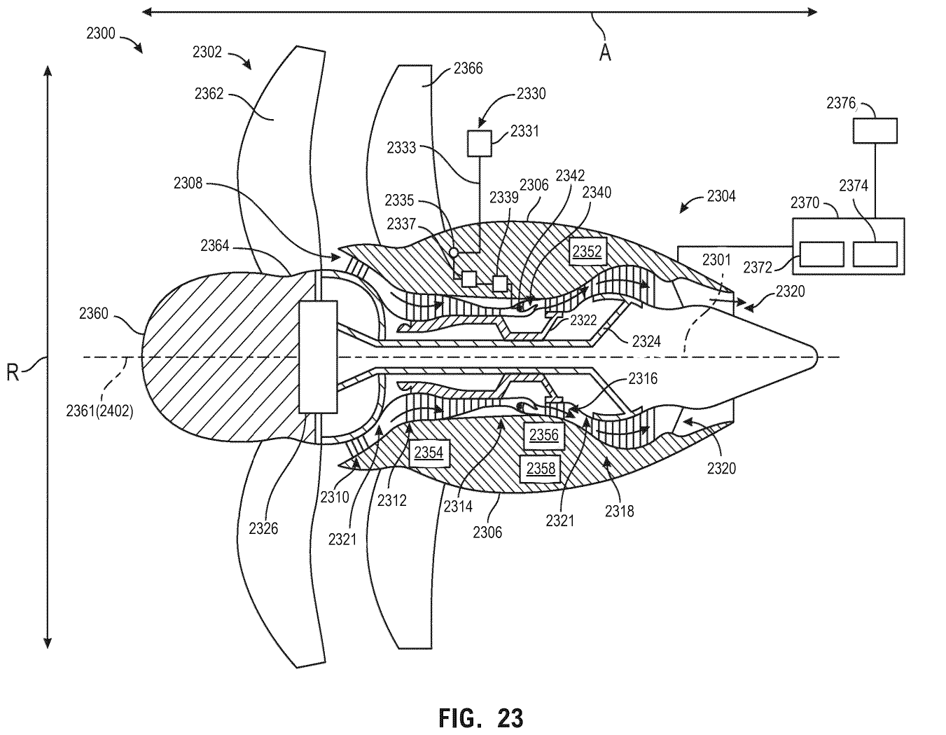

As will be described further below with reference to FIG. 23, the engines 2300 shown in FIG. 22 are turbofan engines that are each capable of selectively generating a propulsive thrust for the aircraft 2210. The amount of propulsive thrust may be controlled at least in part based on a volume of fuel provided to the turbofan engines via a fuel system 2330 (see FIG. 23). An aviation turbine fuel in the embodiments discussed herein is a combustible hydrocarbon liquid fuel, such as a kerosene-type fuel, having a desired carbon number. The fuel is stored in a fuel tank 2331 of the fuel system 2330. As shown in FIG. 22, at least a portion of the fuel tank 2331 is located in each wing 2214 and a portion of the fuel tank 2331 is located in the fuselage 2212 between the wings 2214. The fuel tank 2331, however, may be located at other suitable locations in the fuselage 2212 or the wing 2214. The fuel tank 2331 may also be located entirely within the fuselage 2212 or the wing 2214. The fuel tank 2331 may also be separate tanks instead of a single, unitary body, such as, for example, two tanks each located within a corresponding wing 2214.

FIG. 23 is a schematic, cross-sectional view of one of the engines 2300 used in the propulsion system for the aircraft 2210 shown in FIG. 22. The cross-sectional view of FIG. 23 is taken along line 23-23 in FIG. 22. As noted above, the engine 2300 is a turbofan engine. The turbofan engine 2300 has an axial direction A (extending parallel to a longitudinal centerline 2301, shown for reference in FIG. 23), a radial direction R, and a circumferential direction. The circumferential direction (not depicted in FIG. 23) extends in a direction rotating about the longitudinal centerline 2301. The turbofan engine 2300 includes a fan section 2302 and a turbomachine 2304 disposed downstream from the fan section 2302.

The turbomachine 2304 depicted in FIG. 23 includes a tubular outer casing 2306 (also referred to as a housing or a nacelle) that defines an inlet 2308. In this embodiment, the inlet 2308 is annular. The outer casing 2306 encases an engine core that includes, in a serial flow relationship, a compressor section including a booster or a low-pressure (LP) compressor 2310 and a high-pressure (HP) compressor 2312, a combustion section 2314, a turbine section including a high-pressure (HP) turbine 2316 and a low-pressure (LP) turbine 2318, and a jet exhaust nozzle section 2320. The compressor section, the combustion section 2314, and the turbine section together define at least in part a core air flowpath 2321 extending from the inlet 2308 to the jet exhaust nozzle section 2320. The turbomachine 2304 further includes one or more drive shafts. More specifically, the turbomachine 2304 includes a high-pressure (HP) shaft or spool 2322 drivingly connecting the HP turbine 2316 to the HP compressor 2312, and a low-pressure (LP) shaft or spool 2324 drivingly connecting the LP turbine 2318 to the LP compressor 2310.

The turbofan engine 2300, more specifically, the turbomachine 2304, is operable with the fuel system 2330 and receives a flow of fuel from the fuel system 2330. The fuel system 2330 includes a fuel delivery assembly 2333 providing the fuel flow from the fuel tank 2331 to the turbofan engine 2300, and, more specifically, to a plurality of fuel nozzles 2342 that inject fuel into a combustion chamber of a combustor 2340 of the combustion section 2314. The fuel delivery assembly 2333 includes tubes, pipes, conduits, and the like, to fluidly connect the various components of the fuel system 2330 to the turbofan engine 2300. The fuel tank 2331 is configured to store the hydrocarbon fuel, and the hydrocarbon fuel is supplied from the fuel tank 2331 to the fuel delivery assembly 2333. The fuel delivery assembly 2333 is configured to carry the hydrocarbon fuel between the fuel tank 2331 and the turbofan engine 2300 and, thus, provides a flow path (fluid pathway) of the hydrocarbon fuel from the fuel tank 2331 to the turbofan engine 2300.

The fuel system 2330 includes at least one fuel pump fluidly connected to the fuel delivery assembly 2333 to induce the flow of the fuel through the fuel delivery assembly 2333 to the turbofan engine 2300. One such pump is a main fuel pump 2335. The main fuel pump 2335 is a high-pressure pump that is the primary source of pressure rise in the fuel delivery assembly 2333 between the fuel tank 2331 and the turbofan engine 2300. The main fuel pump 2335 may be configured to increase a pressure in the fuel delivery assembly 2333 to a pressure greater than a pressure within the combustion chamber of the combustor 2340.

The fuel system 2330 also includes a fuel metering unit 2337 in fluid communication with the fuel delivery assembly 2333. Any fuel metering unit 2337 may be used including, for example, a metering valve. The fuel metering unit 2337 is positioned downstream of the main fuel pump 2335 and upstream of a fuel manifold 2339 configured to distribute fuel to the fuel nozzles 2342. The fuel system 2330 is configured to provide the fuel to fuel metering unit 2337, and the fuel metering unit 2337 is configured to receive fuel from the fuel tank 2331. The fuel metering unit 2337 is further configured to provide a flow of fuel to the turbofan engine 2300 in a desired manner. More specifically, the fuel metering unit 2337 is configured to meter the fuel and to provide a desired volume of fuel, at, for example, a desired flow rate, to the fuel manifold 2339 of the turbofan engine 2300. The fuel manifold 2339 is fluidly connected to the fuel nozzles 2342 and distributes (provides) the fuel received to the plurality of fuel nozzles 2342, where the fuel is injected into the combustion chamber and combusted. Adjusting the fuel metering unit 2337 changes the volume of fuel provided to the combustion chamber and, thus, changes the amount of propulsive thrust produced by the turbofan engine 2300 to propel the aircraft 2210.

The turbofan engine 2300 also includes various accessory systems to aid in the operation of the turbofan engine 2300 and/or the aircraft 2210. For example, the turbofan engine 2300 may include a main lubrication system 2352, a compressor cooling air (CCA) system 2354, an active thermal clearance control (ATCC) system 2356, and a generator lubrication system 2358, each of which is depicted schematically in FIG. 23. The main lubrication system 2352 is configured to provide a lubricant to, for example, various bearings and gear meshes in the compressor section, the turbine section, the HP spool 2322, and the LP shaft 2324. The lubricant provided by the main lubrication system 2352 may increase the useful life of such components and may remove a certain amount of heat from such components through the use of one or more heat exchangers. The compressor cooling air (CCA) system 2354 provides air from one or both of the HP compressor 2312 or the LP compressor 2310 to one or both of the HP turbine 2316 or the LP turbine 2318. The active thermal clearance control (ATCC) system 2356 acts to minimize a clearance between tips of turbine blades and casing walls as casing temperatures vary during a flight mission. The generator lubrication system 2358 provides lubrication to an electronic generator (not shown), as well as cooling/heat removal for the electronic generator. The electronic generator may provide electrical power to, for example, a startup electrical motor for the turbofan engine 2300 and/or various other electronic components of the turbofan engine 2300 and/or an aircraft 2210. The lubrication systems for the turbofan engine 2300 (e.g., the main lubrication system 2352 and the generator lubrication system 2358) may use hydrocarbon fluids, such as oil, for lubrication, in which the oil circulates through inner surfaces of oil scavenge lines.

The fan section 2302 of the turbofan engine 2300 includes a plurality of fan blades 2362 coupled to a fan hub 2364 (or disk). The fan blades 2362 and the fan hub 2364 are rotatable, together, circumferentially about a rotation axis 2361, which, in this embodiment, is coincident with the longitudinal centerline (axis) 2301. In this embodiment, a spinner 2360 is connected to the fan hub 2364, and the spinner 2360 rotates with respect to the outer casing 2306. Each of the fan blades 2362 is an airfoil and, more specifically, a rotating airfoil. The fan blades 2362, together with the fan hub 2364, in this embodiment, comprise a rotating airfoil assembly.

The turbomachine 2304 of this embodiment is a torque producing system that generates torque to rotate the fan blades 2362. The turbomachine 2304 is configured to operate (e.g., to rotate) the fan hub 2364. The fan hub 2364 may be coupled to a shaft, and, more specifically, the LP shaft 2324, of the turbomachine 2304, and the LP shaft 2324 rotates the fan blades 2362 and the fan hub 2364. In some embodiments, the LP shaft 2324 may be coupled to the fan hub 2364 in a direct drive configuration, but, in this embodiment, the LP shaft 2324 is coupled to a reduction gearbox 2326 that, in turn, transmits a rotational (torsional) force to rotate the fan hub 2364. The reduction gearbox 2326 may be configured to reduce input rotational speed from the LP shaft 2324 to a speed suitable for rotating the fan blades 2362.

Coupled to the outer casing 2306 may be one or more outlet guide vanes 2366. In this embodiment, the outlet guide vanes 2366 are positioned aft of the fan blades 2362. In this embodiment, the outer casing 2306 is stationary such that the one or more outlet guide vanes 2366 do not rotate around the longitudinal centerline 2301 and are, thus, stationary with respect to rotation about the longitudinal centerline 2301. Although the outlet guide vanes 2366 are stationary with respect to the longitudinal centerline 2301, the outlet guide vanes 2366 are capable of being rotated or moved with respect to the outer casing 2306.

During operation of the turbofan engine 2300, air flows from the left side of FIG. 23 toward the right side of FIG. 23. A portion of the air flow may flow past the fan blades 2362 and the outlet guide vanes 2366. A portion of the air flow may enter the outer casing 2306 through the annular inlet 2308 as the air flowing through core air flowpath 2321 to be mixed with the fuel for combustion in the combustor 2340 and exit through the jet exhaust nozzle section 2320. As noted above, the outlet guide vanes 2366 may be movable with respect to the outer casing 2306 to guide the air flow in a particular direction. Each outlet guide vane 2366 may be movable to adjust the lean, pitch, sweep, or any combination thereof, of the outlet guide vane 2366.

In the embodiment shown in FIGS. 22 and 23, a forward end or a front portion of the outer casing 2306 includes the one or more fan blades 2362 and the one or more outlet guide vanes 2366. In other embodiments, the one or more fan blades 2362 and the one or more outlet guide vanes 2366 may have a different arrangement with respect to the outer casing 2306. For example, the one or more fan blades 2362 and the one or more outlet guide vanes 2366 may be located on an aft end or a rear portion of the outer casing 2306, such as coupled to a rear portion of the outer casing 2306. More specifically, the one or more fan blades 2362 and the one or more outlet guide vanes 2366 may be coupled to a rear portion of the outer casing 2306.

In other embodiments, an engine according to this disclosure may be configured to have stationary vanes positioned forward of the rotating fan blades 2362 (thus, the vanes 2366 are inlet guide vanes). Although the outlet guide vanes 2366 may be stationary and not rotate about the longitudinal centerline 2301, as described above, the one or more outlet guide vanes 2366 may rotate counter to the one or more fan blades 2362 such that the one or more outlet guide vanes 2366 are contra-rotating rotors in a contra-rotating open rotor (CROR) engine. Either pusher configurations, where the rotors are forward of the pylon 2218, or puller configurations, where the rotors are aft of the pylon 2218 are contemplated. In such a case, the contra-rotating rotors may also be rotating airfoils that are part of a rotating airfoil assembly, as discussed further below.

The engine 2300 also includes an engine controller 2370 configured to operate various systems of the engine 2300, including for example, the rotation of the engine 2300, the fan section 2302, and/or fan blades 2362, as discussed below. In this embodiment, the engine controller 2370 is a computing device having one or more processors 2372 and one or more memories 2374. The processor 2372 can be any suitable processing device, including, but not limited to, a microprocessor, a microcontroller, an integrated circuit, a logic device, a programmable logic controller (PLC), an application specific integrated circuit (ASIC), and/or a Field Programmable Gate Array (FPGA). The memory 2374 can include one or more computer-readable media, including, but not limited to, non-transitory computer-readable media, a computer readable non-volatile medium (e.g., a flash memory), a RAM, a ROM, hard drives, flash drives, and/or other memory devices.

The memory 2374 can store information accessible by the processor 2372, including computer-readable instructions that can be executed by the processor 2372. The instructions can be any set of instructions or a sequence of instructions that, when executed by the processor 2372, cause the processor 2372 and the engine controller 2370 to perform operations. In some embodiments, the instructions can be executed by the processor 2372 to cause the processor 2372 to complete any of the operations and functions for which the engine controller 2370 is configured, as will be described further below. The instructions can be software written in any suitable programming language or can be implemented in hardware. Additionally, and/or alternatively, the instructions can be executed in logically and/or virtually separate threads on the processor 2372. The memory 2374 can further store data that can be accessed by the processor 2372.

The engine controller 2370 may be directly communicatively coupled to a sensor 2376 to receive various inputs including, for example, sensors that monitor the operation of the engine 2300 and/or the aircraft 2210. The engine controller 2370 may also be indirectly coupled to such sensors and receive inputs from another source, such as a flight controller for the aircraft 2210. The engine controller 2370 may be communicatively coupled to other controllers, such as a flight controller, and exchange data, and commands with these other controllers. The engine controller 2370 may thus receive various inputs, data, and commands from these other controllers.

The technology discussed herein makes reference to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

The example of the rotating airfoil assembly shown in FIGS. 22 and 23 is the fan blades 2362, together with the fan hub 2364, but the embodiments discussed herein may be applicable to other rotating airfoil assemblies.

The torque producing system discussed above for the engine 2300 shown in FIGS. 22 to 23 is turbomachine 2304. Other suitable torque producing systems, however, may be used to rotate the rotating airfoils (e.g., fan blades 2362) and rotating airfoil assemblies (e.g., fan hub 2364 and fan blades 2362). Other suitable torque producing systems include other engines, such as reciprocating engines, for example. Although the aircraft 2210 shown in FIG. 22 is an airplane, the embodiments described herein may also be applicable to other aircraft 2210, including, for example, other fixed-wing unmanned aerial vehicles (UAV).

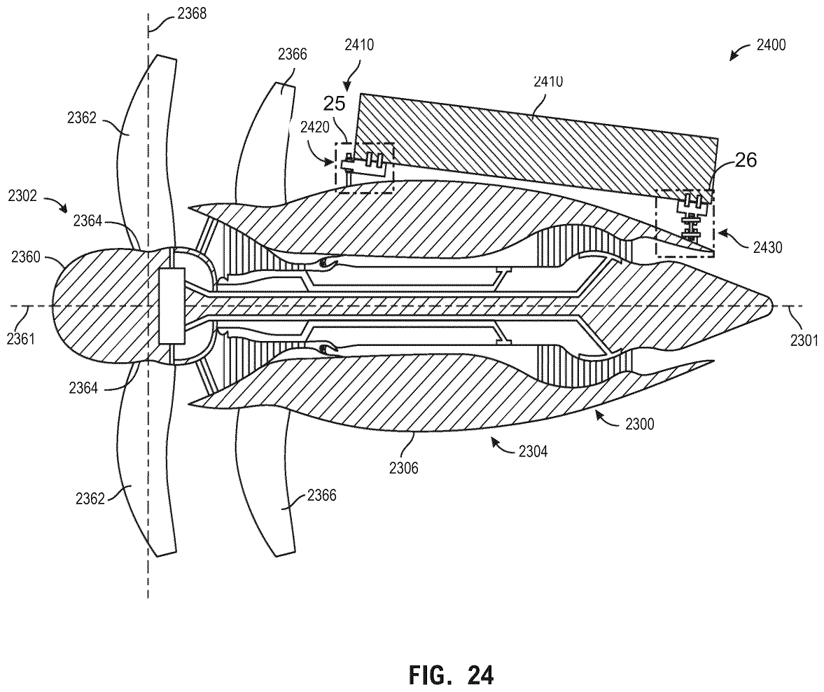

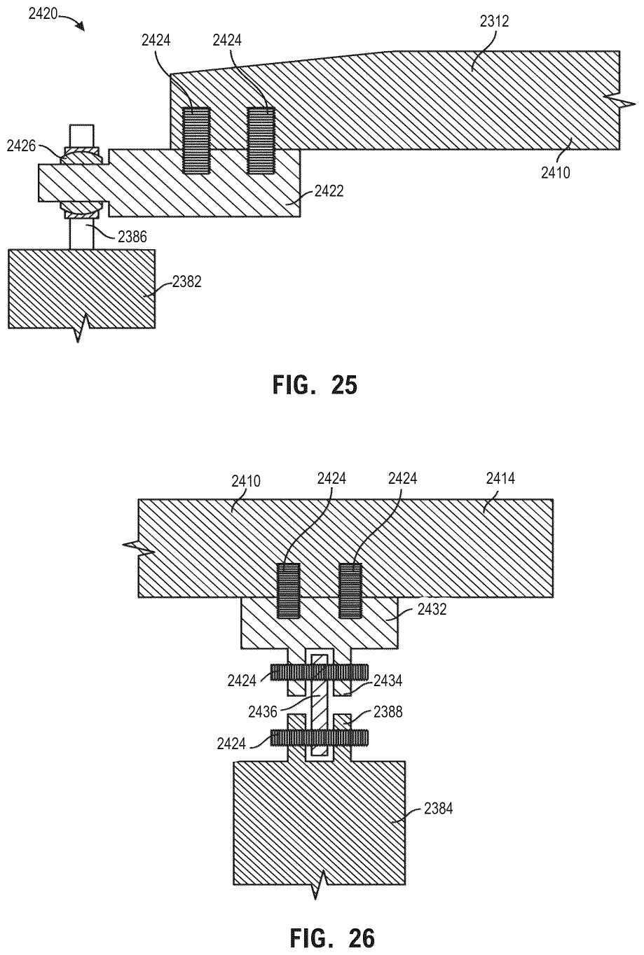

FIG. 24 shows an engine mounting system 2400 that may be used to mount the engine 2300 to the aircraft 2210. FIG. 24 is a cross-sectional view of the engine mounting system 2400. The engine mounting system 2400 includes an engine support structure 2410. The engine support structure 2410 may be the pylon 2218 that extends from the aircraft 2210, such as from the fuselage 2212, the wing 2214, or the empennage 2216 of the aircraft 2210 (see FIG. 22). In this embodiment, the engine 2300 is attached to one of the wings 2214 by the pylon 2218 (engine support structure 2410) in an under-wing configuration, and the engine support structure 2410 extends downwardly beneath the wing 2214. The engine mounting system 2400 includes a plurality of mounts coupling the engine 2300 to the engine support structure 2410. In this embodiment, the engine mounting system 2400 includes a forward mount 2420 and an aft mount 2430. The engine 2300 includes a plurality of frames including a forward frame 2382 (see FIG. 25) and an aft frame 2384 (see FIG. 26). The outer casing 2306 may connect to the forward frame 2382 and the aft frame 2384. In some embodiments, the forward frame 2382 may be disposed generally about the compressor section of the turbomachine 2304, and the aft frame 2384 may be disposed generally about the turbine sections of the turbomachine 2304. The outer casing 2306 may sometimes be referred to as the backbone of the engine 2300.

FIG. 25 is a cross-sectional detail view of the forward mount 2420 showing detail 25 in FIG. 24. Although any suitable mount may be used, the forward mount 2420 of this embodiment includes a forward mount beam 2422 attached to a forward section 2412 of the engine support structure 2410. The forward mount beam 2422 is attached to the engine support structure 2410 using any suitable means including, for example, fasteners. In this embodiment, a plurality of bolts 2424 are used to attach the forward mount beam 2422 to the engine support structure 2410. The forward mount beam 2422 includes a spherical mono-ball bearing 2426 attached to a forward end of the forward mount beam 2422. A mount lug 2386, which, in this embodiment, is integrally formed with the forward frame 2382, is connected to and engages with the mono-ball bearing 2426 to connect the forward frame 2382 and, thus the engine 2300 to the forward mount beam 2422.

FIG. 26 is a cross-sectional detail view of the aft mount 2430 showing detail 26 in FIG. 24. Although any suitable mount may be used, the aft mount 2430 of this embodiment includes a platform 2432 attached to an aft section 2414 of the engine support structure 2410. The platform 2432 is attached to the engine support structure 2410 using any suitable means including, for example, fasteners. In this embodiment, a plurality of bolts 2424 are used to attach the forward mount beam 2422 to the engine support structure 2410. The platform 2432 includes a platform clevis 2434 attached to the platform 2432. In this embodiment, the platform clevis 2434 is integrally formed with the platform 2432. The aft frame 2384 also includes a clevis, here, a frame clevis 2388, which, in this embodiment, is integrally formed with the aft frame 2384. The aft frame 2384 is connected to the platform 2432 by a mount link 2436. The mount link 2436 may be a rod or a plate having holes formed therein. A bolt 2424 is inserted through holes formed in the frame clevis 2388 and one of the holes of the mount link 2436 to connect the mount link 2436 to the aft frame 2384, and another bolt 2424 is inserted through holes formed in the platform 2432 and one of the holes of the mount link 2436 to connect the mount link 2436 to the platform 2432.

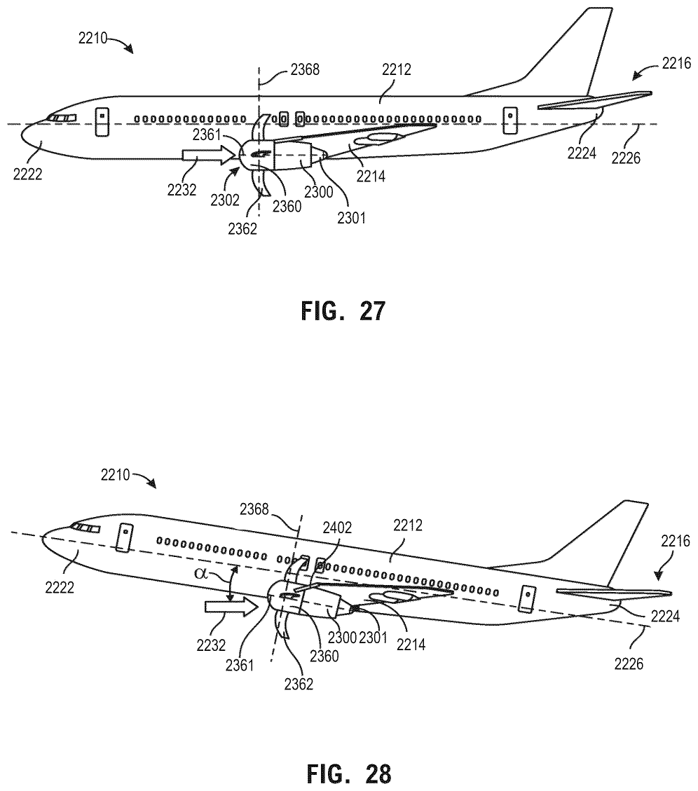

The aircraft 2210 changes pitch throughout a flight. The pitch of the aircraft 2210 may be the angle between the horizon (a horizontal plane) and the centerline 2226 of the aircraft 2210. The pitch of the aircraft 2210 may be small for conditions such as cruise or idle conditions and may be the large for takeoff, climb, and dive. FIG. 27 shows the aircraft 2210 during level flight, such as during a cruise condition. The fan blades 2362 are rotating about the rotation axis 2361 in a plane of rotation 2368, and airflow 2232 into the fan section 2302 is generally perpendicular to the plane of rotation 2368 and parallel to the rotation axis 2361. In this embodiment, the rotation axis 2361 is also parallel to both the longitudinal centerline 2301 of the engine 2300 and the centerline 2226 of the aircraft 2210. Accordingly, the airflow 2232 is also parallel to the longitudinal centerline 2301 of the engine 2300 and the centerline 2226 of the aircraft 2210.

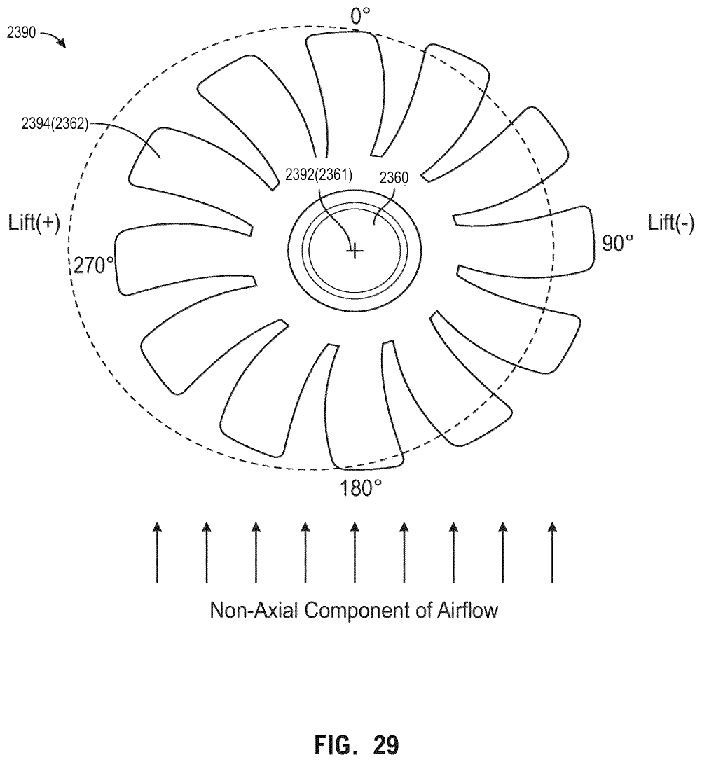

FIG. 28 shows the aircraft 2210 pitched upward, such as during takeoff or a climb condition. When the aircraft 2210 has a pitch, such as when the nose 2222 is pitched upward during takeoff or a climb condition, the aircraft 2210 may have an angle of attack (angle α). The angle of attack (AOA) is the angle α between the oncoming air or relative wind (airflow 2232) and a reference line on the aircraft 2210. In some embodiments, the reference line is a line connecting the leading edge and the trailing edge at some average point on the wing 2214. In other embodiments, such as for commercial, passenger aircraft, the centerline 2226 may be the reference line. Without changing the plane of rotation 2368 and/or the rotation axis 2361, the airflow 2232 flows into the fan section 2302 at an oblique angle relative to both the rotation axis 2361 and the plane of rotation 2368, giving rise to a 1P loading condition discussed further below with respect to FIG. 29.

FIG. 29 shows a rotating airfoil assembly 2390 including a rotating airfoil 2394. The rotating airfoil assembly 2390 depicted in FIG. 24 is the fan blades 2362 and the fan hub 2364 of the turbofan engine 2300 of FIGS. 22 and 23, and FIG. 29 is a front view of the spinner 2360. The rotating airfoils 2394 (fan blades 2362) of the rotating airfoil assembly 2390 are rotating in a clockwise direction in FIG. 29 about a rotation axis 2392 (rotation axis 2361). To aid in the following discussion, angular positions of the rotating airfoil 2394 and the rotating airfoil assembly 2390 are given relative to the rotation axis 2392, as shown in FIG. 29. The rotating airfoil 2394 is thus rotating in a downward direction from zero degrees to one hundred eighty degrees and in an upward direction from one hundred eighty degrees to three hundred sixty degrees (zero degrees).

FIG. 29 illustrates the rotation axis 2392 being angled (such as pitched upward or downward) relative to the airflow 2232 into the rotating airfoil 2394. More specifically, in FIG. 29, the rotation axis 2392 is angled upward relative to the airflow 2232 into the rotating airfoil 2394 such as during the condition shown in FIG. 28. In such a condition, the rotating airfoil assembly 2390 is subjected to a non-axial component of airflow that is in an upward direction (as depicted by the upward arrows). Each rotating airfoil 2394 produces a similar amount of lift at the top (zero degrees) and the bottom (one hundred eighty degrees) of the rotation that the rotating airfoil 2394 would produce if the rotating airfoil assembly 2390 was not inclined. Each rotating airfoil 2394, however, produces less lift when moving downward from the top (zero degrees) to the bottom (one hundred eighty degrees) and more lift when moving upward from the bottom (one hundred eighty degrees) to the top (zero degrees). This change in lift is schematically illustrated by the broken lines in FIG. 29. The lowest amount of lift produced by a rotating airfoil 2394 as the rotating airfoil 2394 makes one rotation is at ninety degrees, steadily increasing from that point to two hundred seventy degrees before steadily decreasing as the rotating airfoil 2394 continues rotating. This may be referred to as once per revolution loading or 1P loading.

Although, as noted above, the rotating airfoil assembly 2390 may be various suitable rotating airfoil assemblies 2390, the embodiments depicted in the figures show a turbofan engine 2300 with the rotating airfoil assembly 2390 being the fan section 2302 and, more specifically, the fan blades 2362 and the fan hub 2364. Accordingly, the discussion herein makes reference to the turbofan engine 2300, but this discussion is equally appliable to other rotating airfoil assemblies 2390, and to rotating airfoils 2394 other than the fan blades 2362 and fan hub 2364 discussed specifically herein.

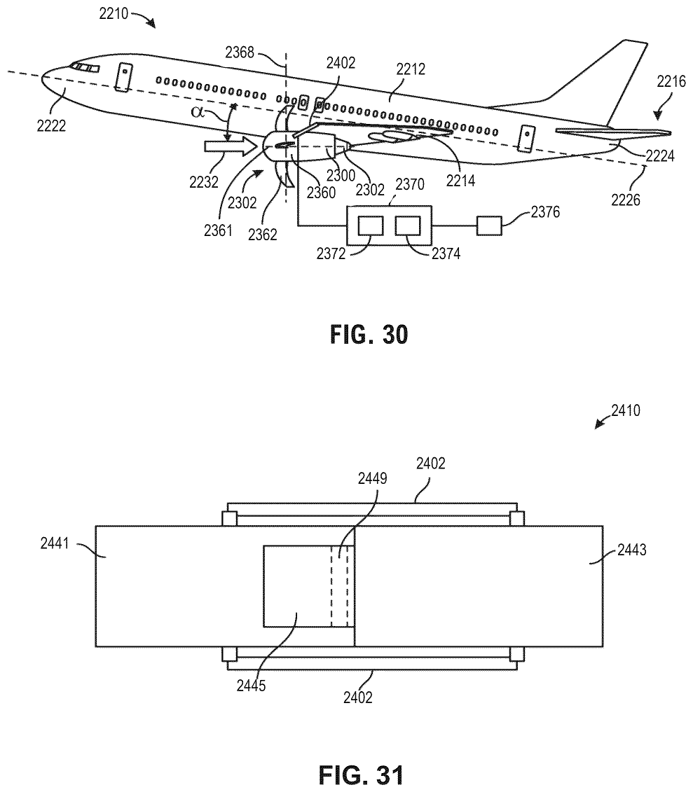

FIG. 30 shows the aircraft 2210 pitched upward, such as during takeoff or a climb condition, with a fan section 2302 according to an embodiment. To eliminate the 1P loading condition, the aircraft 2210 is configured to change the plane of rotation 2368 and, thus, eliminate or reduce the non-axial component of airflow discussed above. In the embodiment depicted in FIG. 30, the engine 2300 is rotated to change the plane of rotation 2368 such that, even when the aircraft 2210 has an angle of attack (angle α), the airflow 2232 is generally perpendicular to the plane of rotation 2368 and parallel to the rotation axis 2361. In some embodiments, such as when the aircraft 2210 has a high angle of attack (angle α), the aircraft 2210 may change the plane of rotation 2368 to a degree such that the airflow 2232 still has an oblique angle with the plane of rotation 2368, the rotation axis 2361, and/or the longitudinal centerline 2301 of the engine 2300, but the oblique angle and, thus, non-axial component of airflow is reduced.

The engine controller 2370 may be configured to receive inputs and to determine from those inputs that the aircraft 2210 has an angle of attack (angle α). In some embodiments, the engine controller 2370 is configured to receive an input indicating the pitch of the aircraft 2210 and determine that the aircraft 2210 has an angle of attack (angle α) based on the pitch of the aircraft 2210. As discussed above, the engine controller 2370 may be directly or indirectly communicatively coupled to a sensor 2376, such as a gyroscope or other suitable sensor to determine that the aircraft 2210 is pitched upward or downward, and the engine controller 2370 is configured to receive an input from the sensor 2376 indicating the pitch of the aircraft 2210. The sensor 2376 may be located on the engine 2300 and/or on another portion of the aircraft 2210 such as the fuselage 2212, a wings 2214, and/or the empennage 2216. The engine controller 2370 may use other inputs from other sensors, such as load cells, strain gauges, pressure sensors, and the like. The aircraft 2210 and, more specifically, the engine 2300 includes at least one actuator 2402 operable to change the plane of rotation 2368. The engine controller 2370 is operatively coupled to the at least one actuator 2402 and configured to operate the at least one actuator 2402 to change the plane of rotation 2368 based on the angle of attack (angle α). Specific mechanisms for changing the plane of rotation 2368 will be discussed further below. In some embodiments, the at least one actuator 2402 is configured to adjust (change) the angle of the rotation axis 2361. In some of these embodiments, the at least one actuator 2402 rotates the entire engine 2300 (e.g., rotating the fan section 2302 together with the turbomachine 2304), but, in other embodiments, the at least one actuator 2402 rotates only a portion of the engine 2300, such as the fan section 2302. In further embodiments, the at least one actuator 2402 pivots each fan blade 2362 as the fan blade 2362 rotates about the rotation axis 2361. In the embodiments discussed herein, the rotational movement is in the pitch direction of the aircraft 2210.

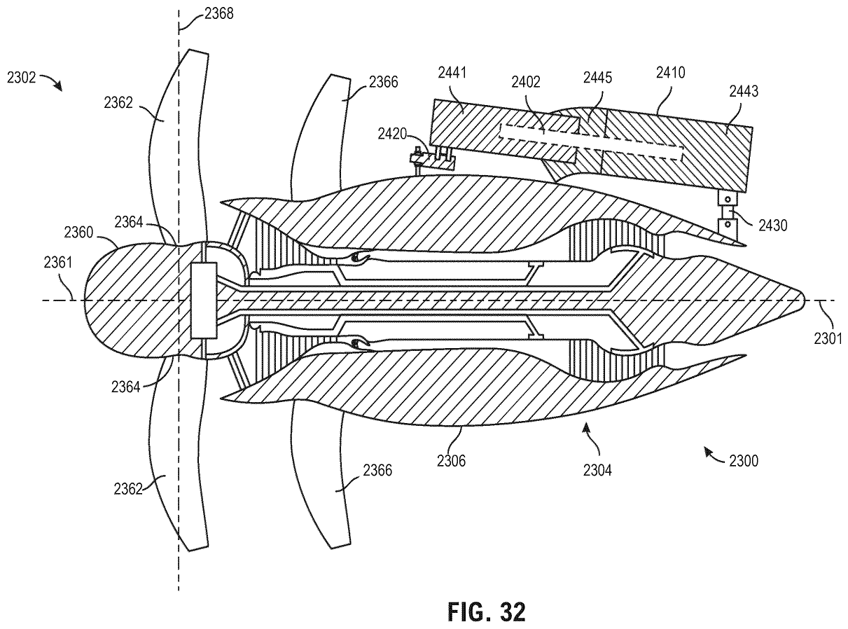

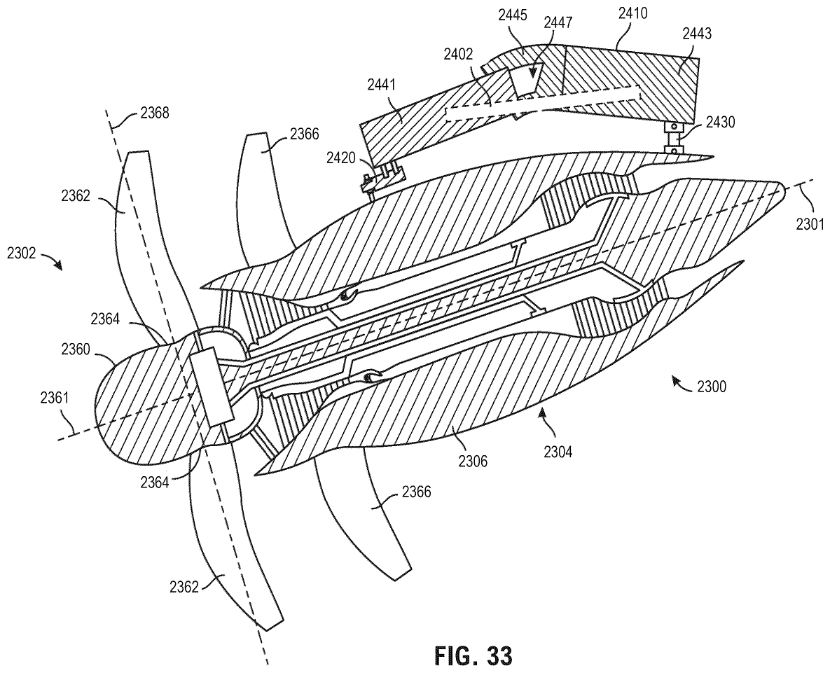

FIGS. 31, 32, and 33 show an engine support structure 2410 (pylon 2218 of FIG. 22) according to an embodiment. FIG. 31 is a top view of the engine support structure 2410 and FIGS. 32 and 33 are schematic, cross-sectional views of the engine 2300 and the engine support structure 2410 taken along line 23-23 in FIG. 22. The engine support structure 2410 of this embodiment is extendable between a stowed position and a deployed position. FIGS. 31 and 32 show the engine support structure 2410 in the stowed position, and FIG. 33 shows the engine support structure 2410 in the deployed position. The engine support structure 2410 of this embodiment includes a forward strut 2441 and an aft strut 2443. The forward strut 2441 is pivotable with respect to the aft strut 2443, and the aft strut 2443 is stationary remaining connected to the wing 2214 (see FIG. 22). At least one actuator 2402 and, in this embodiment, two actuators 2402 are connected to each of the forward strut 2441 and the aft strut 2443. The actuator 2402 extends in a forward direction and retracts in the aft direction. Extending the actuators 2402 from the stowed position moves the forward strut 2441 away from the aft strut 2443. The actuator 2402 may be any suitable actuator, including, for example, linear actuators, such as hydraulic cylinders.

The forward strut 2441 and the aft strut 2443 are engaged with each other such that, when the actuators 2402 are extended, the forward strut 2441 also curves and rotates the engine 2300 and, thus, the longitudinal centerline 2301 about the pitch direction. In this embodiment, a forward portion 2445 of the aft strut 2443 is curved in a downward direction and includes a curved slot 2447. The forward strut 2441 includes an engagement strut 2449 on an aft portion of the forward strut 2441. The engagement strut 2449 engages with the curved slot 2447 and guides the rotation of the forward strut 2441 as the actuators 2402 are extended or retracted. Each of the forward mount 2420 and the aft mount 2430 may be configured to allow for rotation about the pitch axis of the aircraft 2210, such as by changing the orientation of the frame clevis 2388 (FIG. 26) and platform clevis 2434 (FIG. 26) to allow for rotation. With the forward mount 2420 attached to the forward strut 2441 and the aft mount 2430 attached to the aft strut 2443, the engine support structure 2410 extends to maintain constant the distance between the forward mount 2420 and the aft mount 2430.

When the aircraft 2210 is pitched upward forming an angle of attack (angle α) between the fan blades 2362 and the airflow 2232 (FIG. 28), the engine controller 2370 is configured to extend the actuators 2402 and, thereby, pivot the engine 2300 and, more specifically, the rotation axis 2361 and the longitudinal centerline 2301 of the engine 2300 downward relative to the centerline 2226 of the aircraft 2210. Preferably, the engine controller 2370 would extend the actuators 2402 such that the rotation axis 2361 is parallel to the airflow 2232 and the plane of rotation 2368 is perpendicular to the airflow 2232. Accordingly, the fan blades 2362 are not subjected to a non-axial component of the airflow 2232 and the 1P loading can be eliminated or reduced.

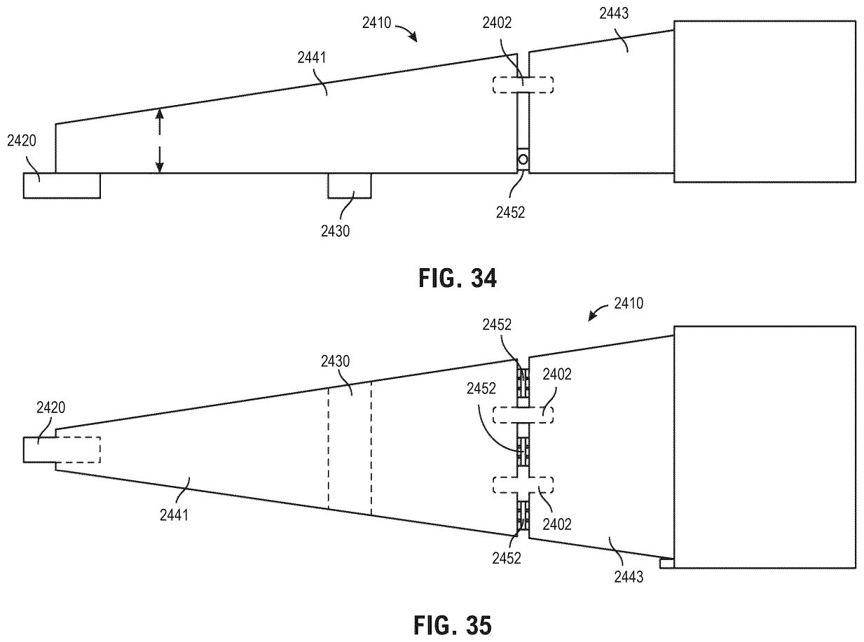

FIGS. 34 and 35 show an engine support structure 2410 (pylon 2218 of FIG. 22) according to another embodiment. FIG. 34 is a side view of the engine support structure 2410, and FIG. 35 is a top view of the engine support structure 2410. This embodiment, like the embodiment shown in FIGS. 31 to 33, utilizes a two-piece engine support structure 2410 with a forward strut 2441 and an aft strut 2443. The forward strut 2441 pivots relative to the aft strut 2443 and is, thus, operable to move the engine 2300, as discussed above relative to the embodiment shown in FIGS. 31 to 33. In this embodiment, however, both the forward mount 2420 and the aft mount 2430 are attached to the forward strut 2441.

The forward strut 2441 is attached to the aft strut 2443 by at least one pivot 2452. In this embodiment, a plurality of pivots 2452 are used. The pivot 2452 is located on a lower portion of each of the forward strut 2441 and the aft strut 2443. At least one actuator 2402 is connected to an upper portion of each of the forward strut 2441 and the aft strut 2443. In this embodiment, a plurality of actuators 2402 are used. Extending or retracting the actuators 2402 pivots the forward strut 2441 about the pivot 2452 to change the angle of the engine 2300. As discussed above, the actuators 2402 may be any suitable actuators, and, in this embodiment, the actuators 2402 preferably may be power screws.

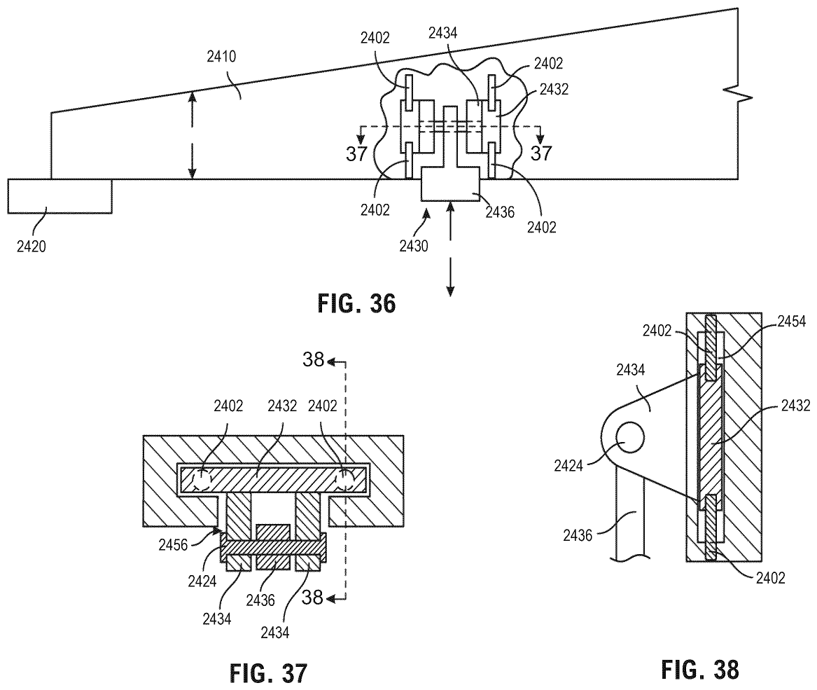

FIGS. 36, 37, and 38 show an engine support structure 2410 (pylon 2218 of FIG. 22) according to another embodiment. FIG. 36 is a side view of the engine support structure 2410. FIG. 37 is a cross-sectional view of the aft mount 2430, taken along line 37-37 in FIG. 36, and FIG. 38 is a cross-sectional view of the aft mount 2430, taken along line 38-38 in FIG. 37. In the previous embodiments, the engine support structure 2410 was movable to pivot the engine 2300 and to change the plane of rotation 2368 relative to the aircraft 2210. In this embodiment, the engine support structure 2410 is stationary and at least one of the forward mount 2420 and the aft mount 2430 is a movable mount that translates up and down to pivot the engine 2300 and to change the plane of rotation 2368 relative to the aircraft 2210, similar to the embodiments discussed above.

In the embodiment shown in FIGS. 36, 37, and 38, the aft mount 2430 is movable, and, more specifically, the platform 2432 is movable. In this embodiment, the platform 2432 is a plate that is oriented in a fore and aft direction and an up and down direction, with a thickness direction that is oriented in an inboard and outboard direction of the aircraft 2210. The platform clevis 2434 projects outboard (or inboard) in this embodiment. The platform 2432 may have other orientations. The platform 2432 is movable in an up and down direction, and the platform 2432 is positioned within a channel 2454 to guide the platform 2432 as it moves up and down. The channel 2454 includes an opening 2456 for the platform clevis 2434. A plurality of actuators 2402 are used to move the platform 2432 up and down. In this embodiment, two actuators 2402 are located on an upper side of the platform 2432 and two actuators 2402 are located on a lower side of the platform 2432. Although any suitable actuator 2402 may be used, as discussed above, the actuators 2402 of this embodiment are preferably power screws. Raising the aft mount 2430 (moving the aft mount 2430 upward) and, more specifically, the platform 2432 raises the aft frame 2384 and an aft portion of the engine 2300 thereby pivoting the fan section 2302 and the plane of rotation 2368 downward as shown in FIG. 30. The engine controller 2370 may be configured to raise and to lower the aft mount 2430 in a manner similar to that discussed above.

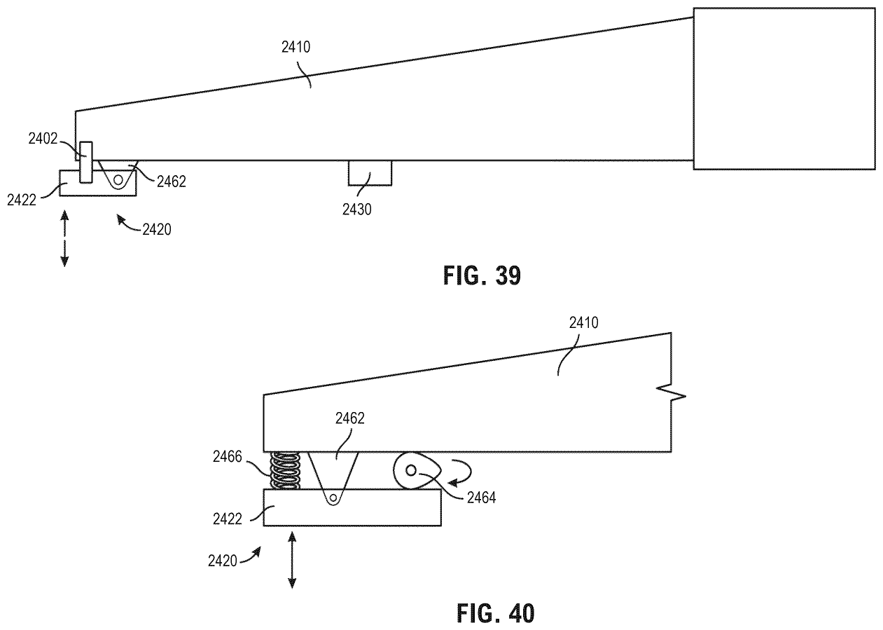

FIG. 39 shows an engine support structure 2410 (pylon 2218 of FIG. 22) according to another embodiment. FIG. 39 is a side view of the engine support structure 2410. In this embodiment, the forward mount 2420 is movable in an up and down direction. The forward mount 2420 and, more specifically, the forward mount beam 2422, is pivotably attached to the engine support structure 2410 by a suitable pivot 2462, such as a clevis and a pin connection. At least one actuator 2402 is connected to the forward mount beam 2422 forward or aft of the pivot 2462 to pivot the forward mount beam 2422 about the pivot 2462. The actuator 2402, in this embodiment, is a linear actuator such as a power screw. Pivoting the forward portion of the forward mount 2420 and, more specifically, the forward mount beam 2422 downward, moves the forward frame 2382 (FIG. 25) and a forward portion of the engine 2300 downward, thereby pivoting the fan section 2302 and the plane of rotation 2368 downward as shown in FIG. 30. The engine controller 2370 may be configured to pivot the forward mount 2420 in a manner similar to that discussed above.

FIG. 40 shows an engine support structure 2410 (pylon 2218 of FIG. 22) according to another embodiment. FIG. 40 is a side view of the engine support structure 2410. This embodiment is similar to the embodiment discussed above with reference to FIG. 39, but, instead of a linear actuator 2402, a rotatable cam, such as a rotatable eccentric cam, 2464 is used to pivot the forward mount 2420. The rotatable cam 2464 may be positioned either forward or aft of the pivot 2462 and rotating the rotatable cam 2464 rotates the forward portion of the forward mount beam 2422. To keep the forward mount beam 2422 and the engine support structure 2410 in contact with each other, a spring 2466 is positioned on an opposite side of the pivot 2462 from the rotatable cam 2464 in a counterbalance arrangement and applying a biasing (counterbalancing) force to the forward mount beam 2422. Although a spring 2466 is shown in FIG. 40, other suitable means may be used to apply the biasing (counterbalancing) force, including, for example a spring/damper arrangement.

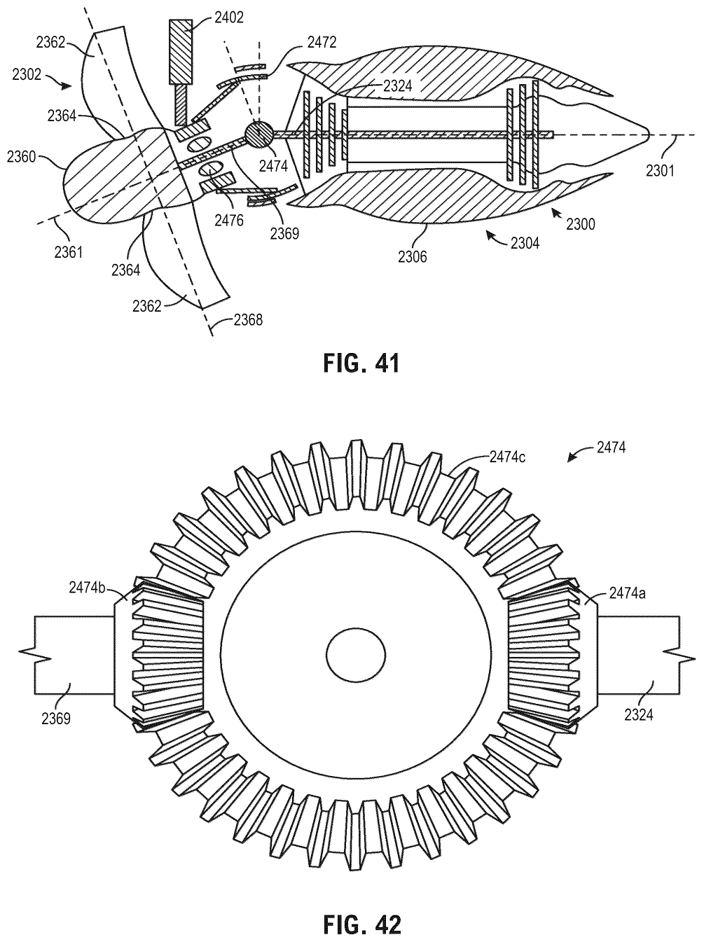

FIG. 41 is a schematic, cross-sectional view of an engine 2300 according to another embodiment. In the embodiments discussed above, the entire engine 2300 was rotated to change the engine 2300, but, in this embodiment, only a portion of the engine 2300 was rotated, specifically, the fan section 2302. In this embodiment, the actuator 2402 is used to pivot the fan section 2302 and, more specifically, the fan blades 2362 and the fan hub 2364, to rotate the rotation axis 2361 and the plane of rotation 2368. The engine controller 2370 is configured to operate the actuator 2402 in a manner similar to those discussed above and the engine controller 2370, in conjunction with the actuator 2402, is configured to change the pitch of the fan section 2302.

The fan section 2302, including the spinner 2360, the fan blades 2362, and the fan hub 2364, is pivotably connected to the outer casing 2306 of the turbomachine 2304. Any suitable pivotable connection may be used such as a curved slot allowing for pitch changes or, as in this embodiment, a spherical joint 2472 is used. As discussed above, the fan hub 2364 is coupled to the LP shaft 2324 of the turbomachine 2304, and the LP shaft 2324 rotates the fan blades 2362 and the fan hub 2364. The LP shaft 2324 is an example of an output shaft of the turbomachine 2304 (torque producing system). The fan hub 2364 is connected to a fan shaft 2369 in this embodiment, and the LP shaft 2324 is connected to the fan hub 2364 through a differential gearbox 2474. The fan shaft 2369 is an example of an input shaft of the rotating airfoil assembly 2390. The differential gearbox 2474 is centered within the spherical joint 2472 and allows the fan shaft 2369 to be angled relative to the LP shaft 2324 and still receive the rotational driving force from the LP shaft 2324. The differential gearbox 2474 is an example of a pivotable coupling between the LP shaft 2324 and the fan shaft 2369 that allows the LP shaft 2324 to change pitch relative to the fan shaft 2369. The fan shaft 2369 may be supported by a barrel bearing 2476 to allow for load transfer and also pitch and rotation.

As noted above with respect to FIG. 23, a reduction gearbox 2326 may be used to connect the LP shaft 2324 with the fan hub 2364 and fan blades 2362. In the embodiment of FIG. 41, the differential gearbox 2474 may be used in place of the reduction gearbox 2326 and configured to reduce the input rotational speed from the LP shaft 2324 to a speed suitable for rotating the fan hub 2364 and fan blades 2362. Alternatively, the differential gearbox 2474 may be used in addition to the reduction gearbox 2326 and, in such cases, the reduction gearbox 2326 may be located between the differential gearbox 2474 and the LP shaft 2324 in the drive train.

FIG. 42 shows the differential gearbox 2474 of FIG. 41. The differential gearbox 2474 includes an input gear 2474a connected to the LP shaft 2324 and an output gear 2474b connected to the fan shaft 2369. Each of the input gear 2474a and the output gear 2474b engages with a pair of transfer gears 2474c to transfer torque from the input gear 2474a to the output gear 2474b. Only one transfer gear 2474c is shown in FIG. 42 as the other transfer gear 2474c is removed for clarity. Each transfer gear 2474c rotates about the same axis and both are positioned to oppose each other on opposite sides of the input gear 2474a and the output gear 2474b. The differential gearbox 2474 is configured to allow the fan shaft 2369 and the output gear 2474b to rotate and to engage with the transfer gear 2474c at different radial positions of the transfer gear 2474c, thereby, allowing the fan section 2302 to change angle as discussed above.

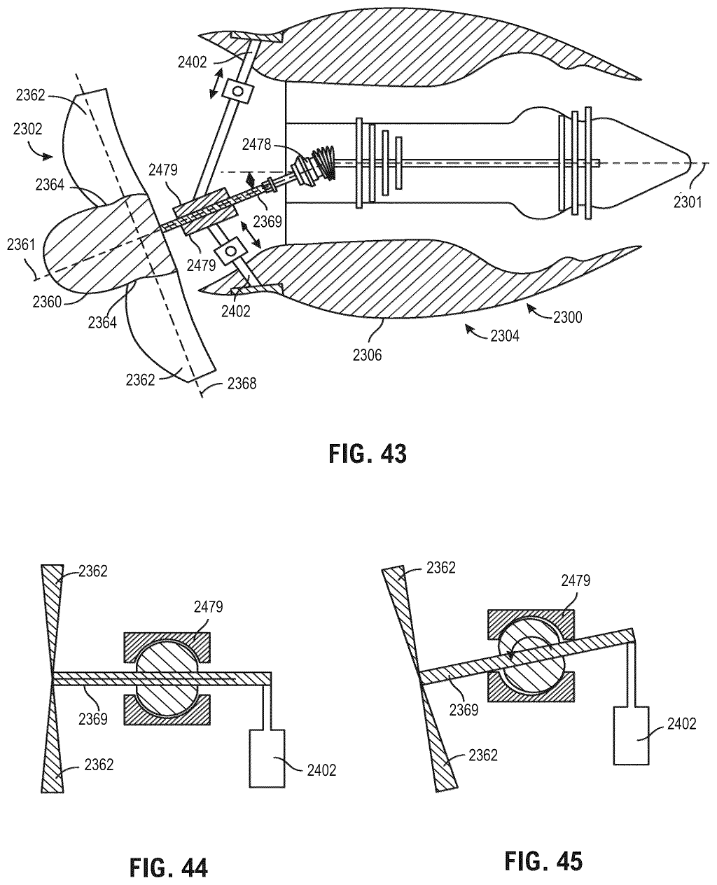

FIG. 43 is a schematic, cross-sectional view of an engine 2300 according to another embodiment. In the embodiment discussed above with reference to FIG. 41, the LP shaft 2324 was connected to the fan shaft 2369 by a differential gearbox 2474, but other suitable connections may be used. In this embodiment, for example, the LP shaft 2324 and the fan shaft 2369 are connected by a constant velocity (CV) joint 2478 instead of a differential gearbox 2474. The constant velocity (CV) joint 2478 is another example of a pivotable coupling between the LP shaft 2324 and the fan shaft 2369. The constant velocity (CV) joint 2478 allows for power to be transferred from the LP shaft 2324 to the fan shaft 2369 and accommodates rotation in the pitch direction of the fan section 2302. The constant velocity (CV) joint 2478 allows for high articulation angles and, thus, can be used to move the fan hub 2364 and fan blades 2362 over a wide range of angles of attack. The fan shaft 2369 may be supported by a bearing such as a spherical bearing 2479, as will be discussed further below. In this embodiment, two actuators 2402 are shown connected to the spherical bearing 2479 to move the fan shaft 2369 and thus the fan hub 2364 and fan blades 2362.

FIGS. 44 and 45 are cross-sectional detail views showing a spherical bearing 2479 supporting the fan shaft 2369. In the embodiment shown in FIG. 41 a barrel bearing 2476 is used to support the fan shaft 2369, but other bearings may be used. A spherical bearing 2479, as shown in FIGS. 44 and 45, may be used, for example. The spherical bearing 2479 allows for an extra degree of freedom relative to traditional radial bearings. When the fan shaft 2369 is moved by the actuator 2402, for example, the spherical bearing 2479 allows the fan shaft 2369 to pivot in the axial direction within the spherical bearing 2479, as shown in FIG. 45.

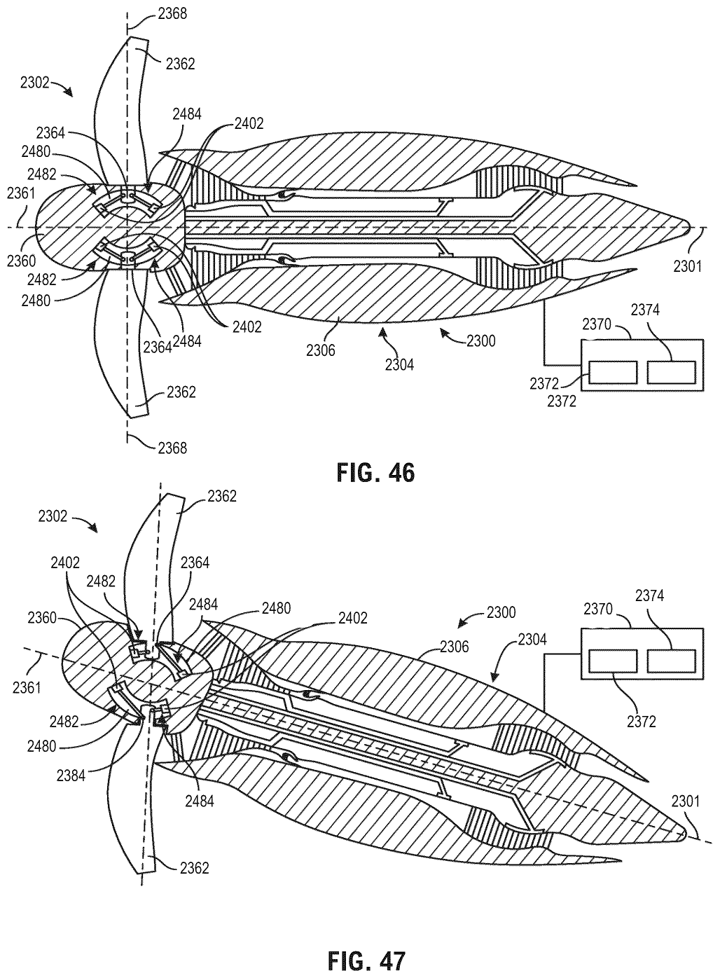

FIGS. 46 and 47 are schematic, cross-sectional views of an engine 2300 according to another embodiment. In the embodiments discussed above, the engine controller 2370 is configured to operate the at least one actuator 2402 to rotate the engine 2300 as a whole, such that the angle of the longitudinal centerline 2301 is changed relative to the aircraft 2210 or to rotate the fan section 2302 such that the rotation axis 2361 is changed relative to the aircraft 2210 and longitudinal centerline 2301. In this embodiment, the engine controller 2370 is configured to operate the at least one actuator 2402 to change the plane of rotation 2368 to have the orientation discussed above, without changing the angle longitudinal centerline 2301 or rotation axis 2361 with respect to the aircraft 2210. Instead, the pitch (as used herein, a forward and aft direction) of each of the fan blades 2362 is changed as the fan blades 2362 rotate about the rotation axis 2361. FIG. 46 shows the engine 2300 during level flight, such as in the condition discussed above with respect to FIG. 27, and FIG. 47 shows the engine 2300 when the aircraft 2210 has an angle of attack such as in the condition discussed above with respect to FIGS. 28 and 29.

In this embodiment, each fan blade 2362 is connected to the fan hub 2364 with a pivotable connection that allows the fan blade 2362 to change pitch. In this embodiment, the pivotable connection includes an arcuate groove 2480 and the fan blade 2362 is configured to move back and forth within the arcuate groove 2480. In this embodiment, each fan blade 2362 is connected to a corresponding arcuate groove 2480, but other arrangements may be used. The arcuate groove 2480 is oriented in the forward and aft direction of the engine 2300. At least one actuator 2402, and, in this embodiment, two actuators 2402 are connected to the fan blade 2362 to move the fan blade 2362 forward and aft within the arcuate groove 2480.

During the condition shown in FIG. 46, the actuators 2402 maintain the fan blade 2362 at a fixed position as the fan blades 2362 rotate about the rotation axis 2361, but, in the conditions shown in FIG. 47, the engine controller 2370 is configured to operate the actuators 2402 to move the fan blades 2362, independently, between a forward portion of the arcuate groove 2480 and an aft portion of the arcuate groove 2480. Each fan blade 2362 is located on a forward portion 2482 of the arcuate groove 2480 when at a twelve o'clock position (zero degrees in FIG. 29), but each fan blade 2362 is located on an aft portion 2484 of the arcuate groove 2480 when at a six o'clock position (one hundred eighty degrees in FIG. 29). The actuators 2402 move each fan blade 2362 from the forward portion 2482 to the aft portion 2484 as the fan blade 2362 rotates from the twelve o'clock position to the six o'clock position, and the actuators 2402 move each fan blade 2362 from the aft portion 2484 to the forward portion 2482 as the fan blade 2362 rotates from the six o'clock position to the twelve o'clock position. The engine controller 2370 may control the degree of forward and aft movement of each fan blade 2362 to maintain a plane of rotation 2368 that is perpendicular to the airflow 2232.

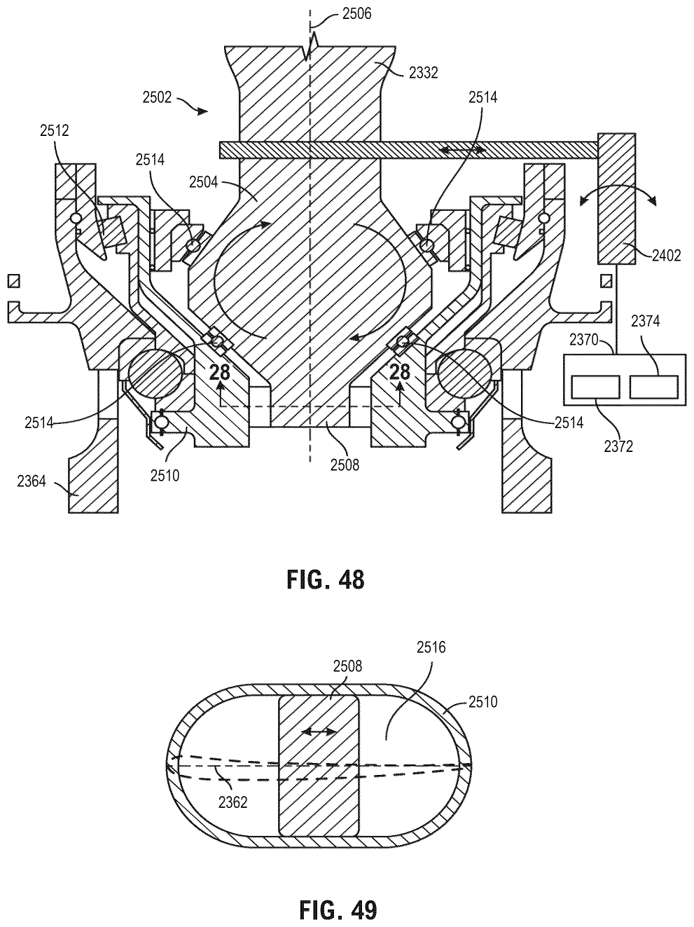

FIG. 48 is a cross-sectional detail view of the fan hub 2364 according to another embodiment. In the embodiment discussed above with respect to FIGS. 46 and 47, each fan blade 2362 changed pitch with a pivotable connection within an arcuate groove 2480. Other suitable pivotable connections may be used, such as the joint shown in FIG. 48. The fan blade 2362 includes a root 2502 including a bulb 2504. The bulb 2504 is connected to the fan hub 2364 by a trunnion 2510, and the trunnion 2510 secures the bulb 2504.

The fan blade 2362 includes a longitudinal axis 2506 that extends in the radial direction from the fan hub 2364. A plurality of radial bearings 2512 connect the trunnion 2510 to the fan hub 2364 and allow the fan blades 2362 to be rotated about the longitudinal axis 2506. Such angular rotation of the fan blades 2362 is referred to herein as airfoil pitch or airfoil angle of attack to distinguish this movement from movement of the fan blades 2362 that is about an axis that is parallel to the pitch axis of the aircraft 2210.

In this embodiment, a plurality of spherical bearings 2514 connect the trunnion 2510 to the bulb 2504 and allow the bulb 2504 and, thus, the fan blade 2362 to change pitch (forward and aft direction of the aircraft 2210) in response to movement of at least one actuator 2402. The actuator 2402 is connected to the root 2502 and configured to move the root 2502 in a forward and aft direction. The engine controller 2370 may be configured to operate the actuator 2402 to change the pitch of the fan blades 2362 pitch (forward and aft direction of the aircraft 2210) in a manner similar to that discussed above with reference to FIG. 47.

FIG. 49 is a cross-sectional view of the root 2502 of the fan blade 2362 taken along line 49-49 in FIG. 48. In this embodiment, an inner portion 2508 of the root 2502 extends below the bulb 2504 and into a slot 2516 formed in the trunnion 2510. The inner portion 2508 is sized relative to the slot 2516 to restrict movement in one direction but with a gap permit movement in another (the forward and aft direction).

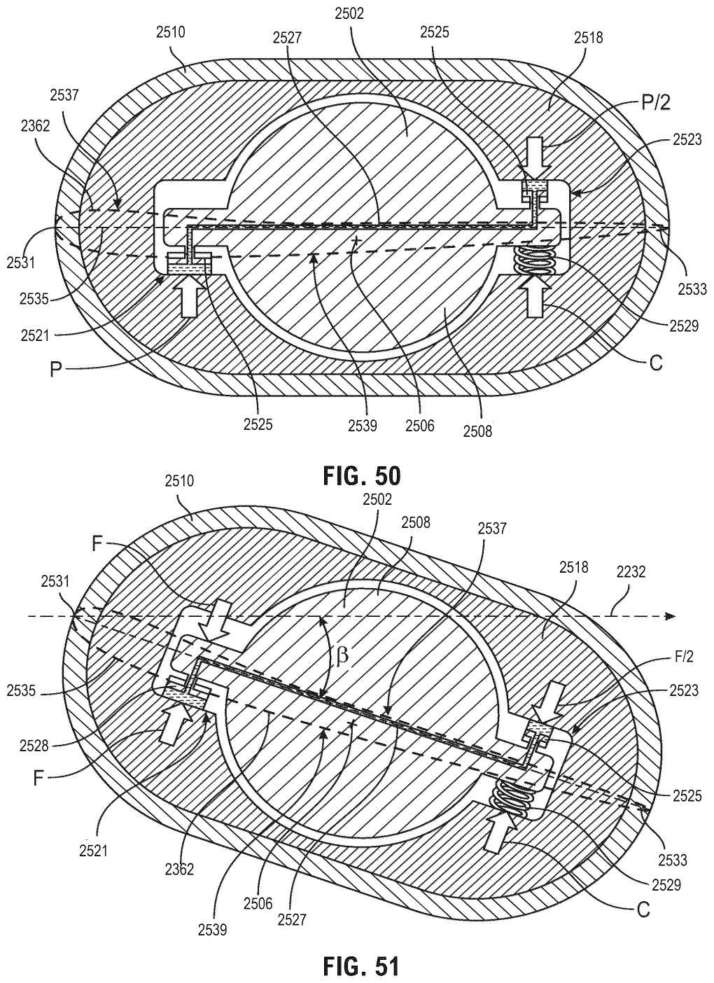

FIG. 50 is a cross-sectional view of a root 2502 of a fan blade 2362 according to another embodiment. In the embodiments discussed above, the pitch of the fan blades 2362 relative to the pitch axis of the aircraft 2210 is actively controlled by the engine controller 2370. These active controls may be used on their own or coupled with other approaches to mitigate the 1P loading. In this embodiment, the fan blade 2362 is equipped with a spring and damper system 2520 that is used to passively adjust the airfoil pitch based on the load applied to the fan blade 2362. As noted above, airfoil pitch as used herein is the rotation or angle of the fan blade 2362 about the longitudinal axis 2506 (see FIG. 48).

The fan blade 2362, a top view of which is shown in broken lines in FIG. 50, has a leading edge 2531 and a trailing edge 2533. A chord 2535 of the fan blade 2362 extends from the leading edge 2531 to the trailing edge 2533. The fan blade 2362 also includes a suction side and a pressure side, and surfaces of the fan blade 2362 are formed on each of the suction side and the pressure side between the leading edge 2531 and the trailing edge 2533. These surfaces are a suction surface 2537 and a pressure surface 2539. As can be seen in FIG. 50, the fan blade 2362 is a cambered airfoil with the suction surface 2537 having a convex curvature and the pressure surface 2539 being generally flat. The fan blade 2362 may have any suitable shape, however, including, for example, concave surfaces, and the fan blade 2362 may be a symmetric airfoil. The suction surface 2537 and the pressure surface 2539 are positioned on opposite sides of the fan blade 2362 such that, when airflows over the suction surface 2537 and the pressure surface 2539 of the fan blade 2362 as the fan blade 2362 rotates about the rotation axis 2361, the fan blade 2362 generates lift (thrust).

The spring and damper system 2520 is connected to the root 2502 and, more specifically, the inner portion 2508 of the root 2502. The spring and damper system 2520 is configured to impart a force against the root 2502 to rotate the root 2502 and the fan blade 2362 about the longitudinal axis 2506, adjusting the airfoil pitch under certain conditions, such as those discussed above. Similar to the embodiment of FIGS. 48 and 49, a trunnion 2510 is configured to actively rotate the fan blade 2362 and to change the airfoil angle of attack (angle 3, see FIG. 51) as a pitch control mechanism to control the pitch of all of the blades at the same time (up to, for example, forty-five degrees on either side of a neutral position). The trunnion 2510 thus may be used to control the amount of thrust produced by the fan section 2302. In contrast to the embodiment of FIGS. 48 and 49, the slot 2516 includes a bearing 2518 that limits the free rotation of the inner portion 2508 that is imparted by the spring and damper system 2520. The amount of rotation that results from the spring and damper system 2520 is limited to a smaller amount, such as ten degrees from the airfoil angle of attack (angle 3) set by the trunnion 2510.

The spring and damper system 2520 includes a plurality of dampers including a large damper 2521 and a small damper 2523. In this embodiment, the large damper 2521 and the small damper 2523 are hydraulic dampers, but any suitable damper may be used, including, for example, pneumatic dampers. Each of the large damper 2521 and the small damper 2523 is configured to impart a rotational force to the inner portion 2508 to rotate the fan blade 2362 about the longitudinal axis 2506. Each of the large damper 2521 and the small damper 2523 includes a piston 2525. The piston 2525 of the small damper 2523 has a smaller surface area than the piston 2525 of the large damper 2521. The large damper 2521 and the small damper 2523 are fluidly connected to each other by a conduit 2527 and, thus, the pressure of the hydraulic fluid in each large damper 2521 and the small damper 2523 is the same. With the difference in the surface area of the pistons 2525, the small damper 2523 imparts a lower pressure load (force) than the large damper 2521. In the embodiment shown in FIG. 50, the piston 2525 of the small damper 2523 has half the area of the piston 2525 of the large damper 2521, and, thus, if the large damper 2521 imparts a force (pressure load) P to the inner portion 2508, the small damper 2523 imparts a force (pressure load) that is one-half P to the inner portion 2508.

The large damper 2521 and the small damper 2523 are positioned on opposite sides of the chord 2535, and, in this embodiment, the large damper 2521 is positioned on the pressure side and the small damper 2523 is positioned on the suction side. The opposite arrangement may also be used with the large damper 2521 positioned on the suction side and the small damper 2523 positioned on the pressure side. The large damper 2521 and the small damper 2523 are also positioned on opposite ends of the fan blade 2362 (opposite side of inner portion 2508) on either side of the longitudinal axis 2506. In this embodiment, the large damper 2521 is positioned on a forward end closer to the leading edge 2531 than the trailing edge 2533, and the small damper 2523 is positioned on a trailing end closer to the trailing edge 2533 than the leading edge 2531. Although other arrangements may be used, such as the small damper 2523 on the leading end and the large damper 2521 on the trailing end. With this arrangement, each of the large damper 2521 and the small damper 2523 imparts a rotational force to the fan blade 2362 in the same direction to change the airfoil pitch. In this embodiment, this rotational force is in a direction that increases the airfoil angle of attack (angle β).

The spring and damper system 2520 also includes a spring 2529 configured to counterbalance the rotational force imparted by the large damper 2521 and the small damper 2523. The spring 2529 may located at any suitable position to counterbalance the rotational force imparted by the large damper 2521 and the small damper 2523, but, in this embodiment, the spring 2529 is located opposite small damper 2523 on the pressure side of the fan blade 2362 and on the trailing end of the fan blade 2362. The spring 2529 is configured to impart a rotational force to the fan shaft (not shown) and, more specifically, the inner portion 2508. The rotation direction of the force imparted by the spring 2529 is opposite the rotational direction of the large damper 2521 and the 2523. The spring 2529 of this embodiment is a compression spring, but other suitable springs and arrangements may be used.

In FIG. 50, the fan blade 2362 is stationary (not rotating), and, in the example shown in FIG. 50, the large damper 2521 imparts a force of P to the inner portion 2508 and the small damper 2523 imparts a force of one-half P to the inner portion 2508 for a total rotational force of one and one-half P. As a result, the spring 2529 is compressed to a point where the spring force C is equal to one and one-half P.

FIG. 51 is a cross-sectional view of the root 2502 of the fan blade 2362 illustrating a condition where the fan blade 2362 is rotating about the rotation axis 2361. The fan blade 2362 has an airfoil angle of attack (angle β) with the airflow 2232. As the fan blade 2362 rotates, the fan blade 2362 produces a thrust with a resultant force F on the fan blade 2362. The pressure in the large damper 2521 adjusts to balance the force F on the fan blade 2362 from the thrust. The small damper 2523 thus imparts a rotational force of one-half F on the fan blade 2362, and the fan blade 2362 rotates to an airfoil pitch where the spring force counterbalances the force of one-half F. In a condition when the aircraft 2210 is flying level, such as the condition shown above in FIG. 27, the thrust and resultant force F is constant through one rotation of the fan blade 2362.

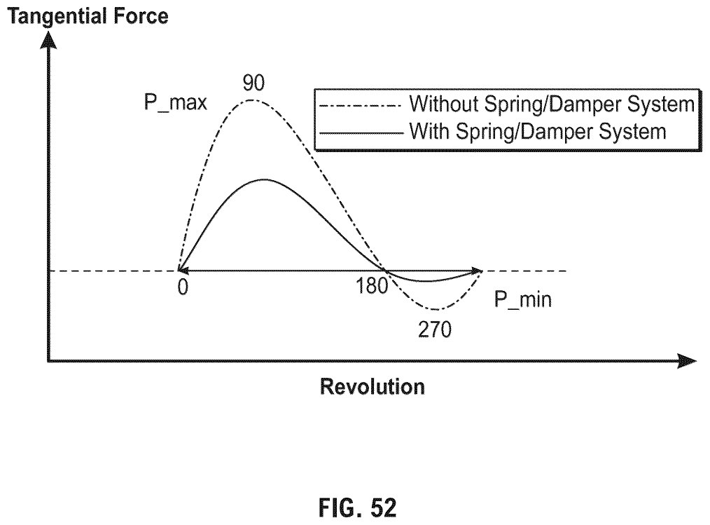

In a condition when the there is a non-axial component of airflow, such as shown in FIG. 28 above, the thrust and resultant force F will change as the fan blade 2362 rotates. As the fan blade 2362 moves through portions of the rotation where resultant force F increases, the small damper 2523 will also impart an additional force to the inner portion 2508 and rotate the fan blade 2362 in a direction to increase the airfoil angle of attack (angle β). When the airfoil angle of attack (angle β) increases, the thrust produced by the fan blade 2362 decreases. As the fan blade 2362 moves through portions of the rotation where resultant force F decreases, the small damper 2523 will imparts less force to the inner portion 2508, and the spring 2529 rotates the fan blade 2362 in a direction to decrease the airfoil angle of attack (angle β). When the airfoil angle of attack (angle β) decreases, the thrust produced by the fan blade 2362 increases. In this way, the cyclic load on the fan blade 2362 can be reduced as shown in FIG. 52.

FIG. 52 shows the load on the fan blade 2362 as the fan blade 2362 rotates through one revolution in a condition shown in FIG. 29. The broken line illustrates one rotation of a fan blade 2362 without the spring and damper system 2520 and the solid line illustrates one rotation of a fan blade 2362 with the spring and damper system 2520. As can be seen in FIG. 52, the use of the spring and damper system 2520 reduces the cyclic loading on the fan blade 2362.

Further aspects of the disclosure are provided by the subject matter of the following clauses:

A turbofan engine for an aircraft, the turbofan engine comprising a fan having a plurality of fan blades, each of the plurality of fan blades being rotatable about a pitch axis, and a fan actuation system including one or more actuators for rotating the plurality of fan blades about the pitch axis and one or more radial thrust bearings, wherein the fan actuation system is characterized by a fan actuation system envelope in a range from 300 to 1860, the fan actuation system envelope being given by:

$$\frac{{N}_{FB} \times {D}_{FT} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, M_{cruise} is a Mach number of the aircraft at cruise operating conditions, and R_{TB} is a thrust bearing radius of the one or more radial thrust bearings.

A turbofan engine for an aircraft, the turbofan engine comprising a fan having a plurality of fan blades, each of the plurality of fan blades being rotatable about a pitch axis, a nacelle that circumferentially surrounds the fan, and a fan actuation system including one or more actuators for rotating the plurality of fan blades about the pitch axis and one or more radial thrust bearings, wherein the fan actuation system is characterized by a fan actuation system envelope in a range from 300 to 660, the fan actuation system envelope being given by:

$$\frac{{N}_{FB} \times {D}_{FT} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, Mcruise is a Mach number of the aircraft at cruise operating conditions, and R_{TB} is a thrust bearing radius of the one or more thrust bearings.

A turbofan engine for an aircraft, the turbofan engine comprising a fan having a plurality of fan blades, the fan being an open fan, and each of the plurality of fan blades being rotatable about a pitch axis, and a fan actuation system including one or more actuators for rotating the plurality of fan blades about the pitch axis and one or more radial thrust bearings, wherein the fan actuation system is characterized by a fan actuation system envelope in a range from 660 to 1860, the fan actuation system envelope being given by:

$$\frac{{N}_{FB} \times {D}_{F T} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, Mcruise is a Mach number of the aircraft at cruise operating conditions, and R_{TB} is a thrust bearing radius of the one or more radial thrust bearings.

The turbofan engine of any preceding clause, wherein the fan actuation system includes a hydraulic system that supplies hydraulic fluid for rotating the plurality of fan blades about the pitch axis.

The turbofan engine of any preceding clause, wherein the cruise operating conditions occur at a mid-level power range of the turbofan engine.

The turbofan engine of the preceding clause, wherein the mid-level power range is 30% to 85% of a sea level static maximum engine rated thrust for the turbofan engine.

The turbofan engine of any preceding clause, wherein the turbofan engine is rated for use on a regional aircraft having a maximum takeoff thrust of 10,000 lbf to 20,000 lbf.

The turbofan engine of any preceding clause, wherein the turbofan engine is rated for use on a narrow body aircraft having a maximum takeoff thrust of 15,000 lbf to 30,000 lbf.

The turbofan engine of any preceding clause, wherein the turbofan engine is rated for use on a wide body aircraft having a maximum takeoff thrust of 40,000 lbf to 110,000 lbf.

The turbofan engine of any preceding clause, wherein N_{FB} is in a range from ten to eighteen.

The turbofan engine of any preceding clause, wherein N_{FB} is in a range from ten to fourteen.

The turbofan engine of any preceding clause, wherein D_{FT} is in a range from 84.0 inches to 180.0 inches.

The turbofan engine of any preceding clause, wherein D_{FT} is in a range from 84.0 inches to 120.0 inches.

The turbofan engine of any preceding clause, wherein D_{FT} is in a range from 120.0 inches to 168.0 inches.

The turbofan engine of any preceding clause, wherein R_{TB} is in a range from 14 inches to 27 inches.

The turbofan engine of any preceding clause, wherein R_{TB} is in a range from 14 inches to 19 inches.

The turbofan engine of any preceding clause, wherein R_{TB} is in a range from 19 inches to 27 inches.

The turbofan engine of any preceding clause, wherein M_{cruise} is in a range from 0.7 to 0.92.

The turbofan engine of any preceding clause, wherein M_{cruise} is in a range from 0.75 to 0.9.

The turbofan engine of any preceding clause, wherein M_{cruise} is in a range from 0.8 to 0.88.

The turbofan engine of any preceding clause, wherein the fan actuation system includes a pressurized pneumatic chamber that is filled with a pressurized gas that biases the plurality of fan blades to a feather position.

The turbofan engine of any preceding clause, wherein the fan actuation system is devoid of counterweights for reducing inertial loading associated with rotation of fan blades.

The turbofan engine of any preceding clause, further comprising core cowl, wherein the turbofan engine has a longitudinal centerline axis, and the core cowl is annular about the longitudinal centerline axis.

The turbofan engine of the preceding clause, further comprising a core inlet that is annular about the longitudinal centerline axis.

The turbofan engine of any preceding clause, further comprising a gearbox assembly, wherein the turbine section includes a low-pressure shaft, and the fan has a fan shaft that is coupled to the low-pressure shaft through the gearbox assembly.

The turbofan engine of the preceding clause, wherein the gearbox assembly has a gear ratio in a range 3.5:1 to 5:1 for a ducted engine.

The turbofan engine of any preceding clause, wherein the gearbox assembly has a gear ratio in a range from 4:1 and 10:1 for an unducted fan engine.

The turbofan engine of any preceding clause, wherein the low-pressure shaft, the gearbox assembly, and the fan shaft are coaxial along the longitudinal centerline axis.

The turbofan engine of any preceding clause, wherein the fan actuation system envelope is in a range from 660 to 1020.

The turbofan engine of any preceding clause, the fan actuation system envelope being in a range from 300 to 660.

The turbofan engine of any preceding clause, the fan actuation system envelope being in a range from 660 to 1860.

The turbofan engine of any preceding clause, the fan actuation system envelope being in a range from 660 to 1020.

The turbofan engine of any preceding clause, further comprising a nacelle that circumferentially surrounds the fan.

The turbofan engine of any preceding clause, wherein the turbofan engine is an open fan engine.

The turbofan engine of any preceding clause, further comprising a fan hub, the plurality of fan blades extending radially from the fan hub.

The turbofan engine of any preceding clause, the fan actuation system being disposed within the fan hub.

The turbofan engine of any preceding clause, further comprising a compressor section, a combustor, and a turbine section.

The turbofan engine of any preceding clause, the compressor section including a low-pressure compressor and a high-pressure compressor, and the turbine section including a high-pressure turbine and a low-pressure turbine.

The turbofan engine of any preceding clause, further comprising a high-pressure shaft that couples the high-pressure compressor and the high-pressure turbine.

The turbofan engine of any preceding clause, further comprising a low-pressure shaft that couples the low-pressure compressor and the low-pressure turbine.

The turbofan engine of any preceding clause, the low-pressure shaft being disposed through the high-pressure shaft.

The turbofan engine of any preceding clause, the gearbox assembly comprising a gear assembly comprising a plurality of gears.

The turbofan engine of any preceding clause, the gearbox assembly including one or more gear bearings.

The turbofan engine of any preceding clause, each of the plurality of fan blades extending from a fan root to a fan tip.

The turbofan engine of any preceding clause, the fan tip diameter DFT being defined from the longitudinal centerline axis to the fan tip of each of the plurality of fan blades.

The turbofan engine of any preceding clause, the fan actuation system including a trunnion mechanism that includes a plurality of trunnions, each fan blade being disposed in a respective trunnion.

The turbofan engine of any preceding clause, the fan blades extending from a disk.

The turbofan engine of any preceding clause, the disk including a plurality of disk segments.

The turbofan engine of any preceding clause, each fan blade being coupled to a respective disk segment at the trunnion mechanism.

The turbofan engine of any preceding clause, the plurality of trunnions being rotatable to rotate the plurality of fan blades about the pitch axis.

The turbofan engine of any preceding clause, the fan actuation system including one or more actuators coupled to the plurality of trunnions.

The turbofan engine of any preceding clause, the fan actuation system including a plurality of trunnion links and a unison ring, the plurality of trunnion links being coupled to the plurality of trunnions and to the unison ring.

The turbofan engine of any preceding clause, the plurality of trunnion links including a plurality of forward trunnion links and a plurality of aft trunnion links.

The turbofan engine of any preceding clause, the unison ring including a plurality of unison rings including a forward unison ring that is positioned forward of the plurality of trunnions and an aft unison ring that is disposed aft of the plurality of trunnions.

The turbofan engine of any preceding clause, the plurality of forward trunnion links being coupled to the forward unison ring.

The turbofan engine of any preceding clause, the plurality of aft trunnion links being coupled to the aft unison ring.

The turbofan engine of any preceding clause, further comprising a plurality of pins that couple the plurality of trunnion links to the unison ring.

The turbofan engine of any preceding clause, the plurality of forward trunnion links being coupled to the forward unison ring by a plurality of forward pins.

The turbofan engine of any preceding clause, the plurality of aft trunnion links being coupled to the aft unison ring by a plurality of aft pins.

The turbofan engine of any preceding clause, the one or more actuators including a hydraulic cylinder and a piston disposed within the hydraulic cylinder.

The turbofan engine of the preceding clause, the hydraulic cylinder and the piston being movable along an axial direction.

The turbofan engine of any preceding clause, the forward unison ring being coupled to the hydraulic cylinder such that the forward unison ring moves when the hydraulic cylinder moves.

The turbofan engine of any preceding clause, the aft unison ring being coupled to the piston such that the aft unison ring moves as the piston moves.

The turbofan engine of any preceding clause, the fan actuation system rotating the plurality of fan blades between a first end position and a second end position.

The turbofan engine of any preceding clause, the first end position being a feather position in which the plurality of fan blades is substantially aligned with a flow of a volume of air across the plurality of fan blades.

The turbofan engine of the preceding clause, the fan actuation system rotating the plurality of fan blades to any position between the first end position and the second end position.

The turbofan engine of any preceding clause, the second end positioned being a reverse position in which the plurality of fan blades exceeds a plane that is transverse to the longitudinal centerline axis by at least 300 to assist with braking the aircraft.

The turbofan engine of any preceding clause, the fan actuation system moving the hydraulic cylinder in a first direction and moving the piston in a second direction.

The turbofan engine of any preceding clause, movement of the hydraulic cylinder and the piston causing the plurality of fan blades to rotate about the pitch axis.

The turbofan engine of any preceding clause, the one or more actuators including a piston retainer.

The turbofan engine of the preceding clause, the piston retainer being coupled to the fan shaft such that the piston retainer rotates with the fan shaft.

The turbofan engine of any preceding clause, the piston being coupled to the piston retainer such that the piston rotates with the piston retainer.

The turbofan engine of any preceding clause, the hydraulic cylinder being axially slidable with respect to the piston and the piston retainer.

The turbofan engine of any preceding clause, the piston retainer comprising a first portion, a second portion that extends radially outward from the first portion, and a third portion that extends axially from the second portion.

The turbofan engine of any preceding clause, the third portion of the piston retainer being coupled to the fan shaft.

The turbofan engine of any preceding clause, the piston being coupled to, and extending forward from, the first portion of the piston retainer.

The turbofan engine of any preceding clause, the hydraulic cylinder being disposed radially outward of the piston retainer and the piston.

The turbofan engine of any preceding clause, the hydraulic cylinder being coupled to the unison ring at a joint such that movement of the hydraulic cylinder in the axial direction causes the plurality of fan blades to pitch about the pitch axis.

The turbofan engine of any preceding clause, the hydraulic cylinder having a first portion, a second portion, a third portion, and a fourth portion.

The turbofan engine of the preceding clause, the first portion of the hydraulic cylinder extending generally in the axial direction and being coupled to the unison ring at the joint.

The turbofan engine of any preceding clause, the second portion of the hydraulic cylinder being disposed radially inward of the first portion and being coupled to the first portion and to the unison ring at the joint.

The turbofan engine of any preceding clause, the third portion of the hydraulic cylinder extending forward from the joint.

The turbofan engine of any preceding clause, the fourth portion of the hydraulic cylinder being coupled to, and extending axially within, the third portion of the hydraulic cylinder.

The turbofan engine of any preceding clause, the first portion of the hydraulic cylinder being sealingly engaged with the third portion of the piston retainer.

The turbofan engine of any preceding clause, the second portion of the piston retainer being sealingly engaged with the first portion of the hydraulic cylinder.

The turbofan engine of any preceding clause, the piston being sealingly engaged with the second portion and the fourth portion of the hydraulic cylinder.

The turbofan engine of any preceding clause, the fan actuation system including one or more hydraulic chambers defined between the hydraulic cylinder, the piston, and the piston retainer.

The turbofan engine of the preceding clause, the one or more hydraulic chambers including a first hydraulic chamber, a second hydraulic chamber, and a third hydraulic chamber.

The turbofan engine of any preceding clause, the first hydraulic chamber being defined between first portion of the hydraulic cylinder, the second portion of the piston retainer, and the third portion of the piston retainer.

The turbofan engine of any preceding clause, the second hydraulic chamber being defined between the first portion of the hydraulic cylinder, the second portion of the hydraulic cylinder, the first portion of the piston retainer, and the second portion of the piston retainer.

The turbofan engine of any preceding clause, the third hydraulic chamber being defined between the second portion of the hydraulic cylinder, an aft end of the piston, and the first portion of the piston retainer,

The turbofan engine of any preceding clause, the first hydraulic chamber and the third hydraulic chamber being supplied with a hydraulic fluid at a first pressure, and the second hydraulic chamber being supplied with the hydraulic fluid at a second pressure.

The turbofan engine of any preceding clause, the first pressure and the second pressure being increased or decreased to cause the hydraulic cylinder to move axially forward or axially rearward to rotate the plurality of fan blades about the pitch axis.

The turbofan engine of any preceding clause, the fan actuation system comprising a hydraulic system that supplies the hydraulic fluid to the one or more hydraulic chambers.

The turbofan engine of any preceding clause, the hydraulic system including a pump to supply the hydraulic fluid to the one or more hydraulic chambers.

The turbofan engine of the preceding clause, the hydraulic system comprising an oil transfer bearing including a fixed portion with a plurality of fluid lines coupled to the pump.

The turbofan engine of the preceding clause, the oil transfer bearing including a sleeve that is rotatable about the fixed portion.

The turbofan engine of any preceding clause, the plurality of fluid lines including a first fluid line in fluid communication with the first hydraulic chamber, a second fluid line in fluid communication with the second hydraulic chamber, and a third fluid line in fluid communication the third hydraulic chamber.

The turbofan engine of any preceding clause, the plurality of fluid lines being coupled to the sleeve.

The turbofan engine of any preceding clause, the first hydraulic chamber and the third hydraulic chamber being provided with the hydraulic fluid at the same first pressure.

The turbofan engine of any preceding clause, the pump supplying the hydraulic fluid to the first hydraulic chamber and the third hydraulic chamber to increase the first pressure P1 and supplying the hydraulic fluid to the second hydraulic chamber to decrease the second pressure P2, to move the hydraulic cylinder in the rearward direction to rotate the plurality of fan blades towards the reverse position.

The turbofan engine of any preceding clause, the pump supplying the hydraulic fluid to the second hydraulic chamber to increase the second pressure P2 and supplying the hydraulic fluid to the first hydraulic chamber and the third hydraulic chamber to decrease the first pressure P1, to move the hydraulic cylinder in the forward direction to rotate the plurality of fan blades towards the feather position.

The turbofan engine of any preceding clause, the one or more actuators further comprising a pressurized pneumatic chamber filled with a pressurized gas to bias the hydraulic cylinder to move the plurality of fan blades to the feather position.

The turbofan engine of any preceding clause, a pressure of the pressurized gas in the pressurized pneumatic chamber being in a range from 720 psi to 920 psi.

The turbofan engine of any preceding clause, the pressurized gas in the pressurized pneumatic chamber causing the hydraulic cylinder to move rearward when the hydraulic system or the turbofan engine fails or is shut down.

The turbofan engine of any preceding clause, the fan actuation system not including a pitch lock device.

The turbofan engine of any preceding clause, the one or more radial thrust bearings being disposed between the plurality of trunnions and the disk such that the plurality of trunnions rotates with respect to the disk to rotate the plurality of fan blades about the pitch axis.

The turbofan engine of any preceding clause, the one or more radial thrust bearings transmitting a load from the plurality of fan blades to a static structure of the turbofan engine.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by

$$\frac{{N}_{FB} \times {D}_{F T}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The turbofan engine of the preceding clause, wherein the fan actuation system includes a pressurized pneumatic chamber that is filled with a pressurized gas that biases the plurality of fan blades to a feather position.

The turbofan engine of any preceding clause, wherein the fan actuation system includes one or more counterweights for reducing inertial loading associated with rotation of the plurality of fan blades.

The turbofan engine of any preceding clause, further comprising a core cowl, wherein the turbofan engine has a longitudinal centerline axis, and the core cowl is annular about the longitudinal centerline axis wherein the core cowl includes a core inlet that is annular about the longitudinal centerline axis.

The turbofan engine of any preceding clause, wherein the fan actuation system includes a hydraulic system that supplies hydraulic fluid for rotating the plurality of fan blades about the pitch axis.

The turbofan engine of any preceding clause, wherein N_{FB} is in a range from ten to eighteen.

The turbofan engine of any preceding clause, wherein N_{FB} is in a range from ten to fourteen.

The turbofan engine of any preceding clause, wherein D_{FT} is in a range from 84.0 inches to 180.0 inches.

The turbofan engine of any preceding clause, wherein D_{FT} is in a range from 84.0 inches to 120.0 inches.

The turbofan engine of any preceding clause, wherein D_{FT} is in a range from 120.0 inches to 180.0 inches.

The turbofan engine of any preceding clause, wherein R_{TB} is in a range from 12 inches to 27 inches.

The turbofan engine of any preceding clause, wherein R_{TB} is in a range from 12 inches to 19 inches.

The turbofan engine of any preceding clause, wherein R_{TB} is in a range from 19 inches to 27 inches.

The turbofan engine of any preceding clause, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings.

The turbofan engine of any preceding clause, wherein A_{FH} is in a range from 25 inches to 75 inches.

The turbofan engine of any preceding clause, wherein A_{FB} is in a range from 16 inches to 23 inches.

The turbofan engine of any preceding clause, wherein the fan actuation system has a fan actuation system axial length (A_{FAS}) defined from an axially forward-most surface of the fan actuation system to the pitch axis of the plurality of fan blades, A_{FAS} being a maximum of 80% A_{FH}.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, a nacelle that circumferentially surrounds the fan, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 13, the fan actuation system length envelope being given by

$$\frac{{N}_{FB} \times {D}_{F T}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range from 25 inches to 40 inches, and A_{FB} is in a range from 17 inches to 20 inches.

A turbofan engine for an aircraft, the turbofan engine including a fan having a plurality of fan blades coupled to a fan shaft having one or more fan bearings, the fan being an open fan, and each of the plurality of fan blades being rotatable about a pitch axis and extending from a fan hub, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by

$$\frac{{N}_{FB} \times {D}_{F T}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range from 25 inches to 75 inches, and A_{FB} is in a range from 16 inches to 23 inches, and D_{FT} is in a range from 120.0 inches to 180.0 inches.

The turbofan engine of the preceding clause, wherein R_{TB} is in a range from 12 inches to 27 inches.

A turbofan engine for an aircraft, the turbofan engine including a fan having a plurality of fan blades coupled to a fan disk that is drivingly coupled to a fan shaft, the fan disk defining a disk bore, a fan hub that directs an airflow through the plurality of fan blades, each of the plurality of fan blades being rotatable about a pitch axis and extending from the fan hub, one or more fan bearings that support rotation of the fan shaft, the one or more fan bearings being positioned radially outward of the disk bore, wherein a fan bearing radius ratio is in a range from 1.0 to 2.75, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by:

$$\frac{{N}_{FB} \times {D}_{F T}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The turbofan engine of the preceding clause, wherein the turbofan engine has a fan hub radius ratio in a range from 0.1 to 0.4.

The turbofan engine of any preceding clause, wherein the one or more radial thrust bearings are tapered roller bearings.

The turbofan engine of any preceding clause, wherein the one or more fan bearings are positioned axially aft of the fan disk.

The turbofan engine of any preceding clause, wherein the fan disk extends between an inner surface and an outer surface, the one or more fan bearings being positioned radially outward of the outer surface.

The turbofan engine of any preceding clause, wherein the one or more fan bearings include at least one of roller bearings or ball bearings.

The turbofan engine of any preceding clause, wherein the ball bearings include four-point contact ball bearings.

The turbofan engine of any preceding clause, further comprising a compressor section, a combustion section, and a turbine section downstream of the fan, the turbine section having an input shaft that couples the compressor section to the turbine section, and a gearbox assembly, the fan shaft being drivingly coupled to the input shaft through the gearbox assembly.

The turbofan engine of any preceding clause, wherein the one or more fan bearings are positioned axially between the fan disk and the gearbox assembly.

The turbofan engine of any preceding clause, wherein the one or more fan bearings are positioned radially outward of the gearbox assembly.

A turbofan engine for an aircraft, the turbofan engine including a fan having a plurality of fan blades coupled to a fan disk that is drivingly coupled to a fan shaft, the fan disk defining a disk bore, and the fan being an open fan, a fan hub that directs an airflow through the plurality of fan blades, each of the plurality of fan blades being rotatable about a pitch axis and extending from the fan hub, one or more fan bearings that support rotation of the fan shaft, the one or more fan bearings being positioned radially outward of the disk bore, wherein a fan bearing radius ratio is in a range from 1.0 to 2.75, and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by

$$\frac{{N}_{FB} \times {D}_{F T}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 85 inches, and A_{FB} is in a range of 10 inches to 23 inches, and D_{FT} is in a range of 120.0 inches to 192.0 inches.

The turbofan engine of the preceding clause, wherein the turbofan engine has a fan hub radius ratio in a range from 0.1 to 0.4.

The turbofan engine of any preceding clause, wherein the one or more radial thrust bearings are tapered roller bearings.

The turbofan engine of any preceding clause, wherein the one or more fan bearings are positioned axially aft of the fan disk.

The turbofan engine of any preceding clause, wherein the fan disk extends between an inner surface and an outer surface, the one or more fan bearings being positioned radially outward of the outer surface.

The turbofan engine of any preceding clause, wherein the one or more fan bearings include at least one of roller bearings or ball bearings.

The turbofan engine of any preceding clause, wherein the ball bearings include four-point contact ball bearings.

The turbofan engine of any preceding clause, further comprising a compressor section, a combustion section, and a turbine section downstream of the fan, the turbine section having an input shaft that couples the compressor section to the turbine section, and a gearbox assembly, the fan shaft being drivingly coupled to the input shaft through the gearbox assembly.

The turbofan engine of any preceding clause, wherein the one or more fan bearings are positioned axially between the fan disk and the gearbox assembly.

The turbofan engine of any preceding clause, wherein the one or more fan bearings are positioned radially outward of the gearbox assembly.

An airfoil structure includes an airfoil and a spring and damper system. The airfoil includes a longitudinal axis, and the spring and damper system is connected to the airfoil to rotate the airfoil about the longitudinal axis to change airfoil pitch in response to a load applied to the airfoil.

The airfoil structure of the preceding clause, wherein the spring and damper system includes a plurality of dampers. Each damper of the plurality of dampers are fluidly connected to each other and configured to impart a rotational force to the rotating airfoil in a first direction.

The airfoil structure of any preceding clause, wherein each damper of the plurality of dampers is a hydraulic damper.

The airfoil structure of any preceding clause, wherein the spring and damper system includes a spring configured to counterbalance the rotational force imparted by the plurality of dampers.

The airfoil structure of any preceding clause, wherein the airfoil further includes a root, and the plurality of dampers and the spring are connected to the root to impart the rotational force to the root.

The airfoil structure of any preceding clause, further comprising a trunnion including a bearing. The root includes a bulb secured in the trunnion by the bearing to allow rotation of the bulb about the longitudinal axis.

The airfoil structure of any preceding clause, wherein the root includes an inner portion extending below the bulb and into a slot formed in the trunnion. The plurality of dampers and the spring are connected to the inner portion of the root.

The airfoil structure of any preceding clause, wherein each damper of the plurality of dampers includes a piston. The plurality of dampers includes a large damper and a small damper. The piston of the small damper has a smaller surface area than the piston of the large damper.

The airfoil structure of any preceding clause, wherein the small damper imparts a smaller pressure load to the airfoil than the large damper.

The airfoil structure of any preceding clause, wherein the airfoil further includes a leading edge, a trailing edge, and a chord extending from the leading edge to the trailing edge. The large damper and the small damper are positioned on opposite sides of the chord.

The airfoil structure of any preceding clause, wherein the spring and damper system includes a spring configured to counterbalance the rotational force imparted by the plurality of dampers. The spring is positioned on the same side of the chord as the large damper.

The airfoil structure of any preceding clause, wherein the airfoil further includes a pressure side and a suction side. The large damper is positioned on the pressure side and the small damper is positioned on the suction side.

The airfoil structure of any preceding clause, wherein the spring and damper system includes a spring configured to counterbalance the rotational force imparted by the plurality of dampers. The spring is positioned on the pressure side.

The airfoil structure of any preceding clause, wherein the large damper and the small damper are positioned on opposite sides of the longitudinal axis.

The airfoil structure of any preceding clause, wherein the spring and damper system includes a spring configured to counterbalance the rotational force imparted by the plurality of dampers. The spring is positioned on the same side of the longitudinal axis as the small damper.

The airfoil structure of any preceding clause, wherein the airfoil further includes a leading edge and a trailing edge. The large damper is positioned on a forward end closer to the leading edge than the trailing edge. The small damper is positioned on a trailing end closer to the trailing edge than the leading edge.

The airfoil structure of any preceding clause, wherein the spring and damper system includes a spring configured to counterbalance the rotational force imparted by the plurality of dampers. The spring is positioned on the trailing end.

A rotating airfoil assembly comprising a plurality of the airfoil structures any preceding clause, the plurality of the airfoil structures being rotatable about a rotation axis of the rotating airfoil assembly.

The rotating airfoil assembly of the preceding clause, wherein the airfoil includes a leading edge, a trailing edge, a suction surface between the leading edge and the trailing edge, and a pressure surface between the leading edge and the trailing edge, the suction surface and the pressure surface being positioned on opposite sides of the airfoil such that, when air flows over the suction surface and the pressure surface of the airfoil as the airfoil rotates about the rotation axis, the airfoil generates lift, the load applied to the airfoil being the generated lift.

An engine comprises the rotating airfoil assembly of any preceding clause and a torque producing system. The torque producing system is coupled to the rotating airfoil assembly and configured to rotate the rotating airfoil assembly about the rotation axis of the rotating airfoil assembly.

The engine of any preceding clause, wherein the engine is a turbofan engine. The torque producing system is a turbomachine of a gas turbine engine. The rotating airfoil assembly is a fan. Each of the plurality of rotating airfoils are fan blades.

An engine for an aircraft comprises a rotating airfoil assembly, at least one actuator, a torque producing system, and a controller. The rotating airfoil assembly includes a rotation axis and a plurality of rotating airfoils configured to rotate about the rotation axis in a plane of rotation. The at least one actuator is operable to change the plane of rotation of the plurality of rotating airfoils. The torque producing system is coupled to the rotating airfoil assembly and configured to rotate the rotating airfoil assembly about the rotation axis of the rotating airfoil assembly. The controller is configured to determine that the aircraft has an angle of attack and to operate the at least one actuator to change the plane of rotation of the plurality of rotating airfoils based on the angle of attack.

The engine of the preceding clause, wherein the controller is configured to receive an input indicating a pitch of the aircraft. The controller determines that the aircraft has an angle of attack based on the pitch of the aircraft.

The engine of any preceding clause, wherein the controller is communicatively coupled to a sensor to receive an input from the sensor. The controller determines that the aircraft has an angle of attack based on the pitch of the aircraft.

The engine of any preceding clause, further comprising the sensor.

The engine of any preceding clause, wherein the engine is a turbofan engine. The torque producing system is a turbomachine of a gas turbine engine. The rotating airfoil assembly is a fan. Each of the plurality of rotating airfoils are fan blades.

The engine of any preceding clause, wherein the at least one actuator is a linear actuator.

The engine of any preceding clause, wherein the at least one actuator is a hydraulic cylinder.

The engine of any preceding clause, wherein the at least one actuator is a power screw.

The engine of any preceding clause, wherein the at least one actuator changes the plane of rotation of the plurality of rotating airfoils by pivoting each rotating airfoil as the rotating airfoil rotates about the rotation axis.

The engine of any preceding clause, wherein the rotating airfoil assembly includes a hub. Each rotating airfoil is pivotably connected to the hub by an arcuate groove. The at least one actuator is configured to change the plane of rotation of the plurality by moving each rotating airfoil within the arcuate groove.

The engine of any preceding clause, wherein the rotating airfoil assembly includes a hub. Each rotating airfoil is pivotably connected to the hub by a trunnion. Each rotating airfoil is secured within the trunnion by a spherical bearing. The at least one actuator is configured to change the plane of rotation of the plurality by moving each rotating airfoil.

The engine of any preceding clause, wherein the at least one actuator changes the plane of rotation of the plurality of rotating airfoils by rotating the rotating airfoil assembly.

The engine of any preceding clause, wherein the torque producing system includes an output shaft. The rotating airfoil assembly includes a shaft coupled to the output shaft to receive torque from the output shaft and to rotate the rotating airfoil assembly.

The engine of any preceding clause, wherein the shaft of the rotating airfoil assembly is supported by a spherical bearing.

The engine of any preceding clause, wherein the shaft of the rotating airfoil assembly is connected to the output shaft of the torque producing system by a differential gearbox. The differential gearbox is configured to allow the shaft of the rotating airfoil assembly to rotate relative to the output shaft.

The engine of any preceding clause, wherein the shaft of the rotating airfoil assembly is connected to the output shaft of the torque producing system by a constant velocity joint. The constant velocity joint is configured to allow the shaft of the rotating airfoil assembly to rotate relative to the output shaft.

The engine of any preceding clause, wherein the at least one actuator changes the plane of rotation of the plurality of rotating airfoils by rotating the rotating airfoil assembly together with the torque producing system.

The engine of any preceding clause, further comprising an engine support structure. The engine support structure is connected to the torque producing system by a plurality of mounts. At least one mount of the plurality of mounts is a movable mount. The at least one actuator is configured to move the movable mount to rotate the torque producing system.

The engine of any preceding clause, wherein the at least one actuator is configured to translate the movable mount.

The engine of any preceding clause, wherein the movable mount is connected to the engine support structure by a pivot. The at least one actuator is configured to move the movable mount by rotating the movable mount about the pivot.

The engine of any preceding clause, wherein the at least one actuator is a cam. The cam is positioned on one side of the pivot. A spring is positioned on the other side of the pivot to counterbalance the cam.

The engine of any preceding clause, further comprising an engine support structure. The engine support structure includes a forward strut and an aft strut. The at least one actuator is configured to move the forward strut relative to the aft strut to rotate the torque producing system.

The engine of any preceding clause, wherein the engine support structure is connected to the torque producing system by a plurality of mounts. The plurality of mounts is connected to the forward strut.

The engine of any preceding clause, wherein the engine support structure is connected to the torque producing system by a forward mount and an aft mount. The forward mount is connected to the forward strut. The aft mount is connected to the aft strut. The at least one actuator is configured to move the forward strut away from the aft strut to rotate the torque producing system.

A mounting system for an aircraft engine including an engine support structure, a plurality of mounts, and at least one actuator. The plurality of mounts attached to the engine support structure to couple the aircraft engine to the engine support structure. At least one mount of the plurality of mounts being a movable mount. The at least one actuator operable to move the movable mount.

The mounting system of the previous clause, wherein the engine support structure includes a channel. The movable mount is movable within the channel and the channel guiding the movement of the movable mount.

The mounting system of any preceding clause, wherein the at least one actuator is configured to translate the movable mount.

The mounting system of any preceding clause, wherein the movable mount is translatable in an up and down direction and the at least one actuator is configured to translate the movable mount in the up and down direction.

The mounting system of any preceding clause, wherein the movable mount includes a platform. The at least one actuator is connected to the platform.

The mounting system of any preceding clause, wherein the at least one actuator is a power screw.

The mounting system of any preceding clause, wherein the movable mount includes a platform clevis attached to the platform.

The mounting system of any preceding clause, further comprising a plurality of the at least one actuator.

The mounting system of any preceding clause, wherein the plurality of the at least one actuator is located on an upper side of the platform.

The mounting system of any preceding clause, wherein the plurality of the at least one actuator is located on a lower side of the platform.

The mounting system of any preceding clause, wherein at least one of the plurality of the at least one actuator is located on an upper side of the platform, and at least one of the plurality of the at least one actuator is located on a lower side of the platform.

The mounting system of any preceding clause, wherein the movable mount includes a beam pivotably attached to the engine support structure by a pivot.

The mounting system of any preceding clause, wherein the beam includes a spherical mono-ball bearing capable of having a mount lug connect thereto.

The mounting system of any preceding clause, wherein the at least one actuator is connected to the beam to pivot the beam about the pivot.

The mounting system of any preceding clause, wherein the at least one actuator is a cam.

The mounting system of any preceding clause, wherein the cam is positioned on one side of the pivot and a spring is positioned on the other side of the pivot to counterbalance the cam.

An engine for an aircraft including a rotating airfoil assembly, a torque producing system coupled, and the mounting system of any preceding clause. The rotating airfoil assembly includes a rotation axis and a plurality of rotating airfoils configured to rotate about the rotation axis in a plane of rotation. The torque producing system is coupled to the rotating airfoil assembly and configured to rotate the rotating airfoil assembly about the rotation axis of the rotating airfoil assembly. The torque producing system is connected to the engine support structure by the plurality of mounts.

The engine the preceding clause, wherein the engine is a turbofan engine, the torque producing system is a turbomachine of a gas turbine engine, and the rotating airfoil assembly is a fan with each of the plurality of rotating airfoils being fan blades.

The engine of any preceding clause, wherein the at least one actuator operable to change the plane of rotation of the plurality of rotating airfoils.

The engine of any preceding clause, wherein the plurality of mounts includes a forward mount and an aft mount, one of the forward mount or the aft mount being the movable mount.

The engine of any preceding clause, further comprising a controller configured to determine that the aircraft has an angle of attack and to operate the at least one actuator to move the movable mount and change the plane of rotation of the plurality of rotating airfoils based on the angle of attack.

The engine of any preceding clause, wherein the controller is configured to receive an input indicating a pitch of the aircraft, the controller determining that the aircraft has an angle of attack based on the pitch of the aircraft.

A mounting system for an aircraft engine including an engine support structure, a plurality of mounts, and at least one actuator. The engine support structure includes a forward strut and an aft strut. The plurality of mounts are attached to the engine support structure to couple the aircraft engine to the engine support structure. The at least one actuator is operable to move one of the forward strut or the aft strut relative to the other one of the forward strut or the aft strut relative.

The mounting system of the preceding clause, wherein the forward strut is pivotable with respect to the aft strut.

The mounting system of any preceding clause, wherein one mount of the plurality of mounts is a forward mount connected to the forward strut and one mount of the plurality of mounts is an aft mount connected to the aft strut.

The mounting system of any preceding clause, wherein the at least one actuator is movable between a stowed position and an extended position, and moving the at least one actuator the stowed position to the extended position moves the forward strut away from the aft strut.

The mounting system of any preceding clause, wherein moving the at least one actuator the stowed position to the extended position moves the forward strut downward from the aft strut.

The mounting system of any preceding clause, wherein the aft strut includes a curved slot and the forward strut includes and engagement strut that engages with the curved slot and guides rotation of the forward strut as the at least one actuator is moved between the stowed position and the extended position.

The mounting system of any preceding clause, wherein the plurality of mounts is connected to the forward strut.

The mounting system of any preceding clause, further comprising at least one pivot pivotably connecting the forward strut to the aft strut.

The mounting system of any preceding clause, wherein the at least one actuator is positioned relative to the at least one pivot such that extending or retracting the at least one actuator pivots the forward strut about the at least one pivot.

The mounting system of any preceding clause, wherein the at least one actuator is connected to an upper portion of each of the forward strut and the aft strut, and the at least one pivot is located on a lower portion of each of the forward strut and the aft strut.

An engine for an aircraft including a rotating airfoil assembly, a torque producing system, and the mounting system of any preceding clause. The rotating airfoil assembly includes a rotation axis and a plurality of rotating airfoils configured to rotate about the rotation axis in a plane of rotation. The torque producing system is coupled to the rotating airfoil assembly and configured to rotate the rotating airfoil assembly about the rotation axis of the rotating airfoil assembly. The torque producing system is connected to the engine support structure by the plurality of mounts.

The engine of the preceding clause, wherein the at least one actuator operable to change the plane of rotation of the plurality of rotating airfoils.

The engine of any preceding clause wherein the engine is a turbofan engine, the torque producing system is a turbomachine of a gas turbine engine, and the rotating airfoil assembly is a fan with each of the plurality of rotating airfoils being fan blades.

The engine of any preceding clause, further comprising a controller configured to determine that the aircraft has an angle of attack and to operate the at least one actuator to move to move one of the forward strut or the aft strut relative and change the plane of rotation of the plurality of rotating airfoils based on the angle of attack.

The engine of any preceding clause, wherein the controller is configured to receive an input indicating a pitch of the aircraft, the controller determining that the aircraft has an angle of attack based on the pitch of the aircraft.

An engine for an aircraft including a torque producing system, a rotating airfoil assembly, and at least one actuator operable to change pitch the rotating airfoil assembly. The torque producing system includes an output shaft. The torque producing system outputs torque via the output shaft. The rotating airfoil assembly includes a rotation axis and a plurality of rotating airfoils configured to rotate about the rotation axis in a plane of rotation. The rotating airfoil assembly includes an input shaft coupled to the output shaft to receive torque from the output shaft and to rotate the rotating airfoil assembly. The input shaft is coupled to the output shaft by a pivotable coupling to allow rotation of the input shaft to change pitch relative to the output shaft.

The engine of the preceding clause, wherein the input shaft of the rotating airfoil assembly is supported by a spherical bearing.

The engine of any preceding clause, wherein the input shaft of the rotating airfoil assembly is supported by a barrel bearing.

The engine of any preceding clause, wherein the pivotable coupling is a constant velocity joint.

The engine of any preceding clause, wherein the pivotable coupling is a differential gearbox.

The engine of any preceding clause, wherein the differential gearbox includes an input gear connected to the output shaft of the torque producing system, an output gear connected to the of the rotating airfoil assembly, and a pair of transfer gears. Each of the input gear and the output gear engage with the pair of transfer gears to transfer the torque from the input gear to the output gear.

The engine of any preceding clause, wherein the transfer gears are positioned to oppose each other on opposite sides of the input gear and the output gear.

The engine of any preceding clause, wherein the torque producing system includes an outer casing, and the rotating airfoil assembly being pivotably connected to the outer casing.

The engine of any preceding clause, wherein rotating airfoil assembly being pivotably connected to the outer casing by a spherical joint.

The engine of any preceding clause, wherein the engine is a turbofan engine, the torque producing system is a turbomachine of a gas turbine engine, and the rotating airfoil assembly is a fan with each of the plurality of rotating airfoils being fan blades.

The engine of any preceding clause, further comprising a controller configured to determine that the aircraft has an angle of attack and to operate the at least one actuator to move the rotating airfoil assembly.

The engine of any preceding clause, wherein the controller is configured to receive an input indicating a pitch of the aircraft, the controller determining that the aircraft has an angle of attack based on the pitch of the aircraft.

An engine for an aircraft including a rotating airfoil assembly, at least one actuator, and a torque producing system coupled to the rotating airfoil assembly. The rotating airfoil assembly includes a rotation axis and a plurality of rotating airfoils configured to rotate about the rotation axis in a plane of rotation. The at least one actuator is operable to change the plane of rotation of the plurality of rotating airfoils by pivoting each rotating airfoil as the rotating airfoil rotates about the rotation axis. The torque producing system is configured to rotate the rotating airfoil assembly about the rotation axis of the rotating airfoil assembly.

The engine of the preceding clause, further comprising a plurality of the at least one actuator. One actuator of the plurality of actuators is connected to a corresponding one of the plurality of rotating airfoils forward of the corresponding rotating airfoil and another one of the plurality of actuators is connected to the corresponding rotating airfoil aft of the corresponding rotating airfoil to change the pitch of the corresponding rotating airfoil.

The engine of any preceding clause, wherein the engine is a turbofan engine, the torque producing system is a turbomachine of a gas turbine engine, and the rotating airfoil assembly is a fan with each of the plurality of rotating airfoils being fan blades.

The engine of any preceding clause, further comprising a plurality of the at least one actuator, at least one actuator of the plurality of actuators connected to a corresponding one of the plurality of rotating airfoils to change the pitch of the corresponding rotating airfoil.

The engine of any preceding clause, wherein the rotating airfoil assembly includes a hub, each rotating airfoil being pivotably connected to the hub with a pivotable connection that allows the rotating airfoil to change pitch.

The engine of any preceding clause, wherein each rotating airfoil is pivotably connected to the hub by an arcuate groove.

The engine of any preceding clause, wherein arcuate groove is oriented in a forward direction and an aft direction of the engine.

The engine of any preceding clause, further comprising a controller configured to determine that the aircraft has an angle of attack and to operate the at least one actuator to pivot each rotating airfoil as the rotating airfoil rotates about the rotation axis.

The engine of any preceding clause, wherein the controller is configured to receive an input indicating a pitch of the aircraft, the controller determining that the aircraft has an angle of attack based on the pitch of the aircraft.

The engine of any preceding clause, wherein the controller is configured to operate the at least one actuator to move each rotating airfoil independently.

The engine of any preceding clause, wherein the rotating airfoil assembly includes a hub. Each rotating airfoil is pivotably connected to the hub by an arcuate groove. The arcuate groove is oriented in the forward direction and the aft direction of the engine. The controller is configured to operate the at least one actuator to move each rotating airfoil independently between a forward portion of the arcuate groove and an aft portion of the arcuate groove.

The engine of any preceding clause, wherein the controller is configured to position the rotating airfoil in the forward portion of the arcuate groove when the rotating airfoil is located at a twelve o'clock position of the rotating airfoil assembly. The controller is configured to position the rotating airfoil in the aft portion of the arcuate groove when the rotating airfoil is located at a six o'clock position of the rotating airfoil assembly.

The engine of any preceding clause, wherein the rotating airfoil assembly includes a hub. Each rotating airfoil is pivotably connected to the hub by a trunnion and each rotating airfoil being secured within the trunnion by a spherical bearing. The at least one actuator is configured to change the plane of rotation of the plurality by moving each rotating airfoil.

The engine of any preceding clause, wherein the rotating airfoil includes a root having a bulb, the trunnion securing the bulb.

The engine of any preceding clause, wherein the trunnion includes a slot, and the root includes an inner portion extending below the bulb and into the slot.

The engine of any preceding clause, wherein the inner portion is sized relative to the slot to restrict movement in one direction but with a gap permit movement in another.

An aircraft including the engine of any preceding clause.

The aircraft of the preceding clause further comprising a fuselage, and a wing attached to the fuselage.

The aircraft of any preceding clause, wherein the engine is mounted to the wing.

The aircraft of any preceding clause, wherein the engine is mounted to the wing by a pylon in an under-wing configuration.

The aircraft of any preceding clause, wherein the pylon includes the engine support structure of any preceding clause.

The aircraft of any preceding clause, further comprising a flight controller, wherein the controller is communicatively coupled to the flight controller to receive an input from the flight controller.

The aircraft of any preceding clause, wherein the input is one of an angle of attack of the aircraft or a pitch of the aircraft.

The aircraft of any preceding clause, wherein the aircraft includes the sensor.

The aircraft of any preceding clause, comprising a turbofan engine, the turbofan engine comprising: a fan having a plurality of fan blades coupled to a fan shaft having one or more fan bearings, each of the plurality of fan blades being rotatable about a pitch axis and extending from a fan hub; and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:

$$\frac{{N}_{FB} \times {D}_{F T}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The mounting system of any preceding clause, comprising a turbofan engine, the turbofan engine comprising: a fan having a plurality of fan blades coupled to a fan shaft having one or more fan bearings, each of the plurality of fan blades being rotatable about a pitch axis and extending from a fan hub; and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:

$$\frac{{N}_{FB} \times {D}_{F T}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The engine of any preceding clause, comprising: a fan having a plurality of fan blades coupled to a fan shaft having one or more fan bearings, each of the plurality of fan blades being rotatable about a pitch axis and extending from a fan hub; and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:

$$\frac{{N}_{FB} \times {D}_{F T}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

A turbofan engine for an aircraft, the turbofan engine comprising: a fan having a plurality of fan blades coupled to a fan shaft having one or more fan bearings, each of the plurality of fan blades being rotatable about a pitch axis and extending from a fan hub, wherein each of the plurality of fan blades includes a spring and damper system connected to the fan blade to rotate the fan blade about the pitch axis; and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:

$$\frac{{N}_{FB} \times {D}_{F T}}{{L}_{AXIAL} \times ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The turbofan engine of any of the preceding clauses, wherein the spring and damper system is connected to the fan blade to rotate the fan blade about the pitch axis to change an airfoil pitch in response to a load applied to the fan blade.

The turbofan engine of any of the preceding clauses, wherein the spring and damper system includes a plurality of dampers operatively engaged with the airfoil and arranged to impart a rotational force to the airfoil, each damper of the plurality of dampers being a hydraulic damper and fluidly connected to each other via a fluid conduit that facilitates a flow of a hydraulic fluid between the plurality of dampers.

The turbofan engine of any of the preceding clauses, wherein each fan blade is rotatable about its pitch axis via the respective spring and damper system independent of the other fan blades.

The turbofan engine of any of the preceding clauses, wherein the spring and damper system includes a plurality of dampers operatively engaged with the fan blades and arranged to impart a rotational force to the fan blades, wherein each damper of the plurality of dampers is fluidly connected to each other and includes a piston, the plurality of dampers including a large damper and a small damper with the piston of the small damper having a smaller surface area than that of the piston of the large damper.

The turbofan engine of any of the preceding clauses, wherein the fan actuation system includes a pressurized pneumatic chamber that is filled with a pressurized gas that biases the plurality of fan blades to a feather position.

The turbofan engine of any of the preceding clauses, wherein the fan actuation system includes one or more counterweights for reducing inertial loading associated with rotation of the plurality of fan blades.

The turbofan engine of any of the preceding clauses, further comprising a turbo-engine, wherein the turbofan engine has a longitudinal centerline axis, and the turbo-engine is annular about the longitudinal centerline axis wherein the turbo-engine includes a core inlet that is annular about the longitudinal centerline axis.

The turbofan engine of any of the preceding clauses, wherein the fan actuation system includes a hydraulic system that supplies hydraulic fluid for rotating the plurality of fan blades about the pitch axis.

The turbofan engine of any of the preceding clauses, wherein N_{FB} is in a range of ten to eighteen.

The turbofan engine of any of the preceding clauses, wherein D_{FT} is in a range of 84.0 inches to 180.0 inches.

The turbofan engine of any of the preceding clauses, wherein R_{TB} is in a range of 12 inches to 27 inches.

The turbofan engine of any of the preceding clauses, wherein R_{TB} is in a range of 12 inches to 19 inches.

The turbofan engine of any of the preceding clauses, wherein R_{TB} is in a range of 19 inches to 27 inches.

The turbofan engine of any of the preceding clauses, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings.

The turbofan engine of any of the preceding clauses, wherein A_{FH} is in a range of 25 inches to 75 inches.

The turbofan engine of any of the preceding clauses, wherein the fan actuation system has a fan actuation system axial length (A_{FAS}) defined from an axially forward-most surface of the fan actuation system to the pitch axis of the plurality of fan blades, A_{FAS} being a maximum of 80% A_{FH}.

A turbofan engine for an aircraft, the turbofan engine comprising: a fan having a plurality of fan blades coupled to a fan shaft having one or more fan bearings, each of the plurality of fan blades being rotatable about a pitch axis and extending from a fan hub, wherein each of the plurality of fan blades includes a spring and damper system connected to the fan blade to rotate the fan blade about the pitch axis; a nacelle that circumferentially surrounds the fan; and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 13, the fan actuation system length envelope being given by:

$$\frac{{N}_{FB} \times {D}_{F T}}{{L}_{AXIAL} \times ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 40 inches, and A_{FB} is in a range of 17 inches to 20 inches.

A turbofan engine for an aircraft, the turbofan engine comprising: a fan having a plurality of fan blades coupled to a fan shaft having one or more fan bearings, the fan being an open fan, and each of the plurality of fan blades being rotatable about a pitch axis and extending from a fan hub, wherein each of the plurality of fan blades includes a spring and damper system connected to the fan blade to rotate the fan blade about the pitch axis; and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:

$$\frac{{N}_{FB} \times {D}_{F T}}{{L}_{AXIAL} \times ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 75 inches, and A_{FB} is in a range of 16 inches to 23 inches, and D_{FT} is in a range of 120.0 inches to 180.0 inches.

The turbofan engine of any of the preceding clauses, further comprising a load mitigation system coupled to a root of each of the plurality of fan blades, wherein the load mitigation system is configured to permit a cyclic pitch change of the fan blade independent of the fan actuation system to isolate the fan actuation system from cyclic aerodynamic loads.

The turbofan engine of any of the preceding clauses, wherein the load mitigation system comprises a spring and damper system configured to passively adjust an airfoil pitch of the fan blade about the longitudinal axis in response to asymmetric airflow loading.

The turbofan engine of any of the preceding clauses, further comprising a pivotable engine support structure, a tilting fan shaft, an active cyclic pitch mechanism, or combinations thereof configured to adjust a plane of rotation of the plurality of fan blades based on an angle of attack of the aircraft.

The turbofan engine of any of the preceding clauses, wherein N_{FB} is 10 to 18, wherein D_{FT} is in a range of 84 inches to 180 inches, and wherein each of the plurality of fan blades includes a passive pitch adjustment mechanism configured to dynamically adjust a rotor blade pitch in response to an asymmetric airflow loading condition.

The turbofan engine of any of the preceding clauses, wherein N_{FB} is 14 to 18, wherein D_{FT} is in a range of 120 inches to 180 inches, and wherein each of the plurality of fan blades includes a passive pitch adjustment mechanism configured to dynamically adjust an airfoil pitch in response to an asymmetric airflow loading condition.

The turbofan engine of any of the preceding clauses, further comprising at least one actuator to change a plane of rotation of the plurality of fan blades.

The turbofan engine of any of the preceding clauses, further comprising an engine controller configured to determine that the aircraft has an angle of attack and to operate the at least one actuator based on the angle of attack.

The turbofan engine of any of the preceding clauses, wherein the controller is communicatively coupled to a sensor to receive an input from the sensor, and wherein the controller determines that the aircraft has the angle of attack based on a pitch of the aircraft.

The turbofan engine of any of the preceding clauses, wherein the at least one actuator is a linear actuator.

The turbofan engine of any of the preceding clauses, wherein the at least one actuator is a hydraulic cylinder.

The turbofan engine of any of the preceding clauses, wherein the at least one actuator is a power screw.

The turbofan engine of any of the preceding clauses, further comprising an engine support structure for supporting the torque producing system, the engine support structure including a forward strut and an aft strut, the forward strut and an aft strut being directly attached to each other, at least one of the forward strut or the aft strut being a movable strut that is movable relative to the other one of the forward strut or the aft strut in a forward direction and an aft direction, the engine support structure being connected to the torque producing system by a plurality of mounts, at least one mount of the plurality of mounts being attached to the movable strut to move with the movable strut; wherein the at least one actuator is operably connected to the movable strut to move the movable strut in the forward direction and the aft direction to rotate the torque producing system and change the plane of rotation of the plurality of rotating airfoils by rotating the rotating airfoil assembly together with the torque producing system; and a controller configured to determine that the aircraft has an angle of attack and to operate the at least one actuator to rotate the torque producing system and change the plane of rotation of the plurality of rotating airfoils based on the angle of attack.

The turbofan engine of any of the preceding clauses, further comprising: at least one actuator operable to change the plane of rotation of the plurality of rotating fan blades by rotating together the rotating fan blade assembly and a torque producing system; and a controller configured to determine that the aircraft has an angle of attack and to operate the at least one actuator to change the plane of rotation of the plurality of rotating fan blades based on the angle of attack.

The turbofan engine of any of the preceding clauses, further comprising: at least one actuator operable to change the plane of rotation of the plurality of rotating fan blades relative to the pitch axis of the engine; and a controller configured to determine that the aircraft has an angle of attack and to operate the at least one actuator to change the plane of rotation of the plurality of rotating fan blades based on the angle of attack.

An aircraft including the turbofan engine of any of the preceding clauses, the aircraft comprising an engine support structure comprising a forward strut and an aft strut, and at least one actuator operable to move one of the forward strut or the aft strut relative to the other to tilt a rotation axis of the fan.

The aircraft of any of the preceding clauses, wherein the aft strut includes a curved slot and the forward strut includes an engagement strut that engages with the curved slot and guides rotation of the forward strut as the at least one actuator moves the forward strut relative to the aft strut.

The aircraft of any of the preceding clauses, wherein the at least one actuator is movable between a stowed position and an extended position, and moving the at least one actuator from the stowed position to the extended position moves the forward strut away from the aft strut.

The aircraft of any of the preceding clauses, further comprising a plurality of mounts attached to the engine support structure, wherein the plurality of mounts are connected to the forward strut.

The turbofan engine of any of the preceding clauses, further comprising an engine support structure comprising a forward strut, an aft strut, and at least one pivot pivotably connecting the forward strut to the aft strut, wherein an actuator is positioned relative to the at least one pivot such that extending or retracting the actuator pivots the forward strut about the at least one pivot to tilt the fan.

The turbofan engine of any of the preceding clauses, wherein the actuator is connected to an upper portion of each of the forward strut and the aft strut.

The turbofan engine of any of the preceding clauses, wherein the at least one pivot is located on a lower portion of each of the forward strut and the aft strut.

The turbofan engine of any of the preceding clauses, wherein the actuator is a power screw.

The turbofan engine of any of the preceding clauses, further comprising a mounting system comprising an engine support structure having a channel, a movable mount movable within the channel, and at least one actuator configured to translate the movable mount within the channel to tilt the fan.

The turbofan engine of any of the preceding clauses, wherein the movable mount includes a platform, and wherein the at least one actuator is connected to the platform to translate the platform in an up and down direction.

The turbofan engine of any of the preceding clauses, wherein the movable mount includes a platform clevis attached to the platform.

The turbofan engine of any of the preceding clauses, wherein the at least one actuator comprises a plurality of actuators, wherein at least one of the plurality of actuators is located on an upper side of the platform, and at least one of the plurality of actuators is located on a lower side of the platform.

The turbofan engine of any of the preceding clauses, further comprising a mounting system comprising an engine support structure and a movable mount, wherein the movable mount includes a beam pivotably attached to the engine support structure by a pivot, and an actuator connected to the beam to pivot the beam about the pivot.

The turbofan engine of any of the preceding clauses, wherein the beam includes a spherical mono-ball bearing capable of having a mount lug connect thereto.

The turbofan engine of any of the preceding clauses, wherein the actuator is a linear actuator connected to the beam forward of the pivot.

The turbofan engine of any of the preceding clauses, further comprising a mounting system comprising a movable mount pivotably attached to an engine support structure by a pivot, and a rotatable cam operable to move the movable mount about the pivot.

The turbofan engine of any of the preceding clauses, wherein the rotatable cam is an eccentric cam positioned on one side of the pivot.

The turbofan engine of any of the preceding clauses, further comprising a spring positioned on an other side of the pivot to counterbalance the rotatable cam.

The turbofan engine of any of the preceding clauses, wherein the fan shaft is coupled to an output shaft of a torque producing system by a differential gearbox, the differential gearbox configured to allow the fan shaft to pivot relative to the output shaft to change a plane of rotation of the plurality of fan blades.

The turbofan engine of any of the preceding clauses, wherein the differential gearbox includes an input gear connected to the output shaft, an output gear connected to the fan shaft, and a pair of transfer gears, wherein each of the input gear and the output gear engage with the pair of transfer gears to transfer torque.

The turbofan engine of any of the preceding clauses, wherein the pair of transfer gears are positioned to oppose each other on opposite sides of the input gear and the output gear.

The turbofan engine of any of the preceding clauses, wherein the torque producing system includes an outer casing, and the fan is pivotably connected to the outer casing by a spherical joint.

The turbofan engine of any of the preceding clauses, wherein the fan shaft is coupled to an output shaft of a torque producing system by a constant velocity joint configured to allow the fan shaft to rotate relative to the output shaft to change a plane of rotation of the plurality of fan blades.

The turbofan engine of any of the preceding clauses, wherein the fan shaft is supported by a spherical bearing.

The turbofan engine of any of the preceding clauses, further comprising at least one actuator connected to the fan shaft to pivot the fan shaft and the fan hub.

The turbofan engine of any of the preceding clauses, wherein the fan hub comprises an arcuate groove for each of the plurality of fan blades, and each fan blade is pivotably connected to the fan hub by the arcuate groove to allow the fan blade to change the airfoil pitch.

The turbofan engine of any of the preceding clauses, wherein the arcuate groove is oriented in a forward direction and an aft direction of the turbofan engine.

The turbofan engine of any of the preceding clauses, further comprising a controller configured to operate at least one actuator to move each fan blade independently between a forward portion of the arcuate groove and an aft portion of the arcuate groove based on an angle of attack of the aircraft.

The turbofan engine of any of the preceding clauses, wherein the controller is configured to position the fan blade in the forward portion of the arcuate groove when the fan blade is located at a twelve o'clock position and in the aft portion of the arcuate groove when the fan blade is located at a six o'clock position.

The turbofan engine of any of the preceding clauses, wherein each fan blade includes a root having a bulb, and the fan hub includes a trunnion securing the bulb via a spherical bearing to allow the fan blade to change the airfoil pitch in a forward direction and an aft direction.

The turbofan engine of any of the preceding clauses, wherein the trunnion includes a slot, and the root includes an inner portion extending below the bulb and into the slot.

The turbofan engine of any of the preceding clauses, wherein the inner portion is sized relative to the slot to restrict movement in one direction while permitting movement in the forward direction and the aft direction.

The turbofan engine of any of the preceding clauses, further comprising an actuator connected to the root and configured to move the root in the forward direction and the aft direction.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A turbofan engine for an aircraft, the turbofan engine comprising:
a fan having a plurality of fan blades coupled to a fan shaft having one or more fan bearings, each of the plurality of fan blades being rotatable about a pitch axis and extending from a fan hub, wherein each of the plurality of fan blades includes a spring and damper system connected to the fan blade to rotate the fan blade about the pitch axis; and
a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:
$$\frac{{N}_{FB} \times {D}_{F T}}{{L}_{AXIAL} \times ( \frac{{R}_{TB}}{{N}_{FB}} )}$$
wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

2. The turbofan engine of claim 1, wherein the spring and damper system is connected to the fan blade to rotate the fan blade about the pitch axis to change an airfoil pitch in response to a load applied to the fan blade.

3. The turbofan engine of claim 1, wherein the spring and damper system includes a plurality of dampers operatively engaged with the airfoil and arranged to impart a rotational force to the airfoil, each damper of the plurality of dampers being a hydraulic damper and fluidly connected to each other via a fluid conduit that facilitates a flow of a hydraulic fluid between the plurality of dampers.

4. The turbofan engine of claim 1, wherein each fan blade is rotatable about its pitch axis via the respective spring and damper system independent of the other fan blades.

5. The turbofan engine of claim 1, wherein the spring and damper system includes a plurality of dampers operatively engaged with the fan blades and arranged to impart a rotational force to the fan blades, wherein each damper of the plurality of dampers is fluidly connected to each other and includes a piston, the plurality of dampers including a large damper and a small damper with the piston of the small damper having a smaller surface area than that of the piston of the large damper.

6. The turbofan engine of claim 1, wherein the fan actuation system includes a pressurized pneumatic chamber that is filled with a pressurized gas that biases the plurality of fan blades to a feather position.

7. The turbofan engine of claim 1, wherein the fan actuation system includes one or more counterweights for reducing inertial loading associated with rotation of the plurality of fan blades.

8. The turbofan engine of claim 1, further comprising a turbo-engine, wherein the turbofan engine has a longitudinal centerline axis, and the turbo-engine is annular about the longitudinal centerline axis wherein the turbo-engine includes a core inlet that is annular about the longitudinal centerline axis.

9. The turbofan engine of claim 1, wherein the fan actuation system includes a hydraulic system that supplies hydraulic fluid for rotating the plurality of fan blades about the pitch axis.

10. The turbofan engine of claim 1, wherein N_{FB} is in a range of ten to eighteen.

11. The turbofan engine of claim 1, wherein D_{FT} is in a range of 84.0 inches to 180.0 inches.

12. The turbofan engine of claim 1, wherein R_{TB} is in a range of 12 inches to 27 inches.

13. The turbofan engine of claim 12, wherein R_{TB} is in a range of 12 inches to 19 inches.

14. The turbofan engine of claim 12, wherein R_{TB} is in a range of 19 inches to 27 inches.

15. The turbofan engine of claim 1, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings.

16. The turbofan engine of claim 15, wherein A_{FH} is in a range of 25 inches to 75 inches.

17. The turbofan engine of claim 15, wherein the fan actuation system has a fan actuation system axial length (A_{FAS}) defined from an axially forward-most surface of the fan actuation system to the pitch axis of the plurality of fan blades, A_{FAS} being a maximum of 80% A_{FH}.

18. A turbofan engine for an aircraft, the turbofan engine comprising:
a fan having a plurality of fan blades coupled to a fan shaft having one or more fan bearings, each of the plurality of fan blades being rotatable about a pitch axis and extending from a fan hub, wherein each of the plurality of fan blades includes a spring and damper system connected to the fan blade to rotate the fan blade about the pitch axis;
a nacelle that circumferentially surrounds the fan; and
a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 13, the fan actuation system length envelope being given by:
$$\frac{{N}_{FB} \times {D}_{F T}}{{L}_{AXIAL} \times ( \frac{{R}_{TB}}{{N}_{FB}} )}$$
wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 40 inches, and A_{FB} is in a range of 17 inches to 20 inches.

19. A turbofan engine for an aircraft, the turbofan engine comprising:
a fan having a plurality of fan blades coupled to a fan shaft having one or more fan bearings, the fan being an open fan, and each of the plurality of fan blades being rotatable about a pitch axis and extending from a fan hub, wherein each of the plurality of fan blades includes a spring and damper system connected to the fan blade to rotate the fan blade about the pitch axis; and
a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:
$$\frac{{N}_{FB} \times {D}_{F T}}{{L}_{AXIAL} \times ( \frac{{R}_{TB}}{{N}_{FB}} )}$$
wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 75 inches, and A_{FB} is in a range of 16 inches to 23 inches, and D_{FT} is in a range of 120.0 inches to 180.0 inches.

20. The turbofan engine of claim 19, wherein R_{TB} is in a range of 12 inches to 27 inches.
